(19) United States
(12) Patent Application Publication
(10) Pub. No.: US 2014/0108556 A1
(43) Pub. Date: Apr. 17, 2014

(54) HOLIDAY EXPRESSION AND MAPPING IN A GEOSPATIALLY CONSTRAINED SOCIAL NETWORK

(71) Applicant: Raj V. Abhyanker, Cupertino, CA (US)

(72) Inventor: Raj V. Abhyanker, Cupertino, CA (US)

(21) Appl. No.: 14/141,432

(22) Filed: Dec. 27, 2013

Related U.S. Application Data
(63) Continuation-in-part of application No. 11/603,442, filed on Nov. 22, 2006, now abandoned.
Application No. 11/603,442 is a continuation-in-part of application No. 11/653,194, filed on Jan. 12, 2007.
Application No. 11/653,194 is a continuation-in-part of application No. 11/731,465, filed on Mar. 29, 2007.
Application No. 11/731,465 is a continuation-in-part of application No. 11/827,400, filed on Jul. 10, 2007.
Application No. 11/827,400 is a continuation-in-part of application No. 13/236,964, filed on Sep. 20, 2011.
Application No. 13/236,964 is a continuation-in-part of application No. 13/242,303, filed on Sep. 23, 2011.
Application No. 13/242,303 is a continuation-in-part of application No. 13/272,245, filed on Oct. 13, 2011, now Pat. No. 8,660,897.
Application No. 13/272,245 is a continuation-in-part of application No. 14/079,611, filed on Nov. 13, 2013.
(60) Provisional application No. 61/894,443, filed on Oct. 23, 2013.

(51) Int. Cl. G06F 15/173

(52) U.S. Cl. CPC G06F 15/17306
USPC 709/204

(57) ABSTRACT

Disclosed are methods of verifying a user of a geospatial social network has a primary residence in a particular location associated with a claimed neighborhood using a processor and a memory. The user verified in the geospatial social network as having the primary residence at the particular location is permitted to place a holiday pushpin on a geospatial representation of a property boundary associated with the user. The method generates a holiday map in which various homes associated with users of the geospatial social network who have placed holiday pushpins on their property boundaries are published to other verified users in the claimed neighborhood. The method restricts the visibility of the holiday map to users who have verified their address in the claimed neighborhood and denies access to the holiday map to users who have verified their addresses in neighborhoods different than the claimed neighborhood.

### CLAIMS OF PRIORITY

This patent application is a continuation in part, claims priority from, and hereby incorporates by reference:
(1) U.S. Provisional patent application No. 60/783,226, titled ‘TRADE IDENTITY LICENSING IN A PROFESSIONAL SERVICES ENVIRONMENT WITH CONFLICT’ filed on Mar. 17, 2006.
(2) U.S. Provisional patent application No. 60/817,470 titled ‘SEGMENTED SERVICES HAVING A GLOBAL STRUCTURE OF NETWORKED INDEPENDENT ENTITIES’, filed Jun. 28, 2006.
(3) U.S. Provisional patent application No. 60/853,499, titled ‘METHOD AND APPARATUS OF NEIGHBORHOOD EXPRESSION AND USER CONTRIBUTION SYSTEM’ filed on Oct. 19, 2006.
(4) U.S. Provisional patent application No. 60/854,230 titled ‘METHOD AND APPARATUS OF NEIGHBORHOOD EXPRESSION AND USER CONTRIBUTION SYSTEM’ filed on Oct. 25, 2006.
(5) U.S. Utility patent application Ser. No. 11/603,442 titled ‘MAP BASED NEIGHBORHOOD SEARCH AND COMMUNITY CONTRIBUTION’ filed on Nov. 22, 2006.
(6) U.S. Utility patent application Ser. No. 11/653,194 titled ‘LODGING AND REAL PROPERTY IN A GEO-SPATIAL MAPPING ENVIRONMENT’ filed on Jan. 12, 2007.
(7) U.S. Utility patent application Ser. No. 11/731,465 titled ‘WHITE PAGE AND YELLOW PAGE DIRECTORIES IN A GEO-SPATIAL ENVIRONMENT’ filed on Mar. 29, 2007.
(8) U.S. Utility patent application Ser. No. 11/827,400 titled ‘HOT NEWS NEIGHBORHOOD BANTER IN A GEO-SPATIAL SOCIAL NETWORK’ filed on Jul. 10, 2007.
(9) U.S. Provisional patent application No. 61/526,693 titled ‘GEOSPATIAL CONSTRAINT AROUND BIDDABILITY OF A GASTRONOMICAL ITEM’ filed on Aug. 24, 2011.
(10) U.S. Utility patent application Ser. No. 13/236,964 titled ‘NEAR-FIELD COMMUNICATION ENABLED WEARABLE APPAREL GARMENT AND METHOD TO CAPTURE GEOSPATIALLY AND SOCIALLY RELEVANT DATA OF A WEARER OF THE WEARABLE APPAREL GARMENT AND/OR A USER OF A READER DEVICE ASSOCIATED THEREWITH’ filed on Sep. 20, 2011.
(11) U.S. Utility patent application Ser. No. 13/242,303 titled ‘GEOSPATIALLY CONSTRAINED GASTRONOMIC BIDDING’ filed on Sep. 23, 2011.
(12) U.S. Utility patent application Ser. No. 13/272,245 titled ‘NEAR-FIELD COMMUNICATION ENABLED WEARABLE APPAREL GARMENT AND METHOD TO CAPTURE GEOSPATIALLY AND SOCIALLY RELEVANT DATA OF A WEARER OF THE WEARABLE APPAREL GARMENT AND/OR A USER OF A READER DEVICE ASSOCIATED THEREWITH’ filed on Oct. 13, 2011.
(13) U.S. Provisional patent application No. 61/894,443 titled ‘RADIO BROADCAST, COMMERCE PUSHPINS, AND AUTOMATED PAGE UPDATES TO A GEOSPATIALLY CONSTRAINED NEIGHBORHOOD REGION THROUGH AN INTERNET NETWORK AND SEPARATELY A TRACKABLE SOCIAL COMMUNITY FORMED BASED ON TRACKABLE TAG BASED APPAREL THAT CREATES INCENTIVES AND CONNECTIONS BETWEEN USERS WEARING PROMOTIONAL APPAREL AND THOSE OTHER USERS READING THE TRACKABLE TAG ON THE APPAREL’ filed on Oct. 23, 2013.
(14) U.S. Utility patent application Ser. No. 14/079,611 titled ‘JOB BROADCAST DATA PUBLICATION THROUGH A WORK-OPPORTUNITY LISTING SERVER USING A RADIAL ALGORITHM TO AUTOMATICALLY DISTRIBUTE THE JOB BROADCAST DATA IN A THRESHOLD RADIAL DISTANCE FROM A SET OF GEOSPATIAL COORDINATES ASSOCIATED WITH A MOBILE DEVICE’ filed on Nov. 13, 2013.

### FIELD OF TECHNOLOGY

This disclosure relates generally to data processing devices and, more particularly, to a method, a device and/or a system of holiday expression and mapping including holiday broadcast data generation and publication in a constrained geospatial vicinity around a broadcast location of a neighborhood social network.

### BACKGROUND

Holidays are a time of year when people may want to invite others into their home. For example, during the holiday of Halloween, families across America may provide candy to children of their neighborhood. However, it may be difficult for families to know who is offering candy or not. Furthermore, families may want to know whose door their kids are knocking on before their kids knock. Security of the neighborhood and knowing who is participating in the holiday activity and who is not may be of concern. For this reason, kids and families may waste time by knocking on doors behind which there is no candy and parents may not be able to attain peace of mind by know whose door their kids are knocking on and/or whose candy their kids are eating.

### SUMMARY

Disclosed are a method, a device and/or a system for holiday expression and mapping including holiday broadcast data generation and publication in a constrained geospatial vicinity around a broadcast location of a neighborhood social network.

In one aspect, a method includes verifying a user of a geospatially constrained social network having a primary residence in a particular location associated with a claimed neighborhood based on at least one of an address data and a zip code data verified using at least one of a post card verification, a utility bill verification, a privately published access code and a neighbor vouching method using a processor and a memory. The method permits the user, verified in the geospatially constrained social network having the primary residence at the particular location, to place a holiday pushpin on a geospatial representation of a property boundary associated with the user. The method also generates a holiday map in which various homes associated with users of the geospatially constrained social network who have placed holiday pushpins on their property boundaries are published to other verified users in the claimed neighborhood. The method restricts the visibility of the holiday map to users who have verified their address in the claimed neighborhood. The method also denies access to the holiday map to users who have verified their addresses in neighborhoods different from the claimed neighborhood.

The holiday expression server may automatically generate a walking map of the claimed neighborhood based on a request of the users in the claimed neighborhood. The holiday map may be a Christmas lighting display map, an Independence Day fireworks map and/or a Halloween candy availability map. The holiday pushpin may be associated with the Halloween candy distribution by the user of the geospatially constrained social network and the holiday map may be a treat map. The method may provide automated verbal navigation guidance describing an optimal walking route to homes offering Halloween candy in the claimed neighborhood through a voice-navigation system of a mobile device associated with the user. The method may permit the user to set a time and/or day of candy availability associated with the holiday pushpin that the user may be able to select when candy will be available at their home and/or what kind of candy will be offered at their home.

The method may include annotating the holiday map based on real-time feedback from users of geospatially constrained social network such that the holiday map may be updated based on an availability, a rating, and/or a review of various items listed in the holiday map. The claimed neighborhood of the user may be activated based on a minimum number of other verified users in a threshold radial distance verified through a primary residential address associated with each of the other verified users through the post card verification, the utility bill verification, the privately published access code and/or the neighbor vouching method. The method may also permit a holiday broadcast data to be disseminated to adjacent neighborhoods that may have been claimed by different users in a manner that the holiday broadcast data may be optionally disseminated to the surrounding claimed neighborhoods based on a preference of the user.

The method may include the holiday pushpin generated through a data processing system radially distributed through an on-page posting, an electronic communication and/or a push notification delivered to desktops, mobile devices and/or data processing systems associated with users and their user profiles around an epicenter defined at the set of geospatial coordinates associated with the holiday broadcast data to all subscribed user profiles in a circular geo-fenced area. The geo-fenced area may be defined by a threshold distance from the set of geospatial coordinates associated with the holiday broadcast data through the radial algorithm of the neighborhood broadcasting system that may measure a distance away of each address associated with each user profile from a current geospatial location at the epicenter.

In another aspect, a method of a holiday expression server includes generating a treat map in a geospatially constrained social network in which users that have verified addresses associated with each listing in the treat map have a holiday pushpin placed on a visual representation of a property associated with each verified address when the users indicate that they are offering Halloween candy to neighborhood residents having verified addresses in the geospatially constrained social network using a processor and a memory. The medium includes, permitting the visibility of the treat map to users who have verified their address in the claimed neighborhood. The method denies access to the treat map to users who have verified their addresses in neighborhoods different from the claimed neighborhood.

The method may include verifying that a user of a geospatially constrained social network has a primary residence at a particular location associated with a claimed neighborhood based on an address data and/or a zip code data verified using a post card verification, a utility bill verification, a privately-published access code, and/or a neighbor vouching method. The user that has been verified in the geospatially constrained social network as having the primary residence at the particular location may be permitted to place a holiday pushpin on a geo-spatial representation of a property boundary associated with the user.

In yet another aspect, a method includes validating that a holiday broadcast data generated through a mobile device is associated with a verified user of the holiday expression server using a processor and a memory. The method verifies that a set of geospatial coordinates associated with the holiday broadcast data generated through the mobile device are trusted based on a claimed geospatial location of the verified user of the holiday expression server. The method includes determining that a time stamp associated with a creation date and a creation time of the holiday broadcast data generated through the mobile device is trusted based on the claimed geospatial location of the verified user of the holiday expression server. The method automatically publishes the holiday broadcast data generated through the mobile device on a set of user profiles having associated verified addresses in a threshold radial distance from the set of geospatial coordinates associated with the holiday broadcast data generated through the mobile device of the verified user of the holiday expression server using a radial algorithm.

The method may include determining that the holiday broadcast data is generated by the verified user of a neighborhood broadcast system when validating that the holiday broadcast data is associated with the mobile device. It may be determined that an application on the mobile device is communicating the holiday broadcast data to the geospatially constrained social network when the holiday broadcast data is processed. The verified user may be associated with a verified user profile in the geospatially constrained social network through the application on the mobile device. The holiday broadcast data generated through the mobile device as an holiday pushpin of the holiday broadcast may be presented in a geospatial map surrounding pre-populated residential and business listings in a surrounding vicinity, such that the holiday pushpin of the holiday broadcast may be automatically presented on the geospatial map and/or may be presented on the set of user profiles having associated verified addresses in the threshold radial distance from the set of geospatial coordinates associated with the holiday broadcast data generated through the mobile device of the verified user of the holiday expression server.

The holiday broadcast data generated through the mobile device may be radially distributed through an on-page posting, an electronic communication, and/or a push notification delivered to desktop and/or mobile devices associated with users and/or their user profiles around an epicenter that may be defined at the set of geospatial coordinates associated with the holiday broadcast data may be generated through the mobile device to all subscribed user profiles in a circular geo-fenced area defined by the threshold distance from the set of geospatial coordinates associated with the holiday broadcast data generated through the mobile device through the radial algorithm of a geo spatially constrained social network that measures a distance away of each address associated with each user profile from the current geospatial location at the epicenter.

The verified user may be permitted to drag and drop the holiday pushpin on any location on the geospatial map, and/or the method may automatically determine a latitude and/or a longitude associated with a placed location. The method may include geocoding a set of residential addresses in a neighborhood surrounding the mobile device. The set of residential addresses in the threshold radial distance from the claimed geospatial location of the verified user of the holiday expression server may be prepopulated in a neighborhood curation system communicatively coupled with the holiday expression server. The holiday broadcast data generated through the mobile device may be automatically published to the set of user profiles having associated verified addresses in the threshold radial distance from the claimed geospatial location of the verified user of the holiday expression server using the radial algorithm.

The method may include processing a claim request of the verified user generating the holiday broadcast data generated through the mobile device to be associated with an address of the neighborhood curation system. It may be determined if the claimable neighborhood in the neighborhood curation system is associated with a private neighborhood community in the claimable neighborhood of the neighborhood curation system. The verified user may be associated with the private neighborhood community in the claimable neighborhood of the neighborhood curation system if the private neighborhood community has been activated by at least one of the verified user and a different verified user.

The verified user may be permitted to draw a set of boundary lines in a form of a geospatial polygon such that the claimable neighborhood in a geospatial region surrounding the claim request may create the private neighborhood community in the neighborhood curation system if the private neighborhood community is inactive;

The claim request of the verified user generating the holiday broadcast data generated through the mobile device may be verified to be associated with a neighborhood address of the neighborhood curation system when the address is determined to be associated with at least one of a work address and a residential address of the verified user. The method may include simultaneously publishing the holiday broadcast data generated through the mobile device on the private neighborhood community associated with the verified user generating the holiday broadcast data generated through the mobile device in the threshold radial distance from the address associated with the claim request of the verified user of the neighborhood curation system when automatically publishing the holiday broadcast data generated through the mobile device on a set of user profiles (having associated verified addresses in the threshold radial distance from the claimed geospatial location of the verified user of the holiday expression server based on a set of preferences of the verified user) using the radial algorithm.

A summary data may be provided to the verified user generating the holiday broadcast data generated through the mobile device of how many user profile pages were updated with an alert of the holiday broadcast data generated through the mobile device when publishing the holiday broadcast data generated through the mobile device in at least one of the private neighborhood community and/or the set of user profiles having associated verified addresses in the threshold radial distance from the claimed geospatial location of the verified user of the holiday expression server based on the set of preferences of the verified user. The method may include live broadcasting the holiday broadcast data generated through the mobile device to the different verified user and/or other verified users in the private neighborhood community and/or currently within the threshold radial distance from the current geospatial location through a multicast algorithm of the holiday expression server such that a live broadcast may multicast to a plurality of data processing systems associated with each of the different user and the other verified users simultaneously when the mobile device of the verified user generating the live-broadcast enables broadcasting of the holiday broadcast data generated through the mobile device to any one of a geospatial vicinity around the mobile device of the verified user generating the broadcast and/or in any private neighborhood community in which the verified user has a non-transitory connection.

The different verified user and other verified users in at least one of the private neighborhood community may be permitted to bi-directionally communicate with the verified user generating the broadcast through the holiday expression server, wherein any private neighborhood community in which the verified user has the non-transitory connection may be the residential address of the verified user that has been confirmed by the holiday expression server as being associated with the verified user. The threshold distance may be between 0.2 and 0.4 miles from the set of geospatial coordinates associated with the holiday broadcast data generated through the mobile device to optimize a relevancy of the live-broadcast. The holiday expression server may include a crowdsourced moderation algorithm in which multiple neighbors to a geospatial area may determine what content contributed to the holiday expression server persists and which is deleted. The holiday expression server may permit users to mute messages of specific verified users to prevent misuse of the holiday expression server. Access to the holiday broadcast data may be restricted to the claimed neighborhood of the verified user. Access to the holiday broadcast data may be denied to users having verified addresses outside the claimed neighborhood of the verified user.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this disclosure are illustrated by way of example and not limitation in the figures of the accompanying drawings, in which like references indicate similar elements and in which:

FIG. 1 is a network view of a holiday expression server 100 having a radial distribution module communicating with a device that generates a radial broadcast through an internet protocol network using a radial algorithm of the radial distribution module of the holiday expression server 100, according to one embodiment.

FIG. 2 is an exploded view of the radial distribution module of FIG. 1 that applies the radial algorithm, according to one embodiment.

FIG. 3 is a broadcast view that demonstrates how the radial distribution module of FIG. 1 is used to communicate a holiday broadcast data to claimed user profiles, pre-seeded user profiles, and to telephone devices or internet-enabled devices of decoration services through a heterogeneous network formed through the internet protocol network of FIG. 1 and through a cellular network, according to one embodiment.

FIG. 4 is a radial operation view that illustrates an expansion of a threshold radial distance based on a claimed neighborhood at a radial boundary surrounding an epicenter formed by geo spatial coordinates of the device of FIG. 1, according to one embodiment.

FIG. 5 illustrates a remote association view in which a recipient device receives the holiday broadcast data from a mobile device based on a non-transitory claimed address associated with a profile of the recipient even when the mobile device is outside a threshold radial distance of a broadcast, according to one embodiment.

FIG. 6A is an treat map user interface view of the mobile device of FIG. 5 that shows how the user can generate and broadcast the broadcast data, according to one embodiment.

FIG. 6B is a navigation guidance user interface view of the recipient device of FIG. 5, in which a Halloween related broadcast data generated through the user interface of FIG. 6A includes voice-navigation to the user, according to one embodiment.

FIG. 6C is a broadcast recipient user interface view of the recipient device of FIG. 5 in which the recipient device is receiving a Halloween related live broadcast, according to one embodiment.

FIG. 6D is a summary data user interface view of the mobile device of FIG. 5 in which the user may see the recipients of the Halloween related broadcast and the recipients watching the live feed of FIG. 6C, according to one embodiment.

FIG. 7 is a claimed location user interface view that explains how a claimed user reviews their holiday broadcasts that they made and manages the neighborhoods that they have claimed, according to one embodiment.

FIG. 8 is a pushpin user interface view that explains how a user drags pushspins to a map including a broadcast pushpin, which is different than other pushpins in that a time and a location of the broadcast pushpin is fixed based on a set of geospatial coordinates associated with a mobile device of the claimed user of FIG. 7, according to one embodiment.

FIG. 9 is a process flow of radially distributing the holiday broadcast data of FIG. 3 as a notification data around an epicenter defined at the set of geospatial coordinates of FIG. 8 associated with the holiday broadcast data, according to one embodiment.

FIG. 10 is a table view illustrating data relationships between users, locations, and with a set of notification types needed to generate a broadcast, according to one embodiment.

FIG. 11 is a critical path view illustrating a flow based on time in which critical operations in establishing a bi-directional session between a verified user and those individuals receiving the holiday broadcast data of FIG. 3 is established, according to one embodiment.

FIG. 12 is a holiday broadcast response view illustrating a response being generated and broadcast by recipients in response to a holiday broadcast made from the user device of FIG. 1, according to one embodiment.

FIG. 13 is a social community view of a social community module 220, according to one embodiment.

FIG. 14 is a profile view of a profile module, according to one embodiment.

FIG. 15 is a contribute view of a neighborhood network module, according to one embodiment.

FIG. 16 is a diagrammatic system view of a data processing system in which any of the embodiments disclosed herein may be performed, according to one embodiment.

FIG. 17A is a user interface view of mapping user profile of the geographical location, according to one embodiment.

FIG. 17B is a user interface view of mapping of the unclaimed profile, according to one embodiment.

FIG. 18A is a user interface view of mapping of the unclaimed profile of the commercial user, according to one embodiment.

FIG. 18B is a user interface view of mapping of customizable business profile of the commercial user, according to one embodiment.

FIG. 19 is a user interface view of a group view associated with particular geographical location, according to one embodiment.

FIG. 20 is a user interface view of claim view, according to one embodiment.

FIG. 21 is a user interface view of a building builder, according to one embodiment.

FIG. 22 is a systematic view of communication of wiki data, according to one embodiment.

FIG. 23 is a systematic view of a network view, according to one embodiment.

FIG. 24 is a block diagram of a database, according to one embodiment.

FIG. 25 is an exemplary graphical user interface view for data collection, according to one embodiment.

FIG. 26 is an exemplary graphical user interface view of image collection, according to one embodiment.

FIG. 27 is an exemplary graphical user interface view of an invitation, according to one embodiment.

FIG. 28 is a flowchart of inviting the invitee(s) by the registered user, notifying the registered user upon the acceptance of the invitation by the invitee(s) and, processing and storing the input data associated with the user in the database, according to one embodiment.

FIG. 29 is a flowchart of adding the neighbor to the queue, according to one embodiment.

FIG. 30 is a flowchart of communicating brief profiles of the registered users, processing a hyperlink selection from the verified registered user and calculating and ensuring the Nmax degree of separation of the registered users away from verified registered users, according to one embodiment.

FIG. 31 is an N degree separation view, according to one embodiment.

FIG. 32 is a user interface view showing a map, according to one embodiment.

FIG. 33 is a user interface view displaying purchase options associated with Christmas decorations, according to one embodiment.

FIG. 34 is a user interface view displaying Halloween decoration representations associated with the occasion along with the residence representation on a geo-spatial map, according to one embodiment.

FIG. 35 is a user interface view displaying Fourth of July decoration representations associated with the occasion along with the residence representation on a geospatial map, according to one embodiment.

FIG. 36 is a user interface view displaying purchase options associated with Easter decorations, according to one embodiment.

FIG. 37 is a user interface view of selecting an occasion, according to one embodiment.

FIG. 38 is a block diagram representation displaying information associated with a user, according to one embodiment.

FIG. 39 is a flowchart of delivering decorations associated with the occasion based on a purchase, according to one embodiment.

FIG. 40 is a flowchart of receiving delivery of decorations associated with the occasion, according to one embodiment.

FIG. 41A is a process flow of displaying decoration representations on the residence geo-spatial map, according to one embodiment.

FIG. 41B is a continuation of the process flow of FIG. 20A, showing additional processes, according to one embodiment.

FIG. 42 is a process flow of making a purchase of decorations associated with the occasion, according to one embodiment.

FIG. 43 is a treat map view of a holiday map indicating neighborhood participation in treat giving at Halloween, according to one embodiment.

FIG. 44 is a view of a treat map promoter, according to one embodiment.

Other features of the present embodiments will be apparent from the accompanying drawings and from the detailed description that follows.

### DETAILED DESCRIPTION

Example embodiments, as described below, may be used to provide a method, a system and/or a device of holiday broadcast data generation and publication in a constrained geospatial vicinity around a broadcast location of a neighborhood social network. Although the present embodiments have been described with reference to specific example embodiments, it will be evident that various modifications and changes may be made to these embodiments without departing from the broader spirit and scope of the various embodiments.

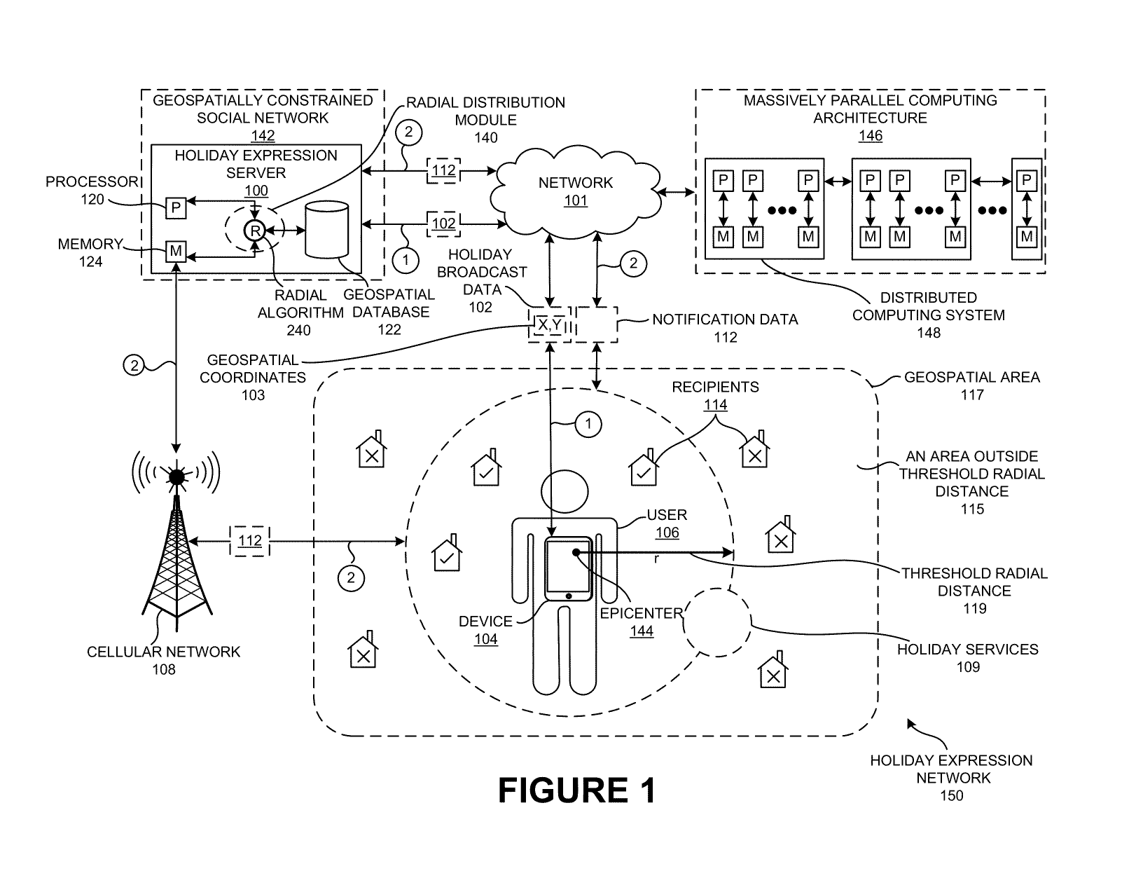

FIG. 1 is a network view of a holiday expression server 100 having a radial distribution module communicating with a device that generates a radial broadcast through an internet protocol network using a radial algorithm of the radial distribution module of the holiday expression server 100, according to one embodiment.

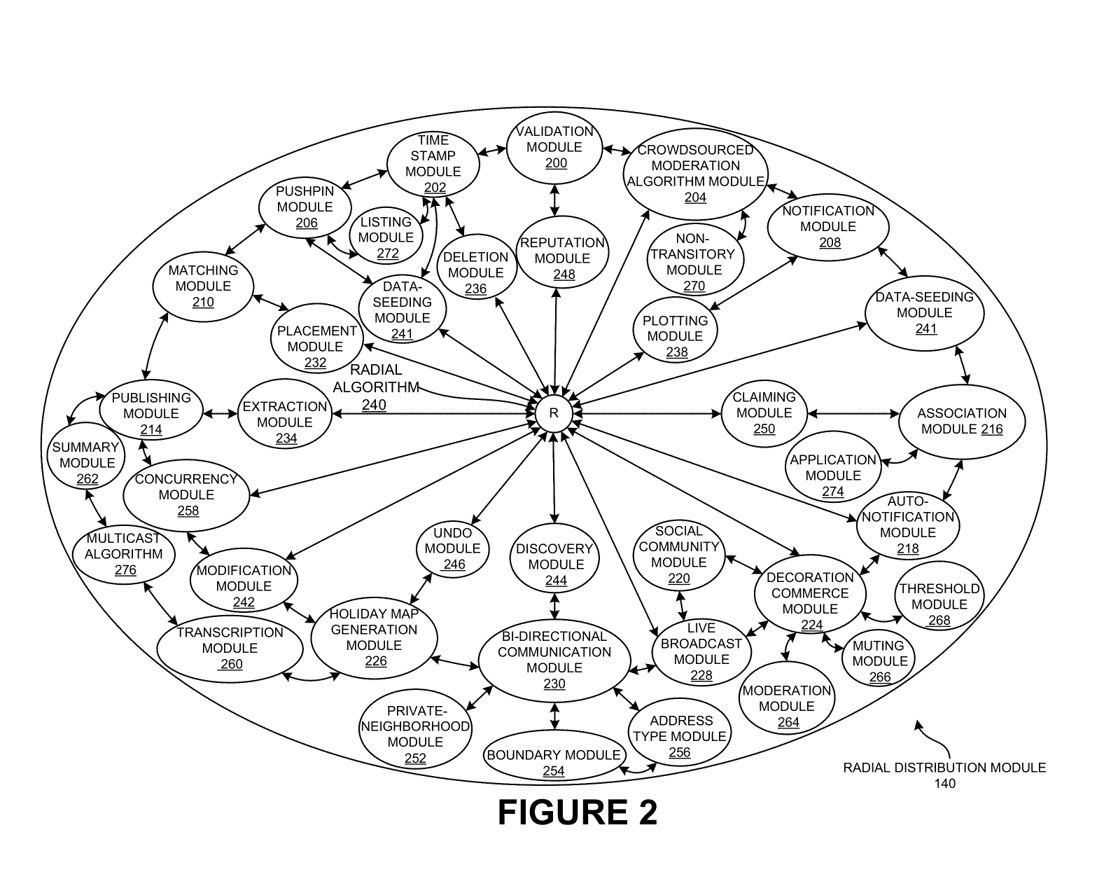

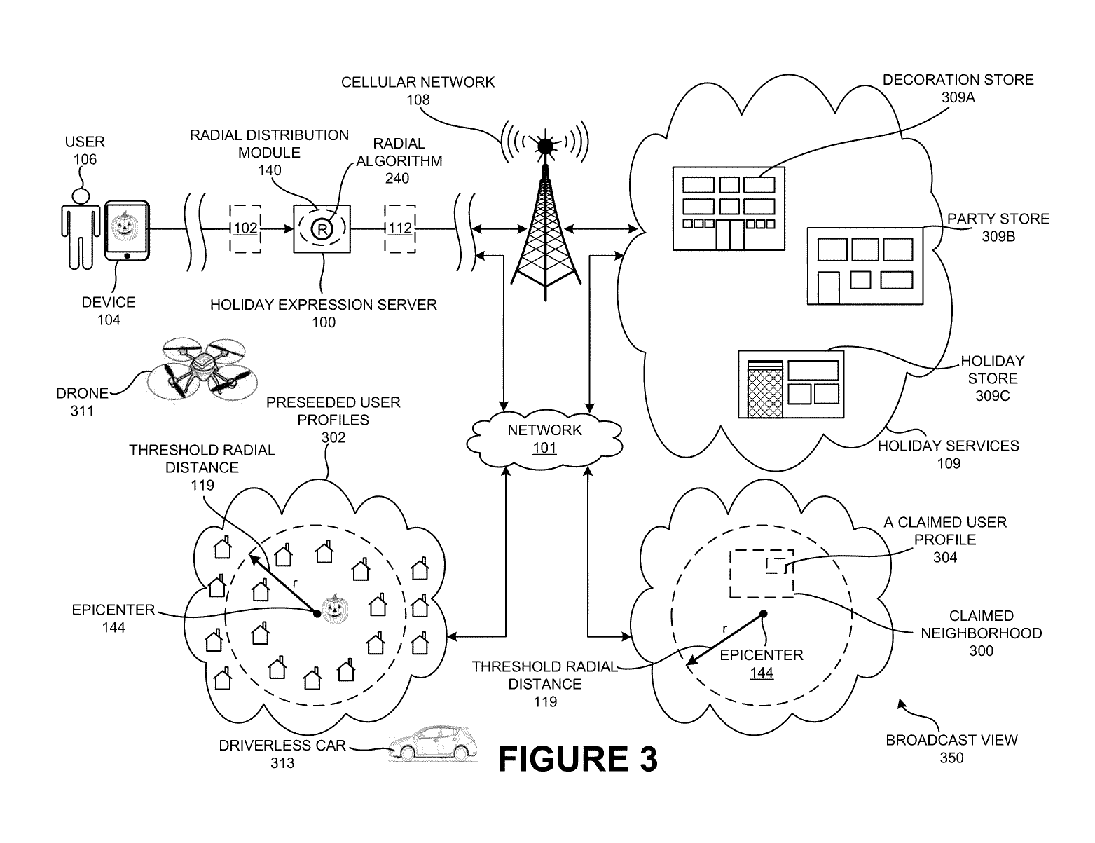

Particularly, FIG. 1 illustrates a holiday expression network 150, according to one embodiment. The embodiment of FIG. 1 describes a holiday expression server 100, a network 101, a holiday broadcast data 102, a set of geospatial coordinates 103, a device 104, a user 106, a cellular network 108, a set of holiday services 109 (including a decoration store 309A, a party store 309B and a holiday store 309C as will be described in FIG. 3), a notification data 112, a set of recipients 114, an area outside the threshold radial distance 115, a geospatial area 117, a threshold radial distance 119, a processor 120, a geospatial database 122, a memory 124, a radial distribution module 140 (e.g., that applies a radial algorithm 240 of FIG. 2 using a series of modules working in concert as described in FIG. 2), a geospatially constrained social network 142, an epicenter 144, a massively parallel computing architecture 146, and a distributed computing system 148.

The holiday expression server 100 includes a processor 120, a memory 124, and a geospatial database 122, according to the embodiment of FIG. 1. The holiday expression server 100 may be one or more server side data processing systems (e.g., web servers operating in concert with each other) that operate in a manner that provide a set of instructions to any number of client side devices (e.g., the device 104, a mobile device 504) communicatively coupled with the holiday expression server 100 through the network 101. For example, the holiday expression server 100 may be a computing system (e.g., or a group of computing systems) that operates in a larger client-server database framework (e.g., such as in a social networking software such as Nextdoor.com, Fatdoor.com, Facebook.com, etc.).

The device 104 (e.g., a mobile device 504 (e.g., a smartphone, a tablet, a laptop)) may access the holiday expression server 100 through the network 101 using a browser application of the mobile device (e.g., Google® Chrome) and/or through a client-side application downloaded to the device 104 (e.g., a mobile device 504) (e.g., a Nextdoor.com mobile application, a Fatdoor.com mobile application) operated by the user 106. In an alternate embodiment, a non-mobile computing device, such as a desktop computer (not shown) may access the holiday expression server 100 through the network 101.

The holiday broadcast data 102 may be communicated from the device 104 (e.g., a mobile device 504) to the holiday expression server 100 through the network 101. The holiday broadcast data 102 may include information about a holiday (e.g., an activity, intended participation, decoration displays) observed and/or performed by the user 106 to recipients 114 and/or the holiday services 109 through the network 101. For example, the holiday broadcast may relate to participation in giving out candy on Halloween, the time candy will be available, and/or the type of candy.

The holiday broadcast data 102 may be generated and distributed through an application of the radial distribution module 140 (e.g., that applies the radial algorithm 240 of FIG. 2 using a series of modules working in concert as described in FIG. 2) of the holiday expression server 100. The radial distribution module 140 (e.g., that applies the radial algorithm 240 of FIG. 2 using a series of modules working in concert as described in FIG. 2) may be a series of software functions/processes that simulates the experience of transmitting and receiving local broadcasts for the verified user, according to one embodiment.

Using an internet protocol based network (e.g., the network 101), the holiday expression server 100 may be able to use the radial distribution module 140 (e.g., that applies the radial algorithm 240 of FIG. 2 using a series of modules working in concert as described in FIG. 2) to simulate a radio frequency (RF) based communication network using an IP network topology of the network 101. Therefore, the holiday broadcast data 102 can be distributed using the holiday expression server 100 to a geo-constrained area (e.g., the recipients 114 in the geospatial area 117 and/or the holiday services 109 in a geo-constrained area around an area in which the device 104 (e.g., a mobile device 504) operates without requiring expensive broadcast towers, transceivers, transmitters, amplifiers, antennas, tuners and/or wave generating and interpreting hardware (e.g., as may be required in local ham radio communication, frequency modulation (FM) audio systems, etc.). The radial distribution module 140 (e.g., that applies the radial algorithm 240 of FIG. 2 using a series of modules working in concert as described in FIG. 2) may recreate an experience of communication between parties in a geospatially restricted area (e.g., for example in the same city, in the surrounding neighborhood, in the same zip code, in the same building, in the same claimed neighborhood) through the use of an Internet protocol network. The holiday expression server 100 may overcome technical challenges of determining a user's geospatial location, calculating distance to other verified users based on relative geospatial locations, and/or coordinating information with a database of geo-coded information of interest (e.g., using the geospatial database 122) using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2), as a function/module of the holiday expression server 100, may determine the location of the user 106, the distance between the user 106 and other verified users, and the distance between the user 106 and locations of interest. With that information, the radial distribution module 140 (e.g., that applies the radial algorithm 240 of FIG. 2 using a series of modules working in concert as described in FIG. 2) may further determine which verified users are within a predetermined vicinity of a user 106. This set of verified users within the vicinity of another verified user may then be determined to be receptive to broadcasts transmitted by the user 106 and to be available as transmitters of broadcasts to the user 106.

The radial distribution module 140 (e.g., that applies the radial algorithm 240 of FIG. 2 using a series of modules working in concert as described in FIG. 2) in effect may create a link between verified users of the network 101 that allows the users to communicate with each other, and this link may be based on the physical distance between the users as measured relative to a current geospatial location of the device 104 (e.g., a mobile device 504) with a claimed and verified (e.g., through a verification mechanism such as a postcard verification, a utility bill verification, and/or a vouching of the user with other users) non-transitory location (e.g., a home location, a work location) of the user and/or other users. In an alternate embodiment, the transitory location of the user (e.g., their current location, a current location of their vehicle and/or mobile phone) and/or the other users may also be used by the radial algorithm to determine an appropriate threshold distance for broadcasting a message.

Furthermore, the radial distribution module 140 (e.g., that applies the radial algorithm 240 of FIG. 2 using a series of modules working in concert as described in FIG. 2) may automatically update a set of pages associated with profiles of individuals and/or businesses that have not yet joined the network based on preseeded address information. In effect, the radial distribution module 140 (e.g., that applies the radial algorithm 240 of FIG. 2 using a series of modules working in concert as described in FIG. 2) may update preseeded pages in a geo-constrained radial distance from where a broadcast originates (e.g., using an epicenter 144 calculated from the current location of the device 104 (e.g., a mobile device 504)) with information about the holiday broadcast data 102. In effect, through this methodology, the radial distribution module 140 (e.g., that applies the radial algorithm 240 of FIG. 2 using a series of modules working in concert as described in FIG. 2) may leave ‘inboxes’ and/or post ‘alerts’ on pages created for users that have not yet signed up based on a confirmed address of the users through a public and/or a private data source (e.g., from Infogroup®, from a white page directory, etc.).

The radial distribution module 140 (e.g., that applies the radial algorithm 240 of FIG. 2 using a series of modules working in concert as described in FIG. 2) of the holiday expression server 100 may be different from previous implementations because it is the first implementation to simulate the experience of local radio transmission between individuals using the internet and non-radio network technology by basing their network broadcast range on the proximity of verified users to one another, according to one embodiment.

FIG. 1 illustrates a number of operations between the device 104 and the recipients 114 and/or the holiday services 109. Particularly, circle ‘1’ of FIG. 1 illustrates that the user of the device 104 communicates the holiday broadcast data 102 to the holiday expression server 100 using the network 101. Then, after applying the radial algorithm 240 utilizing the radial distribution module 140, the holiday expression server 100 generates and communicates an appropriate notification data (e.g., the notification data 112) associated with the holiday broadcast data 102 to a geospatially distributed set of recipients 114 in a radial area (radius represented as ‘r’ of FIG. 1) in a geospatial vicinity from an epicenter 144 associated a present geospatial location with the device 104 as illustrated as circle ‘2’ in FIG. 1.

The radial algorithm 240 may operate as follows, according to one embodiment. The radial algorithm may utilize a radial distribution function (e.g., a pair correlation function)

g(r)

in the holiday expression network 150. The radial distribution function may describe how density varies as a function of distance from a user 106, according to one embodiment.

If a given user 106 is taken to be at the origin O (e.g., the epicenter 144), and if

ρ=N/V

is the average number density of recipients 114 in the holiday expression network 150, then the local time-averaged density at a distance r from O is

ρg(r)

according to one embodiment. This simplified definition may hold for a homogeneous and isotropic type of recipients 114, according to one embodiment of the radial algorithm 240.

A more anisotropic distribution (e.g., exhibiting properties with different values when measured in different directions) of the recipients 114 will be described below, according to one embodiment of the radial algorithm 240. In simplest terms it may be a measure of the probability of finding a recipient at a distance of r away from a given user 106, relative to that for an ideal distribution scenario, according to one embodiment. The anisotropic algorithm involves determining how many recipients 114 are within a distance of r and r+dr away from the user 106, according to one embodiment. The radial algorithm 240 may be determined by calculating the distance between all user pairs and binning them into a user histogram, according to one embodiment.

The histogram may then be normalized with respect to an ideal user at the origin o, where user histograms are completely uncorrelated, according to one embodiment. For three dimensions (e.g., such as a building representation in the geospatially constrained social network 142 in which there are multiple residents in each floor), this normalization may be the number density of the system multiplied by the volume of the spherical shell, which mathematically can be expressed as

g(r)_{I}=4πr²ρdr

where ρ may be the user density, according to one embodiment of the radial algorithm 240.

The radial distribution function of the radial algorithm 240 can be computed either via computer simulation methods like the Monte Carlo method, or via the Ornstein-Zernike equation, using approximative closure relations like the Percus-Yevick approximation or the Hypernetted Chain Theory, according to one embodiment.

This may be important because by confining the broadcast reach of a verified user in the holiday expression network 150 to a specified range, the radial distribution module 140 (e.g., that applies the radial algorithm 240 of FIG. 2 using a series of modules working in concert as described in FIG. 2) may replicate the experience of local radio broadcasting and enable verified users to communicate information to their immediate neighbors as well as receive information from their immediate neighbors in areas that they care about, according to one embodiment. Such methodologies can be complemented with hyperlocal advertising targeted to potential users of the holiday expression server 100 on preseeded profile pages and/or active user pages of the holiday expression server 100. Advertisement communications thus may become highly specialized and localized resulting in an increase in their value and interest to the local verified users of the network through the holiday expression server 100. For example, advertisers may wish to communicate helpful home security devices to a set of users located in a geospatial area with a high concentration of home break-in broadcasts.

The radial distribution module 140 (e.g., that applies the radial algorithm 240 of FIG. 2 using a series of modules working in concert as described in FIG. 2) may also have wide application as it may solve the problem of trying to locate a receptive audience to a verified user's broadcasts, whether that broadcast may be a holiday activity (e.g., a haunted house, Easter egg hunt), a one's personal music, an advertisement for a car for sale, a solicitation for a new employee, and/or a recommendation for a good restaurant in the area. This radial distribution module 140 (e.g., that applies the radial algorithm 240 of FIG. 2 using a series of modules working in concert as described in FIG. 2) may eliminate unnecessarily broadcasting that information to those who are not receptive to it, both as a transmitter and as a recipient of the broadcast. The radial algorithm saves both time (which may be limited in a holiday context) and effort of every user involved by transmitting information only to areas that a user cares about, according to one embodiment.

In effect, the radial algorithm of the holiday expression server 100 enables users to notify people around locations that are cared about (e.g., around where they live, work, and/or where they are physically located). In one embodiment, the user 106 can be provided ‘feedback’ and/or a communication that the recipient 114 may be responding to the holiday activity (e.g., a holiday decoration display, a holiday celebration) after the holiday broadcast data 102 may be delivered to the recipients 114 and/or to the holiday services 109 using the radial distribution module 140 (e.g., that applies the radial algorithm 240 of FIG. 2 using a series of modules working in concert as described in FIG. 2) of the holiday expression server 100. For example, after the holiday broadcast data 102 may be delivered, the device 104 (e.g., a mobile device 504) may display a message saying: “3256 neighbors around a 1 radius from you have been notified on their profile pages of your holiday broadcast in Menlo Park and 4 people are responding” and/or “8356 neighbors around a 2.7 radius from you have been notified of your holiday broadcast.”

In one embodiment, deliveries may be made from a ‘neighborhood drone’ (e.g., an unmanned aerial vehicle such as the drone 311) operated by the geospatially constrained social network 142. For example, Fatdoor.com may operate a set of drones (e.g., the drone 311 of FIG. 3) that can be dispatched and automatically instructed to pick up various holiday displays and deliver them to a resident of a home. The drone 311 may be aircraft without a human pilot on board. A flight path of the drone 311 may be a server of the geo-spatially constrained social network 142 either autonomously by computers in the drone 311 and/or through an automated navigation system based on a mapping algorithm. In one embodiment, a neighbor offering a used item (e.g., a used Halloween mask) may request that a holiday drone operated by Fatdoor.com be summoned by clicking on ‘request pickup’ on their mobile device. This may instruct the holiday drone to fly to a backyard and/or front yard the a home of a neighbor and physically pick up the used holiday mask and deliver it to a borrower, minimizing time to do neighborhood errands. A neighbor who is selling and/or giving away an item may receive an alert when a drone arrives through their mobile device. Similarly, the recipient of the item may receive an alert when the drone delivery is ready. Furthermore, this way, a limited set of drones can be shared by a set of users. Alternative to drones, Fatdoor and/or neighbors themselves may instruct driverless cars (e.g., the driverless car 313 of FIG. 3) that they operate to pick up and deliver gifts to each other through their mobile device using the geo-spatial social network 142. The driverless cars may be personally owned and/or owned by the geospatially constrained social network.

For example the driverless car 313 may be an autonomous car (e.g., a self-driving car, robot car) that is an autonomous vehicle capable of fulfilling the transportation capabilities of a traditional car. As an autonomous vehicle, the driverless car 313 may be capable of sensing its environment and navigating without human input.

The driverless car 313 may be an autonomous vehicle that senses its surroundings with such techniques as radar, lidar, GPS, and computer vision. Advanced control systems may interpret sensory information to identify appropriate navigation paths, as well as obstacles and relevant signage to/from a home offering a holiday item for sale in the geospatially constrained social network 142. The driverless car 313 may update its maps based on sensory input, thereby permitting the driverless car 313 to keep track of their position even when conditions change or when they enter uncharted environments in the neighborhood.

The various embodiments described herein of the holiday expression server 100 using the radial distribution module 140 (e.g., that applies the radial algorithm 240 of FIG. 2 using a series of modules working in concert as described in FIG. 2) may solve a central problem of internet radio service providers (e.g., Pandora) by retaining cultural significance related to a person's locations of association. For example, the radial distribution module 140 (e.g., that applies the radial algorithm 240 of FIG. 2 using a series of modules working in concert as described in FIG. 2) may be used to ‘create’ new radio stations, television stations, and/or mini alert broadcasts to a geospatially constrained area on one end, and provide a means for those ‘tuning in’ to consume information posted in a geospatial area that the listener cares about and/or associates themselves with. The information provided can be actionable in that the user 106 may be able to secure new opportunities through face to face human interaction and physical meeting not otherwise possible in internet radio scenarios.

The radial algorithm may be a set of instructions that may enable users (e.g., verified users, non-verified users) of the Nextdoor.com and Fatdoor.com websites and applications to broadcast their activities (e.g., trick or treat participation, Easter egg hunt, garage sale, t-shirt sale, crime alert) to surrounding neighbors within a claimed neighborhood and to guests of a claimed neighborhood, according to one embodiment. The radial algorithm may be new because current technology does not allow for users of a network (e.g., Nextdoor.com, Fatdoor.com) to locally broadcast their activity to a locally defined geospatial area. With the radial algorithm, users of the network may communicate with one another in a locally defined manner, which may present more relevant information and activities, according to one embodiment. For example, if a verified user of the network broadcasts a holiday activity, locally defined neighbors of the verified user may be much more interested in responding than if they observed a holiday activity on a general news broadcast on traditional radio, according to one embodiment. The radial distribution module 140 may solve the problem of neighbors living in the locally defined geospatial area who don't typically interact, and allows them to connect within a virtual space that did not exist before, according to one embodiment. Prior to this embodiment of the radial algorithm 240 operating through the radial distribution module 140, community boards (e.g., stolen or missing item boards) may have been a method of distributing content in a surrounding neighborhood effectively. However, there may have been little ways to easily distribute content related to exigent circumstances and/or with urgency in a broadcast-like manner to those listening around a neighborhood through mobile devices until the various embodiments applying the radial distribution module 140 as described herein.

A radial algorithm 240 may be a method of calculating a sequence of operations, and in this case a sequence of radio operations, according to one embodiment. Starting from an initial state and initial input, the radial algorithm 240 describes a computation that, when executed, proceeds through a finite number of well-defined successive states, eventually producing radial patterned distribution (e.g., simulating a local radio station), according to one embodiment.

The holiday expression server 100 may solve technical challenges through the radial distribution module 140 (e.g., that applies the radial algorithm 240 of FIG. 2 using a series of modules working in concert as described in FIG. 2) by implementing a vigorous screening process to screen out any lewd or vulgar content in one embodiment. For example, what may be considered lewd content sometimes could be subjective, and verified users could argue that the operator of the holiday expression server 100 is restricting their constitutional right to freedom of speech (e.g., if the holiday expression server 100 is operated by a government entity) through a crowd-moderation capability enabled by the radial distribution module 140 (e.g., that applies the radial algorithm 240 of FIG. 2 using a series of modules working in concert as described in FIG. 2), according to one embodiment. In one embodiment, verified users may sign an electronic agreement to screen their content and agree that the holiday expression network 150 may delete any content that it deems inappropriate for broadcasting, through the radial distribution module 140 (e.g., that applies the radial algorithm 240 of FIG. 2 using a series of modules working in concert as described in FIG. 2) according to one embodiment. For example, it may be determined that a lost item such as a misplaced set of car keys does not qualify as a holiday related item that should be broadcast.

The radial distribution module 140 (e.g., that applies the radial algorithm 240 of FIG. 2 using a series of modules working in concert as described in FIG. 2), in addition to holiday broadcasts, may allow verified users to create and broadcast their own radio show, e.g., music, talk show, commercial, instructional contents, etc., and to choose their neighborhood(s) for broadcasting based on a claimed location, according to one embodiment. The radial distribution module 140 (e.g., that applies the radial algorithm 240 of FIG. 2 using a series of modules working in concert as described in FIG. 2) may allow users to choose the neighborhoods that they would want to receive the broadcasts, live and recorded broadcasts, and/or the types and topics (e.g., Halloween, haunted house, Christmas, light display) of broadcasts that interest them.

The radial distribution module 140 (e.g., that applies the radial algorithm 240 of FIG. 2 using a series of modules working in concert as described in FIG. 2) based approach of the holiday expression server 100 may be a completely different concept from the currently existing neighborhood (e.g., geospatial) social networking options. The radial distribution module 140 (e.g., that applies the radial algorithm 240 of FIG. 2 using a series of modules working in concert as described in FIG. 2) may also allow the user to create his/her own radio station, television station and/or other content such as the holiday broadcast data 102 and distribute this content around locations to users and preseeded profiles around them. For example, the user may wish to broadcast their live reporting of a Fourth of July fireworks display and/or Halloween haunted house. The radial distribution module 140 (e.g., that applies the radial algorithm 240 of FIG. 2 using a series of modules working in concert as described in FIG. 2) can allow verified users to create their content and broadcast in the selected geospatial area. It also allows verified listeners to listen to only the relevant local broadcasts of their choice.

The radial distribution module 140 (e.g., that applies the radial algorithm 240 of FIG. 2 using a series of modules working in concert as described in FIG. 2) may be important because it may provide any verified user the opportunity to create his/her own radial broadcast message (e.g., can be audio, video, pictoral and/or textual content) and distribute this content to a broad group. Radial distribution module 140 (e.g., that applies the radial algorithm 240 of FIG. 2 using a series of modules working in concert as described in FIG. 2) may also allow verified listeners to listen to any missed live broadcasts through the prerecorded features, according to one embodiment. Through this, the radial distribution module 140 (e.g., that applies the radial algorithm 240 of FIG. 2 using a series of modules working in concert as described in FIG. 2) changes the way social networks (e.g., Nextdoor, Fatdoor, Facebook, Path, etc.) operate by enabling location centric broadcasting to regions that a user cares about, according to one embodiment. Radial distribution module 140 (e.g., that applies the radial algorithm 240 of FIG. 2 using a series of modules working in concert as described in FIG. 2) may solve a technical challenge by defining ranges based on a type of a holiday broadcast, a type of neighborhood, and/or boundary condition of a neighborhood by analyzing whether the holiday broadcast data 102 may be associated with a particular kind of recipient, a particular neighborhood, a temporal limitation, and/or through another criteria.

By using the radial distribution module 140 (e.g., that applies the radial algorithm 240 of FIG. 2 using a series of modules working in concert as described in FIG. 2) of the holiday expression server 100 the user 106 may be able to filter irrelevant offers and information provided by broadcasts. In one embodiment, only the broadcasting user (e.g., the user 106) may be a verified user to create accountability for a particular broadcast and/or credibility of the broadcaster. In this embodiment, recipients 114 of the broadcast may not need to be verified users of the holiday expression network. By directing traffic and organizing the onslaught of broadcasts, the radial distribution module 140 (e.g., that applies the radial algorithm 240 of FIG. 2 using a series of modules working in concert as described in FIG. 2) of the holiday expression server 100 may be able to identify the origins and nature of each group of incoming information and locate recipients 114 that are relevant/interested in the holiday broadcast data 102, maximizing the effective use of each broadcast. For example, the recipient 114 may be able to specify that they do not celebrate Halloween so that they would be a relevant recipient 114 for broadcast data regarding Halloween. In another example, a recipient 114 may specify that they are a Jewish such that they may not receive Christmas related holiday broadcasts, according to one embodiment.

The radial distribution module 140 (e.g., that applies the radial algorithm 240 of FIG. 2 using a series of modules working in concert as described in FIG. 2) of the holiday expression server 100 may process the input data from the device 104 (e.g., a mobile device 504) in order to identify which notification(s) to broadcast to which individual(s). This may be separate from a traditional radio broadcast as it not only geographically constrains broadcasters and recipients 114 but also makes use of user preferences in order to allow broadcasters to target an optimal audience and allow recipients 114 to alter and customize what they consume. The user 106 may associate his/herself with a non-transitory address in order to remain constantly connected to their neighborhood and/or neighbors even when they themselves or their neighbors are away. The radial algorithm 240 may be also unique from a neighborhood social network (e.g., the geospatially constrained social network 142) as it permits users to broadcast emergencies, information, audio, video etc. to other users, allowing users to create their own stations.

In order to implement the radial distribution module 140 (e.g., that applies the radial algorithm 240 of FIG. 2 using a series of modules working in concert as described in FIG. 2), geospatial data may need to be collected and amassed in order to create a foundation on which users may sign up and verify themselves by claiming a specific address, associating themselves with that geospatial location. The radial distribution module 140 (e.g., that applies the radial algorithm 240 of FIG. 2 using a series of modules working in concert as described in FIG. 2) may then be able to utilize the geospatial database 122 to filter out surrounding noise and deliver only relevant data to recipients 114. In order to accomplish this, the radial distribution module 140 (e.g., that applies the radial algorithm 240 of FIG. 2 using a series of modules working in concert as described in FIG. 2) may be able to verify the reliability of geospatial coordinates, time stamps, and user information associated with the device 104 (e.g., a mobile device 504). In addition, threshold geospatial radii, private neighborhood boundaries, and personal preferences may be established in the holiday expression server 100 and accommodated using the radial distribution module 140 (e.g., that applies the radial algorithm 240 of FIG. 2 using a series of modules working in concert as described in FIG. 2). The geospatial database 122 may work in concert with the radial distribution module 140 (e.g., that applies the radial algorithm 240 of FIG. 2 using a series of modules working in concert as described in FIG. 2) to store, organize, and manage broadcasts, pushpins, user profiles, preseeded user profiles, metadata, and epicenter 144 locations associated with the geospatially constrained social network 142 (e.g., a neighborhood social network such as Fatdoor.com, Nextdoor.com).

The radial algorithm 240 may be used to calculate relative distances between each one of millions of records as associated with each placed geo-spatial coordinate in the geospatially constrained social network 142 (e.g., a neighborhood social network such as Fatdoor.com, Nextdoor.com). Calculations of relative distance between each geospatial coordinate can be a large computational challenge because of the high number of reads, writes, modify, and creates associated with each geospatial coordinate added to the geospatially constrained social network 142 and subsequent recalculations of surrounding geospatial coordinates associated with other users and/or other profile pages based a relative distance away from a newly added set of geospatial coordinates (e.g., associated with the holiday broadcast data 102 and/or with other pushpin types). To overcome this computational challenge, the radial algorithm may leverage a massively parallel computing architecture 146 through which processing functions are distributed across a large set of processors accessed in a distributed computing system 148 through the network 101.

In order to achieve the utilization of the massively parallel computing architecture 146 in a context of a radial distribution function of a geospatially constrained social network 142, a number of technical challenges have been overcome in at least one embodiment. Particularly, the radial distribution module 140 constructs a series of tables based on an ordered geospatial ranking based on frequency of interaction through a set of ‘n’ number of users simultaneously interacting with the geospatially constrained social network 142, in one preferred embodiment. In this manner, sessions of access between the holiday expression server 100 and users of the holiday expression server 100 (e.g., the user 106) may be monitored based on geospatial claimed areas of the user (e.g., a claimed work and/or home location of the user), and/or a present geospatial location of the user. In this manner, tables associated with data related to claimed geospatial areas of the user and/or the present geospatial location of the user may be anticipatorily cached in the memory 124 to ensure that a response time of the geospatially constrained social network 142 may be not constrained by delays caused by extraction, retrieval, and transformation of tables that are not likely to be required for a current and/or anticipated set of sessions between users and the holiday expression server 100.

In a preferred embodiment, an elastic computing environment may be used by the radial distribution module 140 to provide for increase/decreases of capacity within minutes of a database function requirement. In this manner, the radial distribution module 140 can adapt to workload changes based on number of requests of processing simultaneous and/or concurrent requests associated with holiday broadcast data 102 by provisioning and deprovisioning resources in an autonomic manner, such that at each point in time the available resources match the current demand as closely as possible.

The radial distribution module 140 (e.g., that applies the radial algorithm 240 of FIG. 2 using a series of modules working in concert as described in FIG. 2) may be a concept whereby a server communicating data to a dispersed group of recipients 114 over a network 101, which may be an internet protocol based wide area network (as opposed to a network communicating by radio frequency communications) communicates that data only to a geospatially-constrained group of recipients 114. The radial distribution module 140 (e.g., that applies the radial algorithm 240 of FIG. 2 using a series of modules working in concert as described in FIG. 2) may apply a geospatial constraint related to a radial distance away from an origin point, or a constraint related to regional, state, territory, county, municipal, neighborhood, building, community, district, locality, and/or other geospatial boundaries.

The radial distribution module 140 (e.g., that applies the radial algorithm 240 of FIG. 2 using a series of modules working in concert as described in FIG. 2) may be new as applied to data traveling over wide area networks using internet protocol topology in a geospatial social networking and commerce context, according to one embodiment. While radio broadcasts, by their nature, are transmitted in a radial pattern surrounding the origin point, there may be no known mechanism for restricting access to the data only to verified users of a service subscribing to the broadcast. As applied to wired computer networks, while techniques for applying geospatial constraints have been applied to search results, and to other limited uses, there has as yet been no application of geospatial constraint as applied to the various embodiments described herein using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2) may be roughly analogous to broadcast radio communications such as a) in broadcast radio, b) in wireless computer networking, and c) in mobile telephony. However, all of these systems broadcast their information promiscuously, making the data transmitted available to anyone within range of the transmitter who may be equipped with the appropriate receiving device. In contrast, the radial distribution module 140 (e.g., that applies the radial algorithm 240 of FIG. 2 using a series of modules working in concert as described in FIG. 2) herein describes a system in which networks are used to transmit data in a selective manner in that information may be distributed around a physical location of homes or businesses in areas of interest/relevancy.

The radial distribution module 140 (e.g., that applies the radial algorithm 240 of FIG. 2 using a series of modules working in concert as described in FIG. 2) may solve a problem of restricting data transmitted over networks to specific users who are within a specified distance from the individual who originates the data. In a broad sense, by enabling commerce and communications that are strictly limited within defined neighborhood boundaries, the radial distribution module 140 (e.g., that applies the radial algorithm 240 of FIG. 2 using a series of modules working in concert as described in FIG. 2) may enable the geospatially constrained social network 142 (e.g., a neighborhood social network such as Fatdoor.com, Nextdoor.com) communications, attacking the serious social conditions of anonymity and disengagement in community that afflict the nation and, increasingly, the world.

The radial distribution module 140 (e.g., that applies the radial algorithm 240 of FIG. 2 using a series of modules working in concert as described in FIG. 2) may comprise one or more modules that instruct the holiday expression server 100 to restrict the broadcasting of the holiday broadcast data 102 to one or more parts of the geospatial area 117. For example, in the embodiment of FIG. 1, the radial distribution module 140 (e.g., that applies the radial algorithm 240 of FIG. 2 using a series of modules working in concert as described in FIG. 2) may instruct the holiday expression server 100 to broadcast the holiday broadcast data 102 to the recipients 114 but not to the area outside the threshold radial distance 119.

In one or more embodiments, the radial distribution module 140 (e.g., that applies the radial algorithm 240 of FIG. 2 using a series of modules working in concert as described in FIG. 2) may allow the holiday expression server 100 to function in manner that simulates a traditional radio broadcast (e.g., using a radio tower to transmit a radio frequency signal) in that both the holiday expression server 100 and the radio broadcast are restricted in the geospatial scope of the broadcast transmission. In one or more embodiments, the radial distribution module 140 (e.g., that applies the radial algorithm 240 of FIG. 2 using a series of modules working in concert as described in FIG. 2) may prevent the broadcast of the holiday broadcast data 102 to any geospatial area to which the user 106 does not wish to transmit the holiday broadcast data 102, and/or to users that have either muted and/or selectively subscribed to a set of broadcast feeds.

The radial distribution module 140 (e.g., that applies the radial algorithm 240 of FIG. 2 using a series of modules working in concert as described in FIG. 2) may analyze the holiday broadcast data 102 to determine which recipients 114 may receive notification data 112 within the threshold radial distance 119 (e.g., set by the user 106 and/or auto calculated based on a type of broadcast). The radial distribution module 140 (e.g., that applies the radial algorithm 240 of FIG. 2 using a series of modules working in concert as described in FIG. 2) may use a variety of parameters, including information associated with the holiday broadcast data (e.g., location of the holiday activity, type of activity, etc.) to determine the threshold radial distance 119.

The radial distribution module 140 (e.g., that applies the radial algorithm 240 of FIG. 2 using a series of modules working in concert as described in FIG. 2) may also determine which verified addresses associated with recipients 114 having verified user profiles are located within the threshold radial distance 119. The radial distribution module 140 (e.g., that applies the radial algorithm 240 of FIG. 2 using a series of modules working in concert as described in FIG. 2) may then broadcast the notification data 112 to the profiles and/or mobile devices of the verified users having verified addresses within the threshold radial distance 119.

The radial distribution module 140 (e.g., that applies the radial algorithm 240 of FIG. 2 using a series of modules working in concert as described in FIG. 2) may therefore simulate traditional radio broadcasting (e.g., from a radio station transmission tower) over the IP network. Thus, the radial distribution module 140 (e.g., that applies the radial algorithm 240 of FIG. 2 using a series of modules working in concert as described in FIG. 2) may allow the broadcast to include information and data that traditional radio broadcasts may not be able to convey, for example geospatial coordinates and/or real-time bi-directional communications. Additionally, the radial distribution module 140 (e.g., that applies the radial algorithm 240 of FIG. 2 using a series of modules working in concert as described in FIG. 2) may allow individual users low-entry broadcast capability without resort to expensive equipment and/or licensing by the Federal Communications Commission (FCC).

Another advantage of this broadcast via the radial distribution module 140 (e.g., that applies the radial algorithm 240 of FIG. 2 using a series of modules working in concert as described in FIG. 2) may be that it may bypass obstructions that traditionally disrupt radio waves such as mountains and/or atmospheric disturbances. Yet another advantage of the radial distribution module 140 (e.g., that applies the radial algorithm 240 of FIG. 2 using a series of modules working in concert as described in FIG. 2) may be that it may expand the physical distance of broadcast capability without resort to the expense ordinarily associated with generating powerful carrier signals. In yet another advantage, the radial distribution module 140 (e.g., that applies the radial algorithm 240 of FIG. 2 using a series of modules working in concert as described in FIG. 2) may allow for almost unlimited channels and/or stations as compared to traditional radio where only a narrow band of electromagnetic radiation has been appropriated for use among a small number of entities by government regulators (e.g., the FCC).

The user 106 may be an individual who operates the device 104 (e.g., a mobile device 504) to generate the holiday broadcast data 102. It will be understood by those skilled in the art that the verified nature of the user may be an optional characteristic in an alternate embodiment. This means that in an alternate embodiment, any user (whether verified or not) may generate the holiday broadcast data 102 through the device 104 (e.g., a mobile device 504). In another alternative embodiment, the user 106 may be an electronic sensor, such as a detection sensor device (e.g., a sensory detection sensor device such as a motion detector, a chemical detection device (for example, to sense a natural gas leak), a gunshot listening sensor, etc.), and/or an appliance (e.g., a refrigerator, a home security network, and/or a motion detector). It should also be noted that the ‘mobile’ nature of the device 104 may be optional in yet another alternative embodiment. In such an alternate embodiment, any computing device, whether mobile/portable or fixed in location may generate the holiday broadcast data 102.

The cellular network 108 may be associated with a telephone carrier (e.g., such as AT&T, Sprint, etc.) that provides an infrastructure through which communications are generated between the holiday expression server 100 and the holiday services 109 using the radial algorithm 240. For example, the cellular network 108 may provide a communication infrastructure through which the holiday broadcast data 102 may be communicated as voice and/or text messages through telephones (e.g., standard telephones and/or smart phones) operated by at least some of the holiday services 109 of FIG. 1. It should be understood that in one embodiment, the holiday services 109 are paid subscribers/customers of the geospatially constrained social network 142 in a manner such that each of the holiday services 109 may pay a fee per received holiday broadcast data 102, and/or each hired engagement to the geospatially constrained social network 142. The holiday services 109 may pay extra to be permitted access to receive the holiday broadcast data 102 even when they do not have a transitory and/or non-transitory connection to a neighborhood if they service that neighborhood area. For this reason, FIG. 1 visually illustrates that the holiday services 109 may be located (e.g., principal business address) outside the threshold radial distance 119.

The cellular network 108 (e.g., a mobile network) may be a wireless network distributed over land areas called cells, each served by at least one fixed-location transceiver, known as a cell site or base station through which the holiday broadcast data 102 is distributed from the holiday expression server 100 to telephones of the holiday services 109 using the radial distribution module 140 (e.g., that applies the radial algorithm 240 of FIG. 2 using a series of modules working in concert as described in FIG. 2), according to one embodiment. The cellular network 108 may use a set of frequencies from neighboring cells, to avoid interference and provide guaranteed bandwidth within each cell, in one embodiment.

When joined together these cells of the cellular network 108 may provide radio coverage over a wide geographic area through the cellular network 108 in a manner that ensures that the holiday broadcast data 102 may be simultaneously communicated via both IP networks (e.g., to the recipients 114) and/or to the holiday services 109 through the cellular network 108. It will be appreciated that the radial distribution module 140 (e.g., that applies the radial algorithm 240 of FIG. 2 using a series of modules working in concert as described in FIG. 2) in effect permits simultaneous updates to claimed user pages, unclaimed (preseeded) user pages in a geospatially constrained social network 142 (e.g., neighborhood social network) based on a geospatial location of the device 104 (e.g., a mobile device 504) in a manner that simulates a radio (RF) based network separately from the concepts described in conjunction with the cellular network 108. However, it will be understood that the radial distribution module 140 (e.g., that applies the radial algorithm 240 of FIG. 2 using a series of modules working in concert as described in FIG. 2) may be not restricted to such topology and can multimodally communicate through different networks, such as through the cellular network 108 described in FIG. 1.

The holiday services 109 may be locations, devices, and/or mobile phones associated with individuals and/or agencies associated with decoration services (e.g., a decoration store, a party store, a holiday store, a candy store, a costume store). The holiday services 109 may be notified when a holiday broadcast in an area that they service including a non-transitory location (e.g., around where they live and/or work, regardless of where they currently are) and a transitory location (e.g., where they currently are) is posted using the device 104 (e.g., a mobile device 504) as the holiday broadcast data 102.

The holiday services 109 are illustrated in FIG. 3 as including a decoration store 309A, a party store 309B, and a holiday store 309C. In this manner, mobile devices and/or desktop computers operated by the holiday services 109 may be alerted whenever the holiday broadcast data 102 is posted in and/or around their neighborhood through a push notification (e.g., an alert popping up on their phone), through an email, a telephone call, and/or a voice message delivered to the particular mobile device operated by each of the holiday services 109 using the radial distribution module 140 (e.g., that applies the radial algorithm 240 of FIG. 2 using a series of modules working in concert as described in FIG. 2).

The holiday broadcast data 102 may be delivered as notification data 112 (which may include a number of attributes) from the holiday expression server 100 to the recipients 114 and/or to the holiday services 109 using the radial distribution module 140 (e.g., that applies the radial algorithm 240 of FIG. 2 using a series of modules working in concert as described in FIG. 2) of the holiday expression server 100.

The recipients 114 may be individuals that have claimed a profile (e.g., verified their profile through a postcard, a telephone lookup, a utility bill) associated with a particular non-transitory address (e.g., a home address, a work address) through a geospatial social network (e.g., a geospatially constrained social network 142 (e.g., a neighborhood social network such as Fatdoor.com, Nextdoor.com)) through which the holiday expression server 100 operates. The recipients 114 may be in a geo-fenced area, in that an epicenter 144 of a broadcast message from the device 104 (e.g., a mobile device 504) may be a center through which a radial distance is calculated based on a characteristic of the holiday broadcast data 102. For example, a minor holiday event (e.g., trick or treat participation) may be delivered only to an immediate 0.1 mile radius, where as a major holiday event (e.g., a haunted house) may be automatically delivered to a broader 0.6 mile radius either automatically and/or through a user defined preference (e.g., set by the user 106).

It should be appreciated that individuals in an area outside the threshold radial distance 119 may not receive the holiday broadcast data 102 because their geospatial address may be outside a radial boundary surrounding an epicenter 144 in which the holiday broadcast data 102 originates. Additionally, the threshold radial distance 119 may be confined on its edges by a geospatial polygon at a juncture between the area defined by recipients 114 and the area outside the threshold radial distance 119, according to one embodiment.

FIG. 2 is an exploded view of the radial distribution module 140 of FIG. 1 that applies the radial algorithm 240, according to one embodiment.

Particularly, FIG. 2 illustrates an exploded view of the radial distribution module 140, according to one embodiment. A variety of software instruction sets and/or hardware components form the radial distribution module 140, according to one embodiment. Select ones of these software instruction sets and/or hardware components utilize the radial algorithm 240 to perform functions related to radially distributing information to pre-seeded user profiles, user profiles, and telephone devices (e.g., land based phones, circuit switched phones).

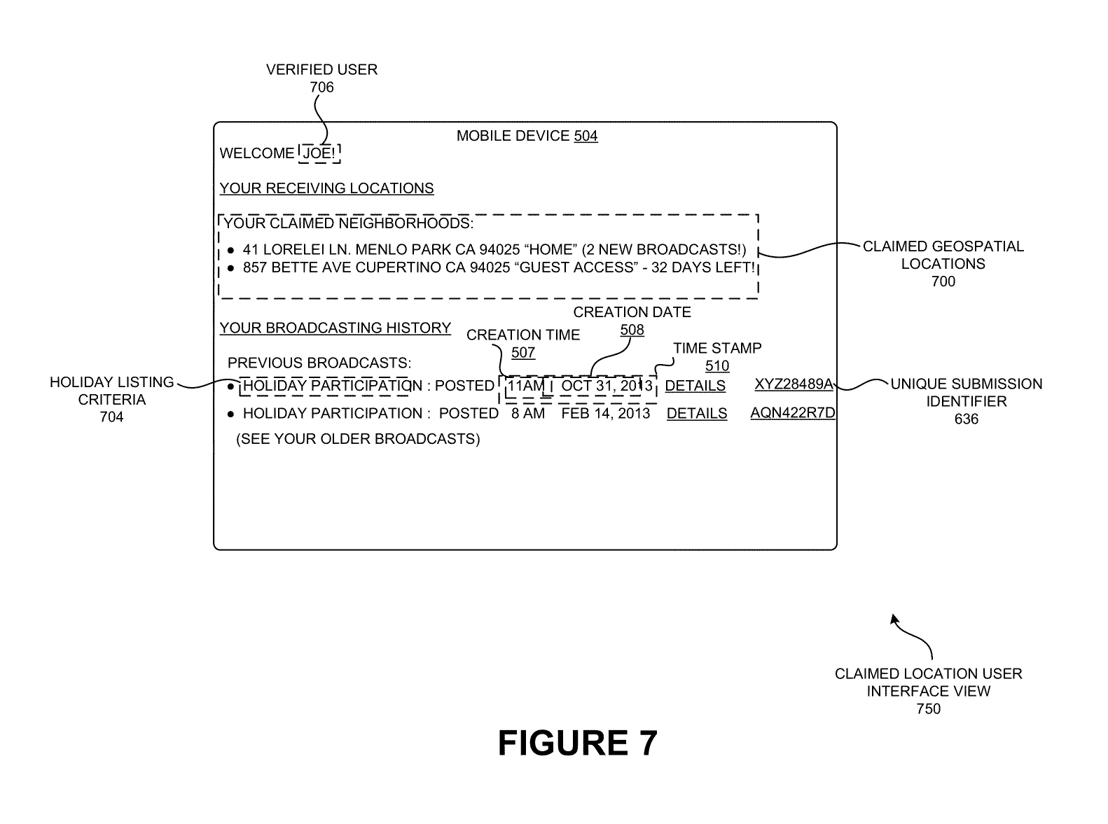

A validation module 200 may determine that a holiday broadcast data 102 generated through a mobile device 504 may be associated with a verified user (e.g., the user 106 of FIG. 1 as described as the verified user 706 in FIG. 7) of the holiday expression server 100) using a processor 120 and/or a memory 124. In addition, the validation module 200 may determine that the broadcast data (e.g., the holiday broadcast data 102) is generated by the validated user (e.g., the user 106 of FIG. 1 as described as the verified user 706 in FIG. 7) of the neighborhood broadcast system (e.g., of the geospatially constrained social network 142) when analyzing that the broadcast data (e.g., the holiday broadcast data 102) is associated with the mobile device 504. The validation module 200 may apply the radial algorithm 240 to determine if the verified user 706 may be in a validated geospatial location based on previous history of the verified user 706, according to one embodiment.

In addition, the validation module 200 may ensure that a set of geospatial coordinates 103 associated with the holiday broadcast data 102 generated through the mobile device 504 are trusted based on a claimed geospatial location (e.g., any of the claimed geospatial locations 700 as described in FIG. 7 of the verified user (e.g., the user 106 of FIG. 1 as described as the verified user 706 in FIG. 7) of the holiday expression server 100).

A time stamp module 202 may determine that a time stamp 510 associated with a creation date 508 and/or a creation time 507 of the holiday broadcast data 102 generated through the mobile device 504 may be trusted based on the claimed geospatial location (e.g., any of the claimed geospatial locations 700 as described in FIG. 7 of the verified user (e.g., the user 106 of FIG. 1 as described as the verified user 706 in FIG. 7) of the holiday expression server 100). A listing module 272 may determine an holiday listing criteria 704 associated with the holiday broadcast data 102 including a description, a photograph, a video, a category, wherein the holiday may be a national holiday, a religious holiday, a secular holiday, a cultural holiday, a birthday etc.

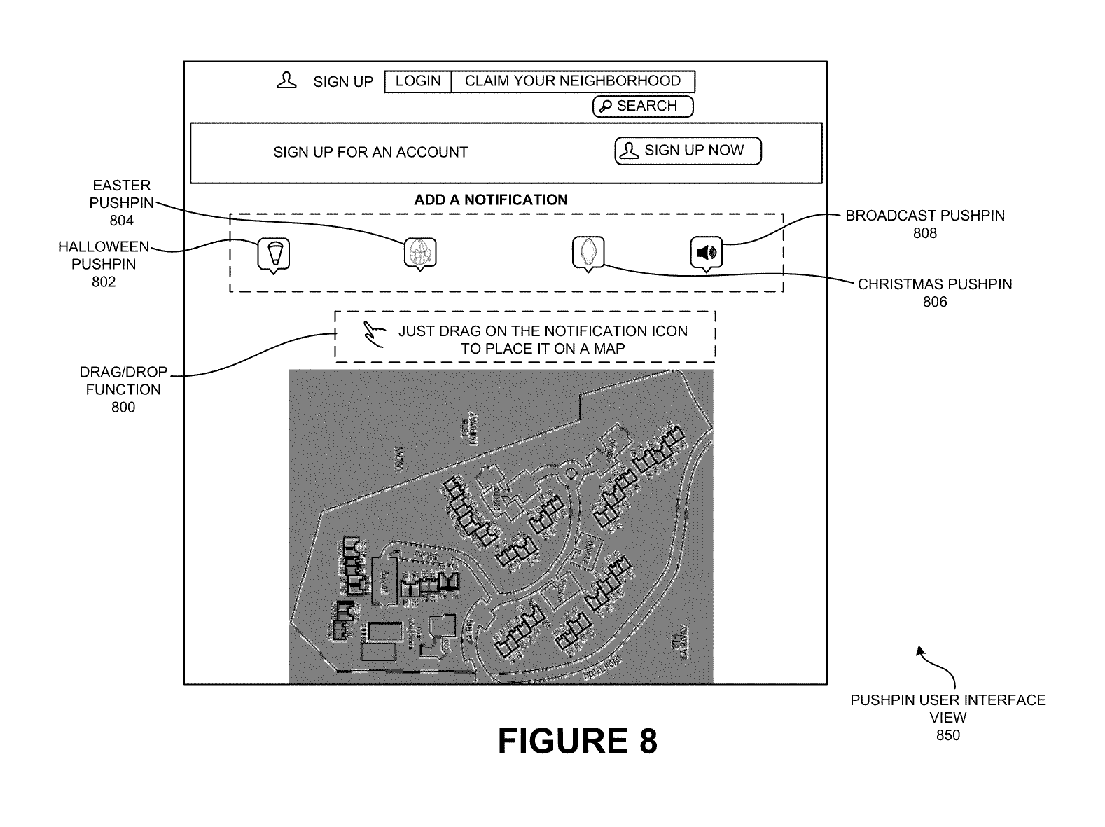

A pushpin module 206 may present the holiday broadcast data 102 generated through the mobile device 504 as an holiday pushpin of the holiday broadcast in a geospatial map surrounding pre-populated residential and/or business listings in a surrounding vicinity, such that the holiday pushpin (e.g., a Halloween pushpin 802, an Easter pushpin 804, a Christmas pushpin 806 of FIG. 8) of the holiday broadcast may be automatically presented on the geospatial map in addition to being presented on the set of user profiles (e.g., preseeded user profiles 302 and/or claimed user profiles 304 as described in FIG. 3) having associated verified addresses in the threshold radial distance 119 from the set of geospatial coordinates 103 associated with the holiday broadcast data 102 generated through the mobile device 504 of the verified user (e.g., the user 106 of FIG. 1 as described as the verified user 706 in FIG. 7) of the holiday expression server 100).

A radial distribution module 140 may radially distribute the holiday broadcast data 102 generated through the mobile device 504 through an on-page posting, an electronic communication, and/or a push notification delivered to desktop and/or mobile devices 504 associated with users and/or their user profiles (e.g., preseeded user profiles 302 and/or claimed user profiles 304 as described in FIG. 3) around an epicenter defined at the set of geospatial coordinates 103 associated with the holiday broadcast data 102 generated through the mobile device 504 to all subscribed user profiles (e.g., preseeded user profiles 302 and/or claimed user profiles 304 as described in FIG. 3) in a circular geo-fenced area defined by the threshold distance from the set of geospatial coordinates 103 associated with the holiday broadcast data 102 generated through the mobile device 504 through the radial algorithm 240 of a holiday expression network 150 that measures a distance away of each address associated with each user profile from the current geospatial location at the epicenter. A placement module 232 may enable the verified user (e.g., the user 106 of FIG. 1 as described as the verified user 706 in FIG. 7) to drag and/or drop the holiday pushpin on any location on the geospatial map, and/or automatically determining a latitude and/or a longitude associated a placed location.

A notification module 208 may automatically notify a decoration store 309A, a party store 309B and/or a holiday store 309C in a surrounding geospatial area to the set of geospatial coordinates 103 associated with the holiday broadcast data 102 generated through the mobile device 504. An extraction module 234 may separate the geospatial coordinates 103 from a metadata associated with the holiday broadcast data 102 generated through the mobile device 504 when verifying that the set of geospatial coordinates 103 associated with the holiday broadcast data 102 generated through the mobile device 504 are trusted based on the claimed geospatial location (e.g., any of the claimed geospatial locations 700 as described in FIG. 7 of the verified user (e.g., the user 106 of FIG. 1 as described as the verified user 706 in FIG. 7) of the holiday expression server 100).

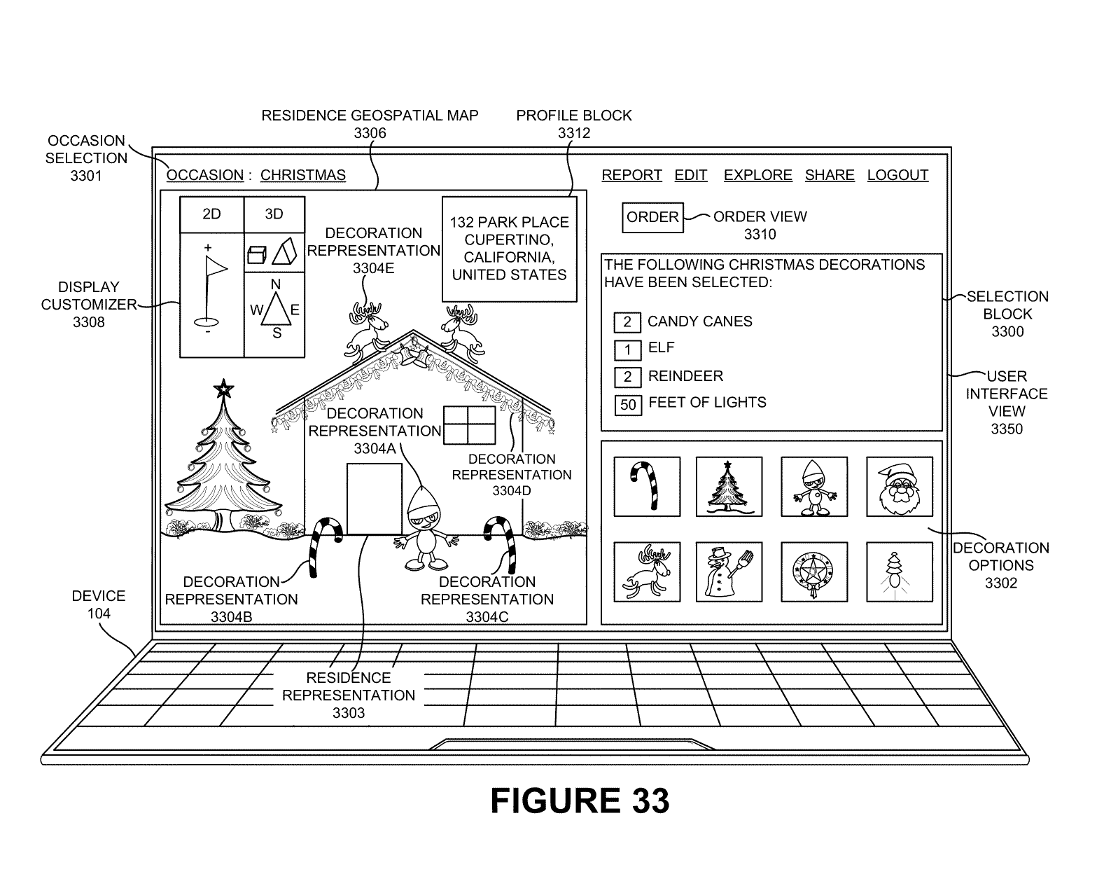

A decoration commerce module 224 may enable the verified user (e.g., the user 106 of FIG. 1 as described as the verified user 706 in FIG. 7) to view and/or purchase decorations associated with at least one of a holiday, birthday, occasion as described in FIGS. 33-37. A holiday map generation module 226 may generate a holiday map that may be viewed by users with verified non-transient addresses in the neighborhood displayed on the holiday map.

A social community module 220 may permit the user to view profiles and/or locations in their claimed neighborhood and/or build a building, floor, room representation of a structure in their claimed neighborhood. An auto-notification module 218 may automatically broadcast a notification of the holiday broadcast, the audio data 1202 associated with the holiday broadcast, and/or the response 1204 of the holiday broadcast through the on-page posting, the electronic communication, and/or the push notification delivered to desktop and/or mobile devices 504 associated with users and/or their user profiles around the epicenter 144 defined at the set of geospatial coordinates 103 associated with the broadcast data (e.g., the holiday broadcast data 102) generated through the mobile device 504 using the radial algorithm 240.

A matching module 210 may determine a relative match between a persistent clock associated with the holiday expression server 100 and/or a digital clock of the mobile device 504 to determine that the time stamp 510 associated with the creation date 508 and/or time of the holiday broadcast data 102 generated through the mobile device 504 may be accurate and/or therefore trusted. A deletion module 236 may automatically remove a publishing of the holiday broadcast data 102 generated through the mobile device 504 on a set of user profiles (e.g., preseeded user profiles 302 and/or claimed user profiles 304 as described in FIG. 3 having associated verified addresses in the threshold radial distance 119 from the set of geospatial coordinates 103 associated with the holiday broadcast data 102 generated through the mobile device 504 of the verified user (e.g., the user 106 of FIG. 1 as described as the verified user 706 in FIG. 7) of the holiday expression server 100) based on an holiday alert expiration time. A plotting module 238 may geocode a set of residential addresses each associated with a resident name in a neighborhood surrounding the mobile device 504.

A data-seeding module 241 may prepopulate the set of residential addresses each associated with the resident name as the set of user profiles (e.g., preseeded user profiles 302 and/or claimed user profiles 304 as described in FIG. 3 in the threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the holiday expression server 100) in a neighborhood curation system (e.g., part of the geospatially constrained social network 142) communicatively coupled with the holiday expression server 100. A modification module 242 may alter content in each of the set of user profiles (e.g., preseeded user profiles 302 and/or claimed user profiles 304 as described in FIG. 3). A discovery module 244 may track the modified content through the neighborhood curation system (e.g., part of the geospatially constrained social network 142). An undo module 246 may generate a reversible history journal associated with each of the set of user profiles (e.g., preseeded user profiles 302 and/or claimed user profiles 304 as described in FIG. 3 such that a modification of the verified user (e.g., the user 106 of FIG. 1 as described as the verified user 706 in FIG. 7) can be undone on a modified user profile page. A reputation module 248 may determine an editing credibility of the verified user (e.g., the user 106 of FIG. 1 as described as the verified user 706 in FIG. 7) based on an edit history of the verified user (e.g., the user 106 of FIG. 1 as described as the verified user 706 in FIG. 7) and/or a community contribution validation of the verified user (e.g., the user 106 of FIG. 1 as described as the verified user 706 in FIG. 7) by other users of the neighborhood curation system (e.g., part of the geospatially constrained social network 142).

A publishing module 214 may automatically communicate the holiday broadcast data 102 generated through the mobile device 504 to a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the holiday expression server 100) using the radial algorithm 240. A claiming module 250 may process a claim request of the verified user (e.g., the user 106 of FIG. 1 as described as the verified user 706 in FIG. 7) generating the holiday broadcast data 102 generated through the mobile device 504 to be associated with an address of the neighborhood curation system (e.g., part of the geospatially constrained social network 142). A private-neighborhood module 252 may determine if the claimable neighborhood in the neighborhood curation system (e.g., part of the geospatially constrained social network 142) may be associated with a private neighborhood community in the claimable neighborhood of the neighborhood curation system (e.g., part of the geospatially constrained social network 142).

An association module 216 may associate the verified user (e.g., the user 106 of FIG. 1 as described as the verified user 706 in FIG. 7) with the private neighborhood community in the claimable neighborhood of the neighborhood curation system (e.g., part of the geospatially constrained social network 142) if the private neighborhood community has been activated by the verified user (e.g., the user 106 of FIG. 1 as described as the verified user 706 in FIG. 7) and/or a different verified user (e.g., the user 106 of FIG. 1 as described as the verified user 706 in FIG. 7). A boundary module 254 may permit the verified user (e.g., the user 106 of FIG. 1 as described as the verified user 706 in FIG. 7) to draw a set of boundary lines in a form of a geospatial polygon such that the claimable neighborhood in a geospatial region surrounding the claim request creates the private neighborhood community in the neighborhood curation system (e.g., part of the geo spatially constrained social network 142) if the private neighborhood community may be inactive. An address type module 256 may verify the claim request of the verified user (e.g., the user 106 of FIG. 1 as described as the verified user 706 in FIG. 7) generating the holiday broadcast data 102 generated through the mobile device 504 to be associated with a neighborhood address of the neighborhood curation system (e.g., part of the geospatially constrained social network 142) when the address may be determined to be associated with a work address and/or a residential address of the verified user (e.g., the user 106 of FIG. 1 as described as the verified user 706 in FIG. 7).

A concurrency module 258 may simultaneously publish the holiday broadcast data 102 generated through the mobile device 504 on the private neighborhood community associated with the verified user (e.g., the user 106 of FIG. 1 as described as the verified user 706 in FIG. 7) generating the holiday broadcast data 102 generated through the mobile device 504 in the threshold radial distance 119 from the address associated with the claim request of the verified user (e.g., the user 106 of FIG. 1 as described as the verified user 706 in FIG. 7) of the neighborhood curation system (e.g., part of the geospatially constrained social network 142) when automatically publishing the holiday broadcast data 102 generated through the mobile device 504 on a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the holiday expression server 100) based on a set of preferences of the verified user (e.g., the user 106 of FIG. 1 as described as the verified user 706 in FIG. 7) using the radial algorithm 240.

A live broadcast module 228 may live broadcast the holiday broadcast data 102 generated through the mobile device 504 to the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community and/or currently within the threshold radial distance 119 from the current geo spatial location through the holiday expression server 100 through a multicast algorithm 276 such that a live broadcast multicasts to a plurality of data processing systems associated with each of the different user and/or the other verified user (e.g., the user 106 of FIG. 1 as described as the verified user 706 in FIG. 7) simultaneously when the mobile device 504 of the verified user (e.g., the user 106 of FIG. 1 as described as the verified user 706 in FIG. 7) generating the live-broadcast enables broadcasting of the holiday broadcast data 102 generated through the mobile device 504 to any one of a geospatial vicinity around the mobile device 504 of the verified user (e.g., the user 106 of FIG. 1 as described as the verified user 706 in FIG. 7) generating the broadcast and/or in any private neighborhood community in which the verified user (e.g., the user 106 of FIG. 1 as described as the verified user 706 in FIG. 7) has a non-transitory connection.

A summary module 262 may generate a summary data 626 to the verified user (e.g., the user 106 of FIG. 1 as described as the verified user 706 in FIG. 7) generating the broadcast data (e.g., the holiday broadcast data 102) generated through the mobile device 504 through the mobile device 504 of how many user profile pages were updated with an alert of the broadcast data (e.g., the holiday broadcast data 102) generated through the mobile device 504 when publishing the broadcast data (e.g., the holiday broadcast data 102) generated through the mobile device 504 in the private neighborhood community and/or the set of user profiles having associated verified addresses in the threshold radial distance 119 from the claimed geospatial location of the verified user (e.g., the user 106 of FIG. 1 as described as the verified user 706 in FIG. 7) of the holiday expression server 100 based on the set of preferences of the verified user (e.g., the user 106 of FIG. 1 as described as the verified user 706 in FIG. 7).

A bi-directional communication module 230 may permit the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community to bi-directionally communicate with the verified user (e.g., the user 106 of FIG. 1 as described as the verified user 706 in FIG. 7) generating the broadcast through the holiday expression server 100. A moderation module 264 may apply a crowdsourced moderation algorithm 204 in which multiple neighbors to a geospatial area determine what content contributed to the holiday expression server 100 persists and/or which may be deleted. A muting module 266 may permit users to mute messages of specific verified user (e.g., the user 106 of FIG. 1 as described as the verified user 706 in FIG. 7) to prevent misuse of the holiday expression server 100.

An application module 274 may determine that an application on the mobile device 504 is communicating the broadcast data to the holiday expression network 150 when the broadcast data is processed, and/or to associate the verified user (e.g., the user 106 of FIG. 1 as described as the verified user 706 in FIG. 7) with a verified user profile in the holiday expression network 150 through the application on the mobile device 504.

A threshold module 268 may automatically set the threshold distance between 0.2 and/or 0.4 miles from the set of geospatial coordinates 103 associated with the holiday broadcast data 102 generated through the mobile device 504 to optimize a relevancy of the live-broadcast. A non-transitory module 270 may determine any private neighborhood community in which the verified user (e.g., the user 106 of FIG. 1 as described as the verified user 706 in FIG. 7) has a non-transitory connection may be a residential address of the verified user (e.g., the user 106 of FIG. 1 as described as the verified user 706 in FIG. 7) and/or a work address of the verified user (e.g., the user 106 of FIG. 1 as described as the verified user 706 in FIG. 7) that has been confirmed by the holiday expression server 100 as being associated with the verified user (e.g., the user 106 of FIG. 1 as described as the verified user 706 in FIG. 7).

FIG. 3 is a broadcast view that demonstrates how the radial distribution module of FIG. 1 is used to communicate a holiday broadcast data to claimed user profiles, pre-seeded user profiles, and to telephone devices and/or internet-enabled devices through a heterogeneous network formed through the internet protocol network of FIG. 1 and through a cellular network, according to one embodiment.

Particularly, FIG. 3 illustrates a broadcast view 350, according to one embodiment. FIG. 3 introduces a claimed neighborhood 300, a set of preseeded user profiles 302, and a claimed user profile 304, and their relationships with elements previously described in FIG. 1. In addition, FIG. 3 explains the set of holiday services 109 of FIG. 1 to include a decoration store 309A, a party store 309B, and a holiday store 309C, a drone 311 and a driverless car 313.

In FIG. 3, the claimed neighborhood 300 may refer to a region that may be claimed by the user 106 as being associated with a non-transitory location (e.g., a work address, a home address) of the user 106. The preseeded user profiles 302 may refer to address information from people and/or business directories that has been prepopulated in the geospatial social map and/or may be associated with manually placed pushpins on the geospatial map in the geospatially constrained social network 142 of FIG. 1. The claimed user profile 304 may refer to the verified user 706 associated with a verified address in the geospatial social map and/or may be associated with claimed pushpin (e.g., a previously preseeded residential and/or business profile) on the geospatial map in the geospatially constrained social network 142 of FIG. 1.

The decoration store 309A, the party store 309B, and the holiday store 309C may receive the holiday broadcast data 102 through their mobile devices, desktop devices, and/or through their cellular telephones. The decoration store 309A, the party store 309B, and the holiday store 309C may receive the holiday broadcast data 102 and may bi-directionally interact with the holiday services 109 through either cellular network 108 and/or through the network 101 (e.g., an internet protocol network). When a holiday query of the user 106 interacting with any one of the recipients 114 based on the bi-directional communication is responded to, the user 106 may be able to choose which decoration store 309A, party store 309B and/or holiday store 309C should respond.

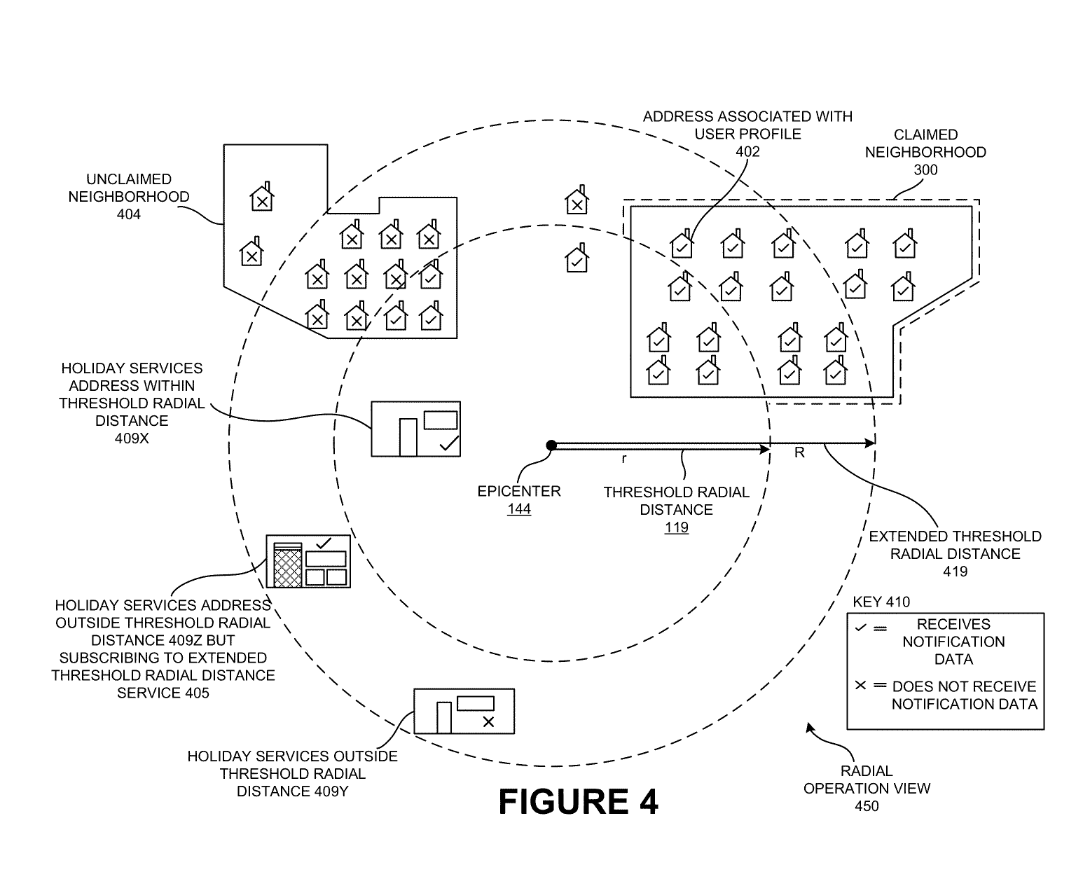

The notification data 112 may be communicated through the network 101 to the preseeded user profiles 302 within a threshold radial distance 119 of the epicenter 144. Alternately, the notification data 112 may be communicated through the network 101 to different ones of the claimed user profile 304 within the claimed neighborhood 300 that are located within the threshold radial distance 119 from the epicenter 144. Additionally, as described in FIG. 4, it will be understood that the claimed neighborhood 300 may be situated partially within the threshold radial distance 119 and partially outside the threshold radial distance 119, yet the notification data 112 received by of the recipients 114 (e.g., having a claimed user profile) may be propagated to other claimed user profiles within the claimed neighborhood 300 even though they are outside the threshold radial distance 119.

The notification data 112 may also be communicated through the cellular network 108 or through the network 101 to the set of holiday services 109. For example, the decoration store 309A may use the holiday expression network 150 to monitor queries (e.g., for decorations) in a neighborhood and publish sales to residents around a geospatial area of the neighborhood. In addition, the decoration store 309A, the party store 309B and/or the holiday store 309C may service a particular neighborhood and may be alerted of a new order and/or query based on a subscription they pay to access broadcasts from areas that they service. Additionally, it should be understood that other types of decoration services or businesses may receive the notification data 112. For example, additional services receiving the notification data 112 may include candy shops, costume stores, birthday stores, etc.

In one embodiment, deliveries (e.g., of products from the holiday services 109, neighbors, other users) may be made from a ‘neighborhood drone’ (e.g., an unmanned aerial vehicle such as the drone 311) operated by the geospatially constrained social network 142. For example, Fatdoor.com may operate a set of drones (e.g., the drone 311 of FIG. 3) that can be dispatched and automatically instructed to pick up various holiday displays and deliver them to a resident of a home. The drone 311 may be aircraft without a human pilot on board. A flight path of the drone 311 may be a server of the geo-spatially constrained social network 142 either autonomously by computers in the drone 311 and/or through an automated navigation system based on a mapping algorithm.

In one embodiment, a neighbor offering a used item (e.g., a used Halloween mask) may request that a holiday drone operated by Fatdoor.com be summoned by clicking on ‘request pickup’ on their mobile device. This may instruct the holiday drone to fly to a backyard and/or front yard the a home of a neighbor and physically pick up the used holiday mask and deliver it to a borrower, minimizing time to do neighborhood errands. A neighbor who is selling and/or giving away an item may receive an alert when a drone arrives through their mobile device. Similarly, the recipient of the item may receive an alert when the drone delivery is ready. Furthermore, this way, a limited set of drones can be shared by a set of users. The drones 311 may be communicatively coupled with the holiday expression server 100 through the network 101, the cellular network 108, and/or another network. Alternative to drones, Fatdoor and/or neighbors themselves may instruct driverless cars (e.g., the driverless car 313 of FIG. 3) that they operate to pick up and deliver gifts to each other through their mobile device using the geo-spatial social network 142. The driverless cars may be personally owned and/or owned by the geospatially constrained social network. The driverless cars 313 may be communicatively coupled with the holiday expression server 100 through the network 101, the cellular network 108 and/or another method.

For example the driverless car 313 may be an autonomous car (e.g., a self-driving car, robot car) that is an autonomous vehicle capable of fulfilling the transportation capabilities of a traditional car. As an autonomous vehicle, the driverless car 313 may be capable of sensing its environment and navigating without human input.

The driverless car 313 may be an autonomous vehicle that senses its surroundings with such techniques as radar, lidar, GPS, and computer vision. Advanced control systems may interpret sensory information to identify appropriate navigation paths, as well as obstacles and relevant signage to/from a home offering a holiday item for sale in the geospatially constrained social network 142. The driverless car 313 may update its maps based on sensory input, thereby permitting the driverless car 313 to keep track of their position even when conditions change or when they enter uncharted environments in the neighborhood.

FIG. 4 is a radial operation view 450 that illustrates an expansion of a threshold radial distance based on a claimed neighborhood 400 at a radial boundary surrounding the epicenter 144 formed by geospatial coordinates of the device of FIG. 1, according to one embodiment. FIG. 4 illustrates a claimed neighborhood 400, an address associated with a user profile 402, an unclaimed neighborhood 404, an holiday service provider address outside the threshold radial distance as described in operation 409Z but subscribing to extend the threshold radial distance as described in operation 405, a holiday service provider within the threshold radial distance as described in operation 409X, a holiday service provider outside the threshold radial distance in operation 409Y, a key 410, and an extended threshold radial distance 419. The key 410 describes that a ‘checkmark’ inside a home in either the claimed neighborhood 400 and/or the unclaimed neighborhood 404 indicates that the holiday broadcast data 102 reaches a user associated with that address at a radial geospatial distance away. In contrast, the key 410 describes that an ‘X mark’ inside a home in either the claimed neighborhood 400 and/or the unclaimed neighborhood 404 indicates that the holiday broadcast data 102 does not reach a user associated with that address at a radial geospatial distance away.

Particularly, in FIG. 4, an address associated with each user profile 402 is illustrated, according to one embodiment. In FIG. 4, because the claimed neighborhood 400 is partially within the threshold radial distance ‘r’, every verified user in the claimed neighborhood 400 receives the holiday broadcast data 102, according to one embodiment. Thereby, the radial broadcast distance ‘r’ is extended to a′ as illustrated in FIG. 4 (e.g., the extended threshold radial distance 419 of FIG. 4). It should be understood that in an alternate embodiment, the radial broadcast of the holiday broadcast data 102 may not extend to the entire group of users of the claimed neighborhood 400. However, to promote neighborhood communication and cooperation, the holiday broadcast data 102 is illustrated as being extended to the claimed neighborhood 400 in the embodiment of FIG. 4.

It should be also noted that in some embodiments, the “preseeded user profiles” may be users that have previously signed up for the geospatially constrained social network 142, as opposed to users that have been preseeded there in a social network. For example, in one alternate embodiment, each of the claimed neighborhood 400 may serve as an approximate to actual radial distribution, in that broadcast messages are solely sent to claimed neighborhoods (e.g., private claimed neighborhoods) of actual users in a vicinity of a broadcast (rather than to public profiles).

FIG. 4 also illustrates an unclaimed neighborhood 404. The unclaimed neighborhood 404 may be preseeded based on public data, according to one embodiment. The unclaimed neighborhood has within it a series of addresses (e.g., associated with non-transitory homes and/or business locations), according to one embodiment as illustrated in FIG. 4. Those addresses in the unclaimed neighborhood 404 to whom the holiday broadcast data 102 is delivered have a ‘checkmark’, according to one embodiment. In contrast, those addresses in the unclaimed neighborhood 404 to whom the holiday broadcast data 102 is not delivered have an ‘X mark’, as illustrated in FIG. 4. Particularly, addresses in the radial boundary ‘r’ have a check mark, whereas addresses that are outside the radial boundary ‘r’ (e.g., and therefore outside the threshold radial distance 119) are marked with the ‘X mark’. In this example embodiment of FIG. 4 showing the unclaimed neighborhood 404, the addresses within the threshold radial distance 119 are the addresses that receive the holiday broadcast data 102.

Also illustrated in FIG. 4 is the concept of the holiday service provider address within the threshold radial distance as shown in operation 409X, the service provider address outside the threshold radial distance but subscribing to extend threshold radial distance service as shown in operation 405 (e.g., a service that extends the threshold radial distance to a′, the extended threshold radial distance 419), and the service provider outside the threshold radial distance as illustrated in operation 409Y. Each of these different operations will be compared and contrasted. The holiday service provider address in operation 409X may receive the holiday broadcast data 102 because the service provider in this example embodiment of FIG. 4 is within the threshold radial distance 119, according to one embodiment. The holiday service provider address in operation 405 may receive the holiday broadcast data 102 because they provide a consideration (e.g., pay a monthly subscription, annual fee, and/or pay per access/use fee) to the geospatially constrained social network 142, even though the holiday service provider in operation 405 does not have a physical address within the threshold radial distance 119. In an alternate embodiment, the decoration services need not pay a consideration for this service due to the beneficial societal nature of their participation in the geospatially constrained social network 142. The geospatially constrained social network 142 (e.g., or holiday expression server 100) may verify, confirm, and/or ask for an assurance that the holiday service provider actually provides decoration services in the threshold radial distance 119. The geospatially constrained social network 142 (and other the holiday expression server 100) may request feedback, reviews, and comments from homes/businesses in the geospatially constrained social network 142 for the decoration services in operation 405 and operation 409X to ensure that they continue to be recommended and/or are permitted to participate in the threshold radial distance 119 around the epicenter 144 (e.g., where the broadcast originates) in the geospatially constrained social network 142. Operation 409Y indicates that a service provider outside the threshold radial distance 119 does not receive the holiday broadcast data 102, and therefore cannot participate bi-directionally in the geospatially constrained social network 142.

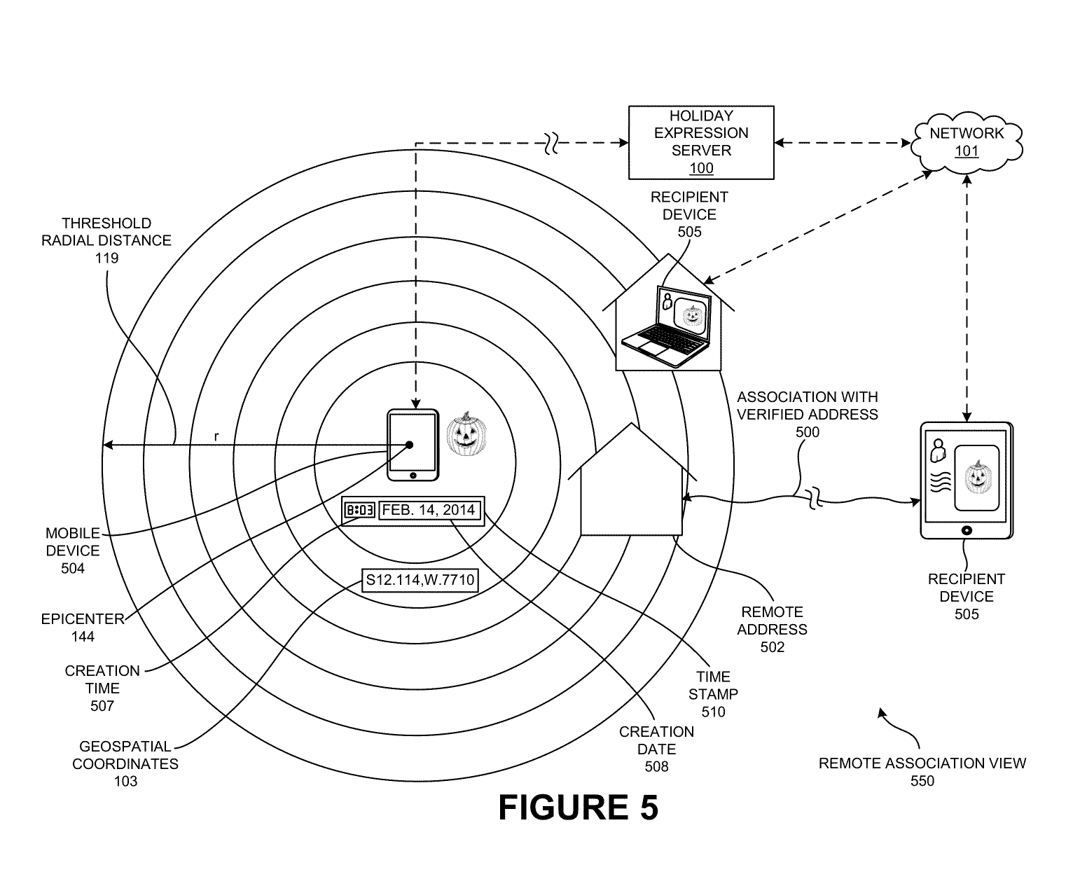

FIG. 5 illustrates a remote association view 550 in which a recipient device 505 (e.g., a cellphone, mobile phone, a computer, a tablet) of an recipient receives the holiday broadcast data of FIG. 3 based on a non-transitory claimed address associated with a profile of the recipient even when the recipient's device is outside a threshold radial distance of a broadcast, according to one embodiment.

Particularly, FIG. 5 illustrates an operation of an association with verified address 500 which illustrates the recipient device 505 can be associated to a remote address 502, and a time stamp 510 associated with a creation time 507, a creation date 508, and a set of geospatial coordinates 103 generated from a mobile device 504. The remote address 502 may be a non-transitory location such as a home and/or a work address of the recipient 114 (e.g., the user 106 generating the holiday broadcast data 102), according to one embodiment. The non-transitory location may be a place of domicile (e.g., a home) and/or a place of work (e.g., a physical location and/or a principle place of business) of a property (e.g., a work address) and/or business associated with the user 106), according to one embodiment. The concept illustrates that the recipient device 505 may be located at a physical location outside the threshold radial distance 119 and still get the holiday broadcast data 102 and/or the notification data 112 if the recipient device 505 (e.g., a mobile phone) has verified an address at a location that they care about and/or are associated with (e.g., a location in which they live, work, and/or have guest access) that is within the threshold radial distance 119. In other words, the user 106 may receive broadcast (e.g., the notification data 112 and/or the holiday broadcast data 102 which may be live streamed and/or through after the event notifications) related to a radial distance from their home and/or work even when physically at a location outside their claimed non-transitory location.

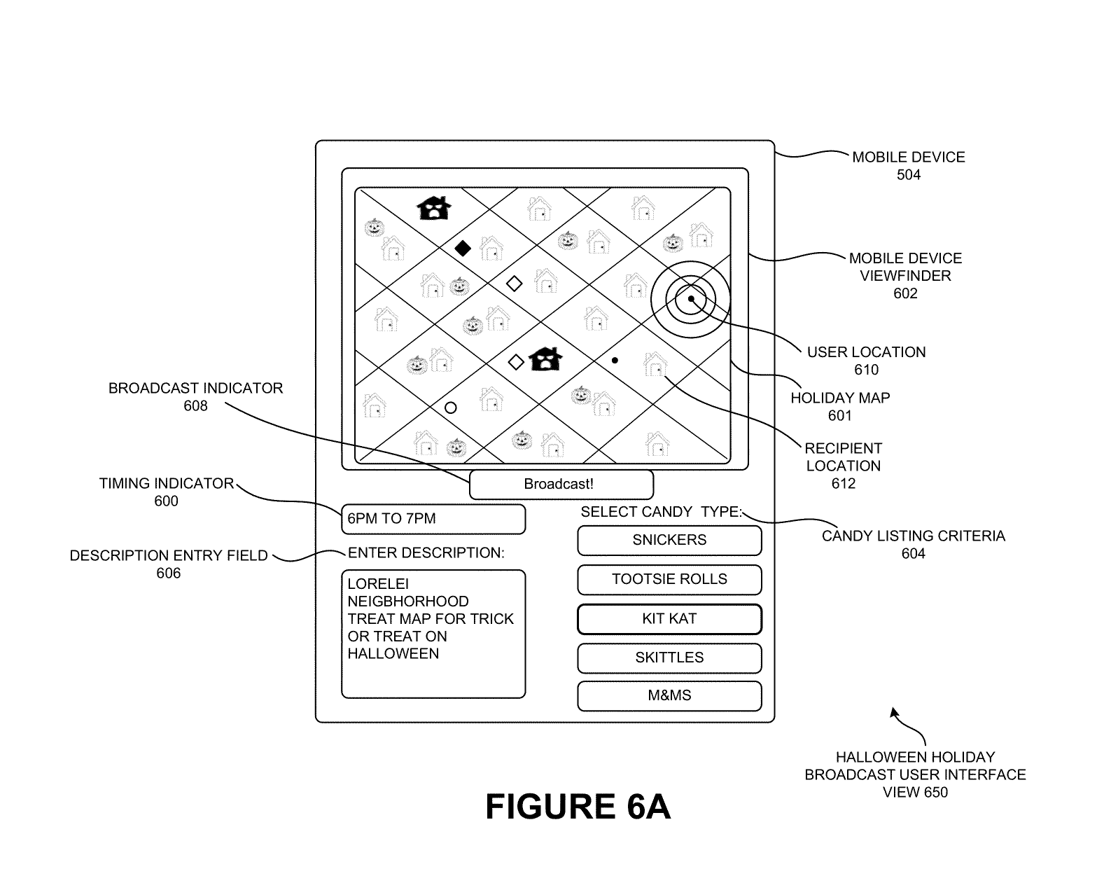

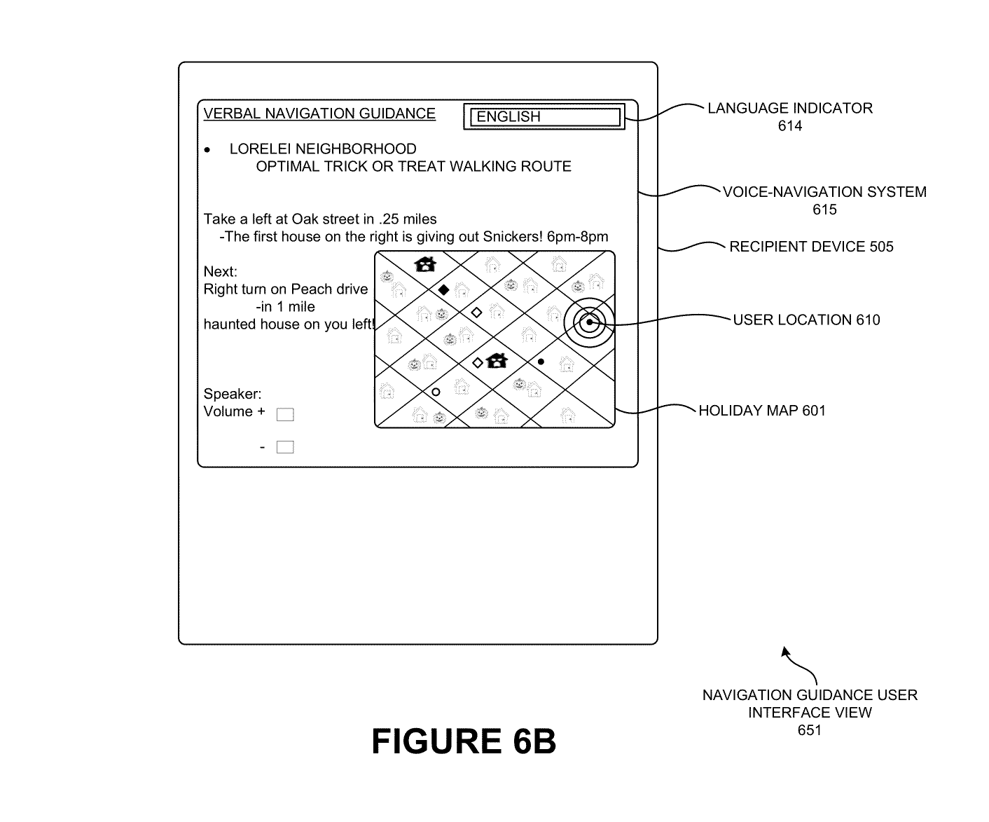

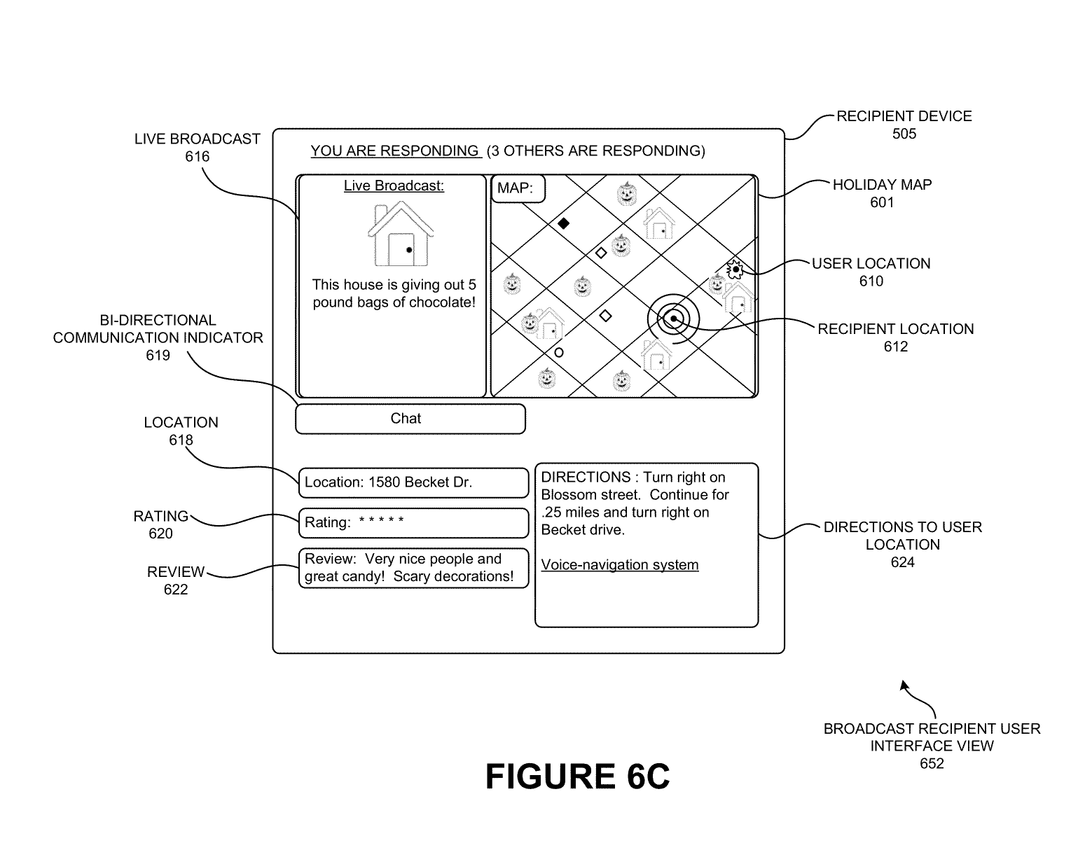

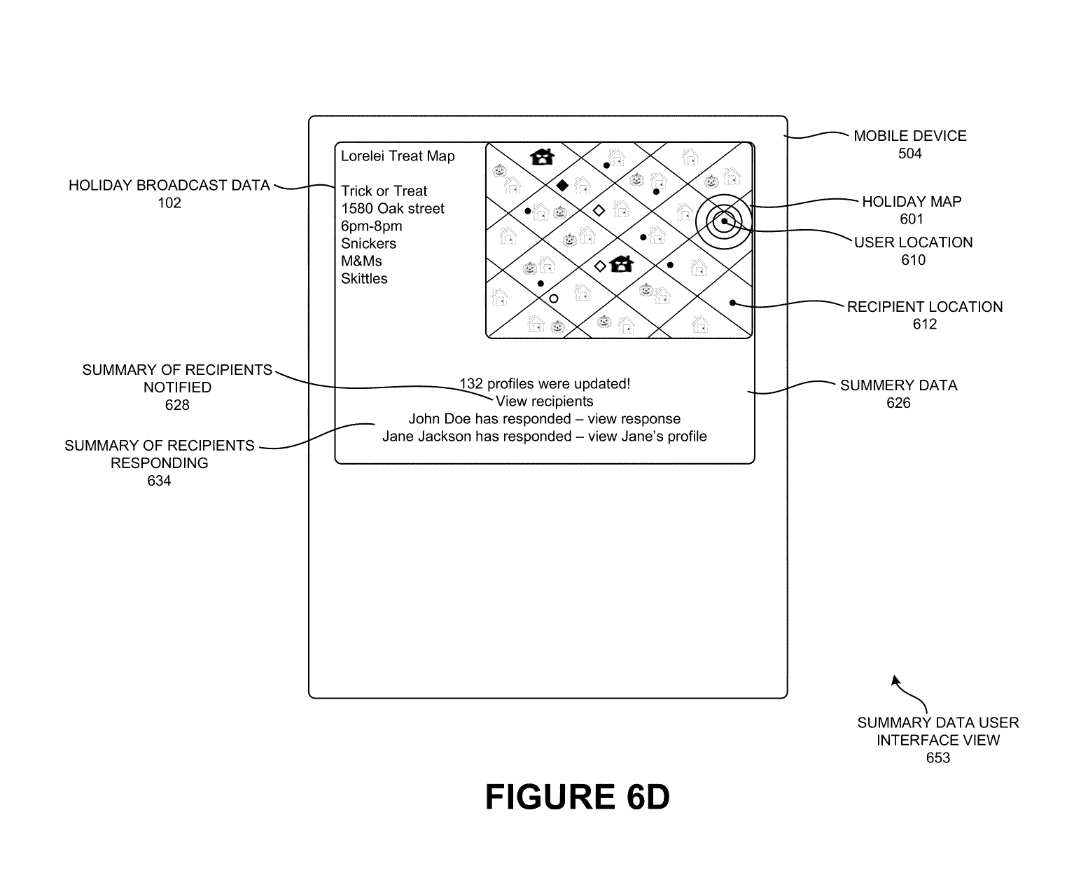

FIG. 6A is a Halloween holiday broadcast user interface view 650 of the mobile device of FIG. 5 that shows how the user can generate and broadcast the broadcast data, according to one embodiment.

Particularly, FIG. 6A illustrates a timing indicator 600, a mobile device viewfinder 602, a candy listing criteria 604, a description entry field 606, a broadcast indicator 608, a holiday map 601, a user location 610 and a recipient location 612, according to one embodiment.

In FIG. 6A, the user 106 generating the holiday broadcast data 102 sent to the holiday expression server 100 may use the mobile device viewfinder 602 to create a holiday broadcast through the mobile device and/or the mobile device's camera and/or video device. The user 106 may then broadcast the holiday broadcast by pressing and/or selecting the broadcast indicator 608. The user 106 may also enter text to help the recipients 114 of the holiday broadcast data 102 understand the broadcast in the description entry field 606. The user 106 may enter a time of the activity (e.g., giving out candy to children on Halloween) in the timing indicator 600. In one embodiment, the user may be able to enter a date in the time indicator and/or a time of day. The user 106 may also select the candy listing criteria 604 (e.g., Snickers, Tootsie Rolls, KitKat, Skittles, M&Ms) to be incorporated into the holiday broadcast data 102 and/or the notification data 112 so that recipients 114 may see what kind of candy will be available. The holiday map 601 may also show the user location 610 so that they may navigate toward participating locations and/or see the recipient location 612 receiving and/or responding to the user 106's notification data 112. For example, the user 106, may want to alert neighbors that the user 106 will be giving out candy between six and seven at night this Halloween and detail what candy will be available. The user may customize a Halloween broadcast and activate the broadcast indicator 608 to broadcast the notification data 112 to recipients 114 in the geospatial area around the user 106.

FIG. 6B depicts a navigation guidance user interface view 651 of the recipient device of FIG. 5, in which a Halloween related broadcast data generated through the user interface of FIG. 6A includes voice-navigation to the user, according to one embodiment.

Particularly, FIG. 6B further illustrates a language indicator 614 through which the recipient may be able to select a language they wish to receive directions in, according to one embodiment. In FIG. 6B a condensed form of the holiday broadcast data 102 and/or the notification data 112 is displayed to the recipient 114 on the recipient device 505. For example, the displayed information may include a time of the broadcast, a date of the broadcast, a holiday listing criteria 704, the candy listing criteria 604, a description written by the user 106 in the description entry field 606 on the mobile device 504, and/or links allowing the recipient 114 to view the live feed of the holiday broadcast data 102 or the map of the geospatial location of the broadcast. In addition, the embodiment of the navigation guidance user interface view 651 may include a voice-navigation system 615 of the recipient device 505 respond indicator 614 that may allow the recipient 114 receive directions to houses participating in the holiday activity (e.g., giving out candy on Halloween. The voice-navigation system 615 may provide the user 106 with an optimal route. The navigation guidance user interface may also include the holiday map 601, the user's current location 610, and/or written directions.

FIG. 6C is a broadcast recipient user interface view 652 of the recipient device of FIG. 5 in which the recipient device is receiving a Halloween related live broadcast after the recipient has activated the respond indicator of FIG. 6B, according to one embodiment.

Particularly, FIG. 6C further illustrates a Halloween related live broadcast 616, a location 618, a bi-directional communication indicator 619, a rating 620, a review 622, and a directions to user location 624.

According to the embodiment of FIG. 6C, the recipient device 505 may display the live broadcast 616 (e.g., the Halloween related live broadcast) generated by the mobile device 504. The recipient device 505 may also display the holiday map 601 with the user location 610 and the recipient location 612 to help the recipient 114 either avoid or navigate to the user location 610. The recipient device 505 may display an indicator for forming a bi-directional communication with the user 106 (e.g., an indicator labeled “dial broadcaster”) the bi-directional communication indicator 618. Further, the user interface depicted in FIG. 6C may include a location 618 which may show the location (e.g., geospatial coordinates, latitude and/or longitude, street address) of the live broadcast 616 (e.g., the user location 610). The rating 620 may be a rating by the user 106 of the holiday activity (e.g., the house the user 106 is trick or treating at) and/or may be a cumulative rating (e.g., the aggregate of all ratings of the location, person, and/or activity the live broadcast is about). The review 622 may be a review by the user 106 of the holiday activity (e.g., the house the user 106 is trick or treating at) and/or may be a collection of all past reviews of the location, person, and/or activity the live broadcast is about. In one embodiment, the recipient 114 may be able to view the profile of the user 106 that sent the live broadcast 616 through the broadcast recipient user interface. The directions to user location 624 may provide listed directions (e.g., walking directions, driving directions) from the recipient location 612 to the user location 610. In one embodiment, the user may be able to access the voice-navigation system 615 through the directions to user location 624.

FIG. 6D is a summary data user interface view 653 of the mobile device of FIG. 5 in which the user may see the recipients of the broadcast, the recipients watching the live feed of FIG. 6C, and which decoration services of FIG. 3 were contacted, according to one embodiment.

Particularly, FIG. 6B further illustrates a summary data 626, a summary of recipients notified 628, and a summary of recipients responding 634.

In the embodiment of FIG. 6, the user 106 is presented with a collection of the summary data 626. The summary data 626 may display on the mobile device 504 how many recipients received the live broadcast 616. The summary data 626 may also show by the summary of recipients notified 628 how many user profile pages were updated with an alert of the holiday broadcast data 102 generated through the mobile device 504 when publishing the holiday broadcast data 102 generated through the mobile device 504 in the private neighborhood community and/or the set of user profiles (e.g., preseeded user profiles 302 and/or claimed user profiles 304 as described in FIG. 3 having associated verified addresses (in the threshold radial distance 119 from the claimed geospatial location (e.g., any of the claimed geospatial locations 700 as described in FIG. 7 of the verified user (e.g., the user 106 of FIG. 1 as described as the verified user in FIG. 7) of the holiday expression server 100))) based on the set of preferences of the verified user (e.g., the user 106 of FIG. 1 as described as the verified user in FIG. 7). Additionally, the user 106 may also be able to see the summary of recipients responding 634 to the broadcast.

FIG. 7 is a claimed location user interface view 750 that explains how a claimed user reviews their holiday broadcasts that they made and manages the neighborhoods that they have claimed, according to one embodiment.

FIG. 7 is a claimed location user interface view 750 that explains how a user manages notifications in neighborhoods that they have claimed and reviews their previous broadcasts, according to one embodiment. Particularly, FIG. 7 describes claimed geospatial locations 700 of a verified user (‘Joe’). The claimed geospatial locations 700 will show up when the user 106 becomes the verified user (e.g., by proving the addresses of the claimed geospatial locations 700 by proving utility bills associated with that address). FIG. 7 also shows a broadcasting history of the user, including the holiday listing criteria 704, the creation time 507, the creation date 508, the time stamp 510, and the unique submission identifier 636 of past broadcasts.

FIG. 8 is a pushpin user interface view 850 that explains how the user drags pushspins to a map including a broadcast pushpin, which is different than other pushpins in that a time and a location of the broadcast pushpin is fixed based on a set of geospatial coordinates associated with a mobile device of the claimed user of FIG. 7, according to one embodiment. Particularly, FIG. 8 illustrates a drag/drop function 800 associated with a Halloween pushpin 802, an Easter pushpin 804, a Christmas pushpin 806, and a broadcast pushpin 808, according to one embodiment.

In FIG. 8, the broadcast pushpin 808 (e.g., that may generate the holiday broadcast data 102) may be unique in that it can only be placed through a device that has a geo-spatial chip and which can verify a geo-spatial location of a device making the broadcast. In this way, the broadcast pushpin 808 is fixed in time and place, whereas the other pushpins can be manually dragged to the map through the drag/drop function 800.

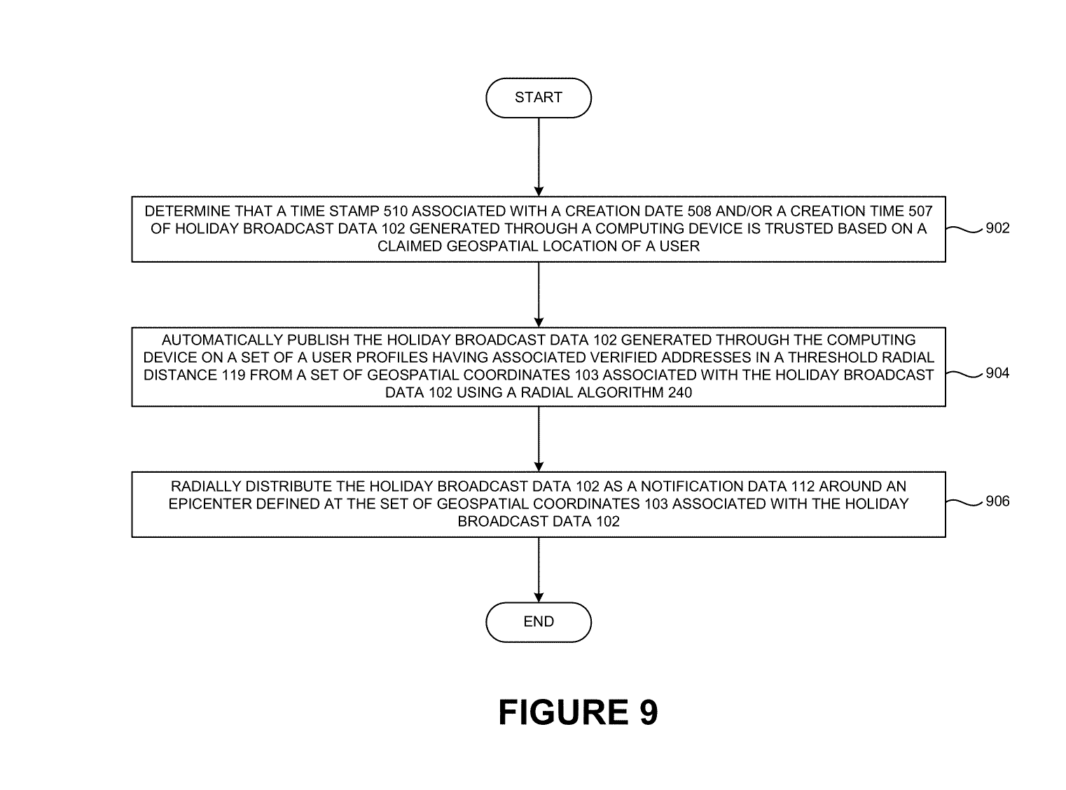

FIG. 9 is a process flow of radially distributing the holiday broadcast data of FIG. 3 as a notification data around an epicenter defined at the set of geospatial coordinates of FIG. 8 associated with the holiday broadcast data, according to one embodiment. Particularly, in FIG. 9, operation 902 may determine that a time stamp 510 associated with a creation date 508 and/or a creation time 507 of the holiday broadcast data 102 generated through a computing device (e.g., the device 104) is trusted based on a claimed geospatial location of a user (e.g., the user 106), according to one embodiment. Then, in operation 904, the holiday broadcast data 102 generated through the computing device may be automatically published on a set of user profiles having associated verified addresses in a threshold radial distance 119 from a set of geospatial coordinates 103 associated with the holiday broadcast data 102 using a radial algorithm 240. Next, in operation 906, the holiday broadcast data 102 may be radially distributed as the notification data 112 around an epicenter defined at the set of geospatial coordinates 103 associated with the holiday broadcast data 102.

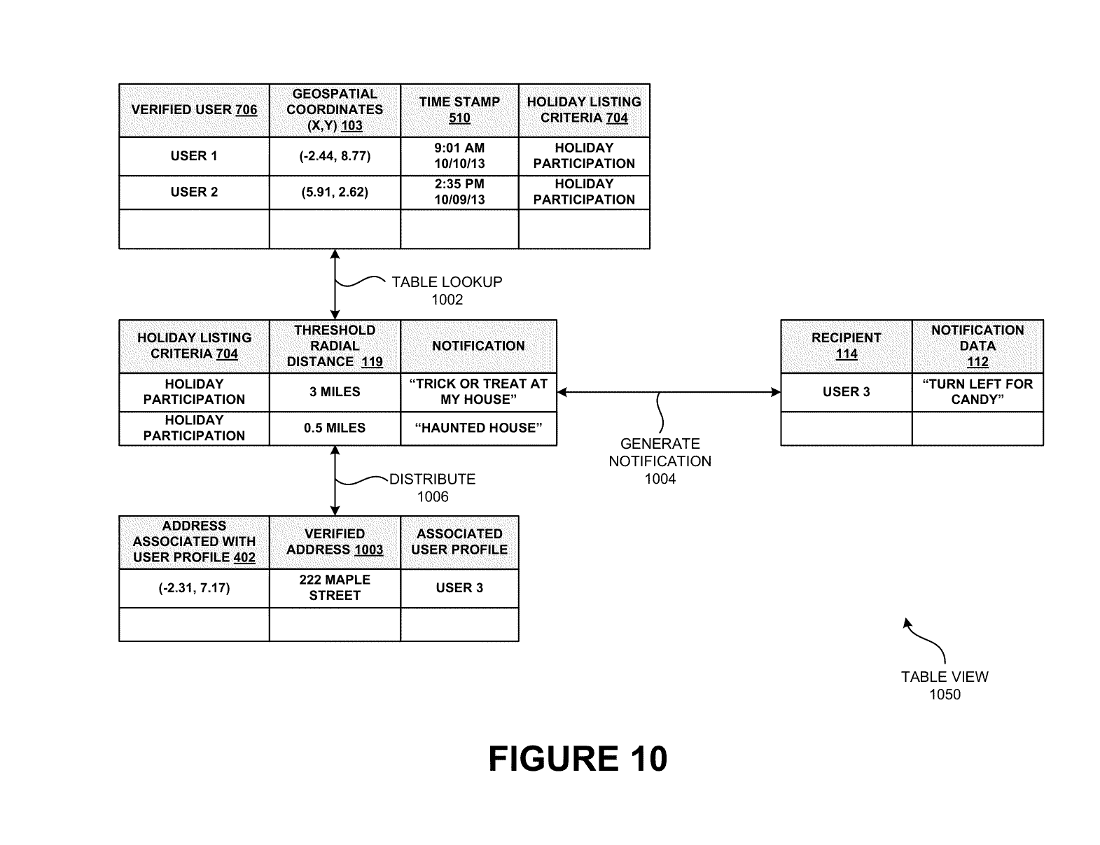

FIG. 10 is a table view 1050 illustrating data relationships between users, locations, and with a set of notification types needed to generate a broadcast, according to one embodiment. In FIG. 10, a table lookup 1002 may be performed in which a holiday listing criteria 704 is matched with a threshold radial distance 119 and a notification data 112. Then, a notification may be generated using the generate notification operation 1004 from the recipient 114, and distributed to the verified address (e.g., the verified address 1003) in the threshold radial distance 119 using the distribute operation 1006, according to one embodiment. The associated user profile may be the claimed user profile 304.

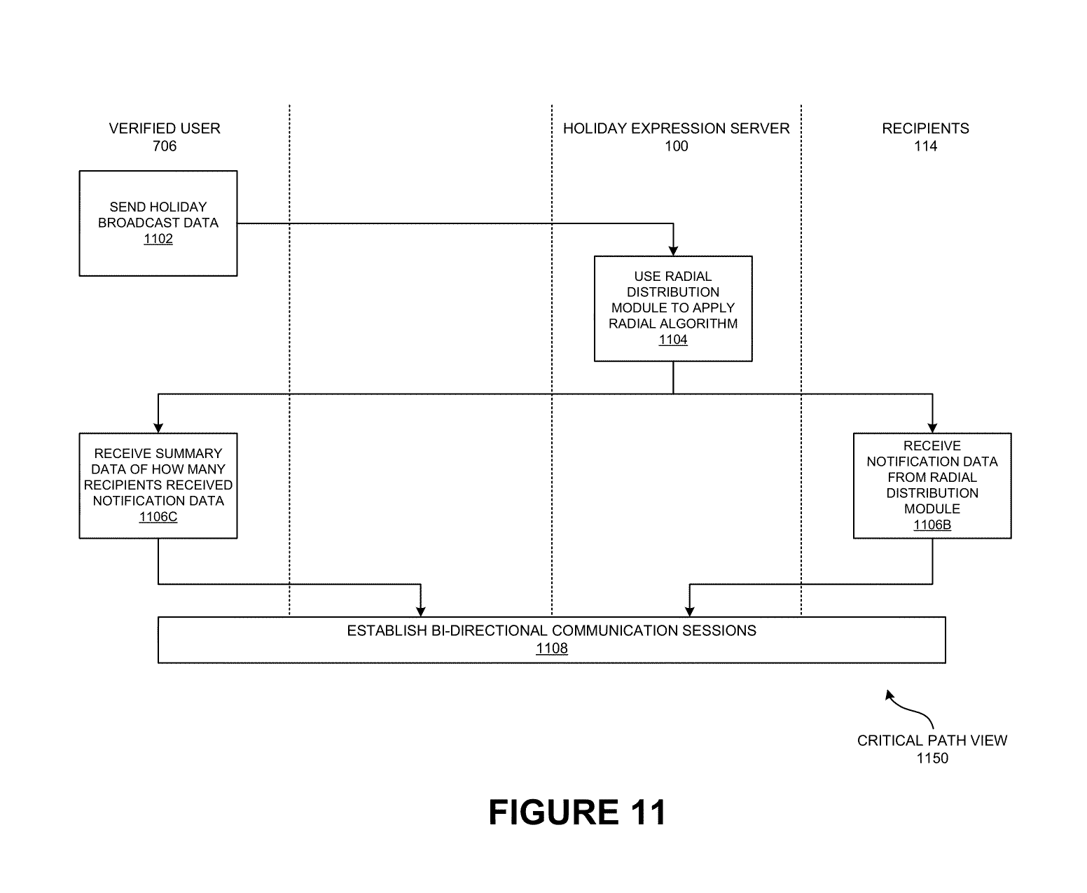

FIG. 11 is a critical path view 1150 illustrating a flow based on time in which critical operations in establishing a bi-directional session between a verified user and those individuals receiving the holiday broadcast data of FIG. 3 is established, according to one embodiment. In FIG. 11, a verified user sends a holiday broadcast data 102 to the holiday expression server 100 in operation 1102. Then, the recipients 114 receive the notification data 112 from the radial distribution module 140 of the holiday expression server 100 in operation 1106B, according to one embodiment. Based on operation 1106B, the verified user may automatically receive a summary (e.g., the summary data 626) of how many recipients received the notification data 112 in operation 1106C. Next, bidirectional communication sessions are established between the verified user and the recipients 114 in operation 1108.

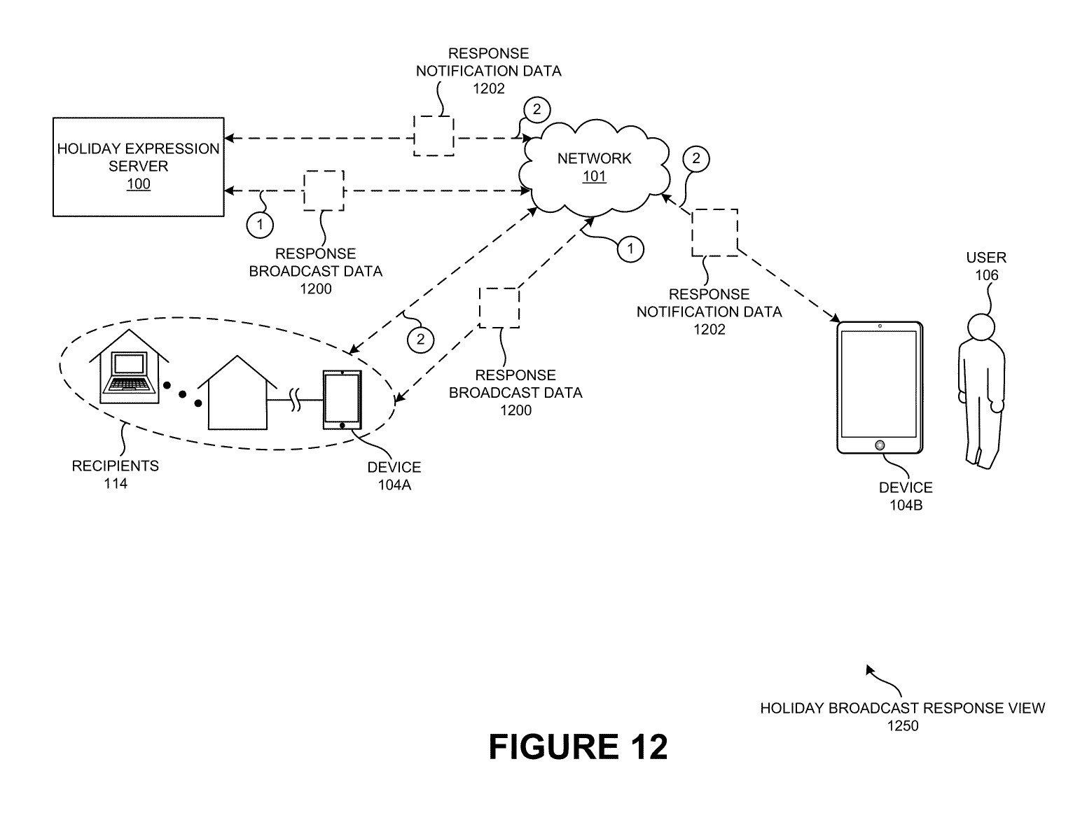

FIG. 12 is a holiday broadcast response view 1250 illustrating a response being generated and broadcast by recipients in response to a holiday broadcast made from the user device of FIG. 1, according to one embodiment.

Particularly, FIG. 12 further illustrates a response broadcast data 1200 and a response notification data 1202. After the user's 106 broadcast reaches recipients 114 with verified addresses within a threshold radial distance 119 from the epicenter 144 (illustrated in FIG. 1), the recipients 114 may broadcast responses (illustrated in FIG. 6D) as response broadcast data 1200 along path circle ‘1’ through the network 101 and/or the cellular network 108 (not shown). The response broadcast data 1200 may be automatically generated by the device 104A associated with the recipient 114. Second, the response notification data 1202 may be automatically generated using the response broadcast data 1200 by the holiday expression server 100. The response notification data 1202 may then be broadcasted to the user 106 and/or recipients 114 along path circle ‘2’ using the radial distribution module 140. The response notification data 1202 may move along path circle ‘2’ through the network 101 to the device 104B associated with the user 106 and/or other recipients that may have received the original broadcast from the user 106.

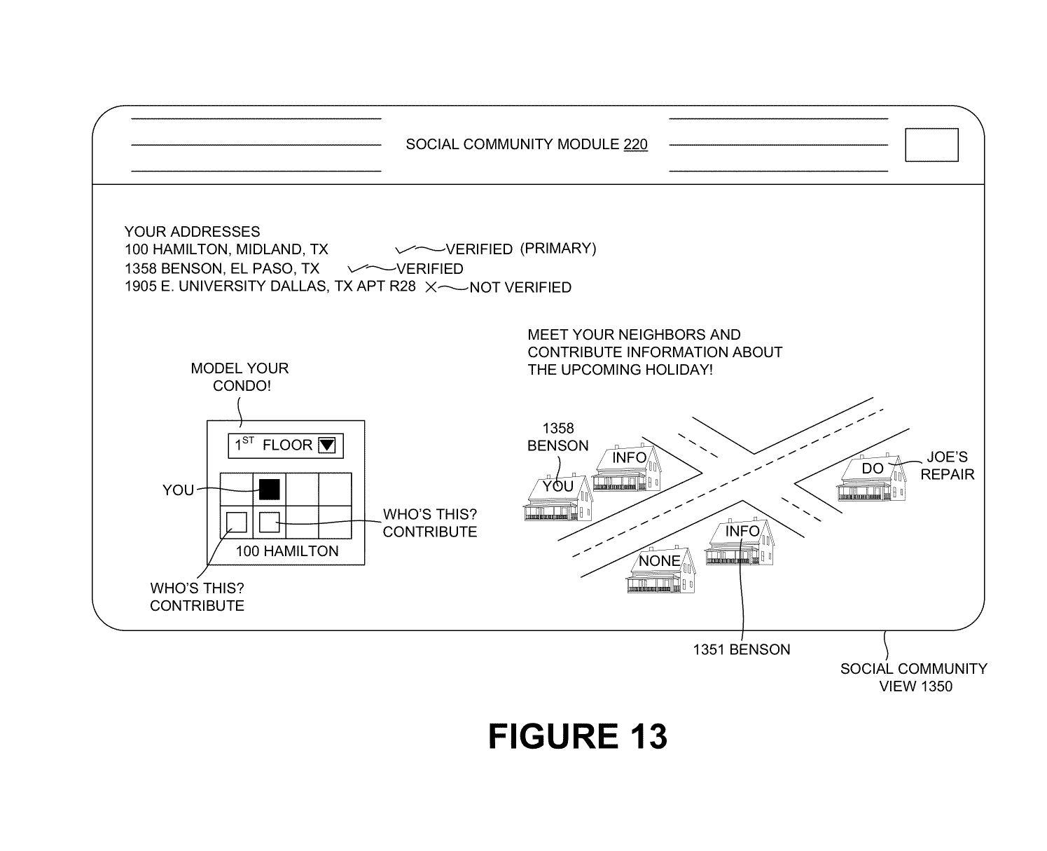

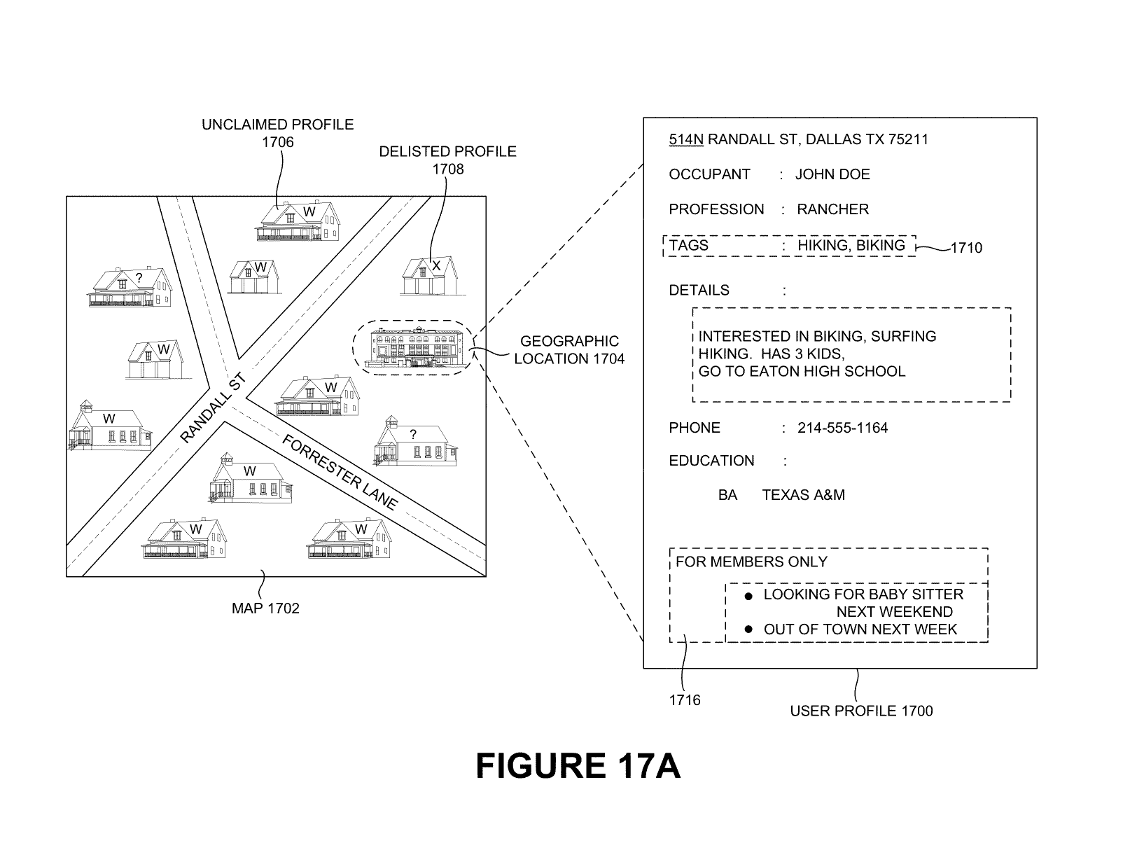

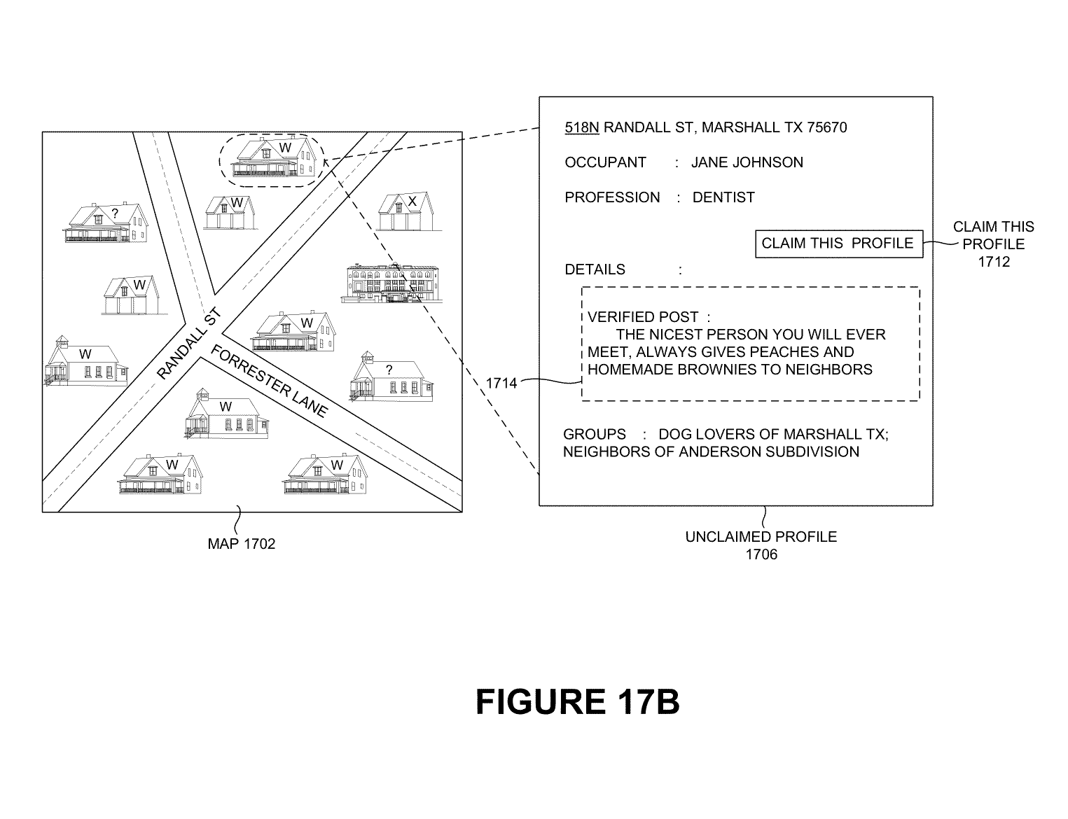

FIG. 13 is a user interface view of the social community module 220 220, according to one embodiment. The social community view 1350 may display the information associated with the social community module 220 (e.g., the social community module 220 of FIG. 2). The social community view 1350 may display a map of the specific geographic location associated with the user profile of the social community module 220 (e.g., the social community module 220 of FIG. 2). The social community view 1350 may display the map based geographic location associated with the user profile (e.g., the user profile 1700 of FIG. 17A) only after verifying the address of the registered user of the global neighborhood environment 2300 (e.g., the geospatially constrained social network 142 of FIG. 1).

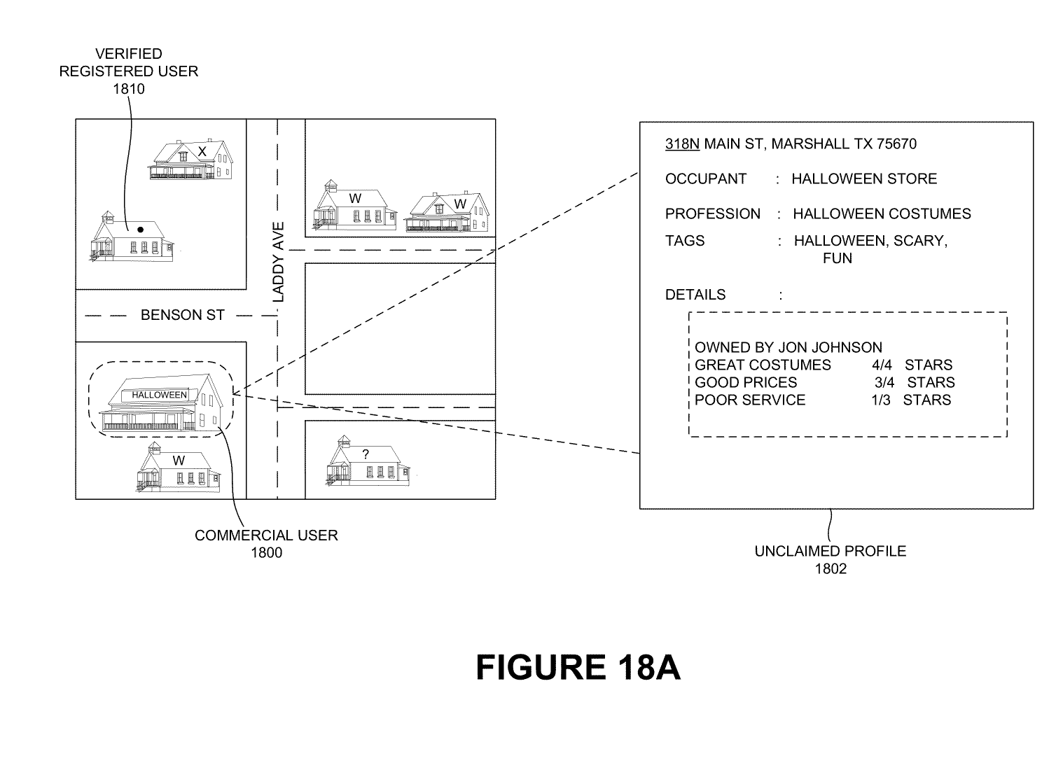

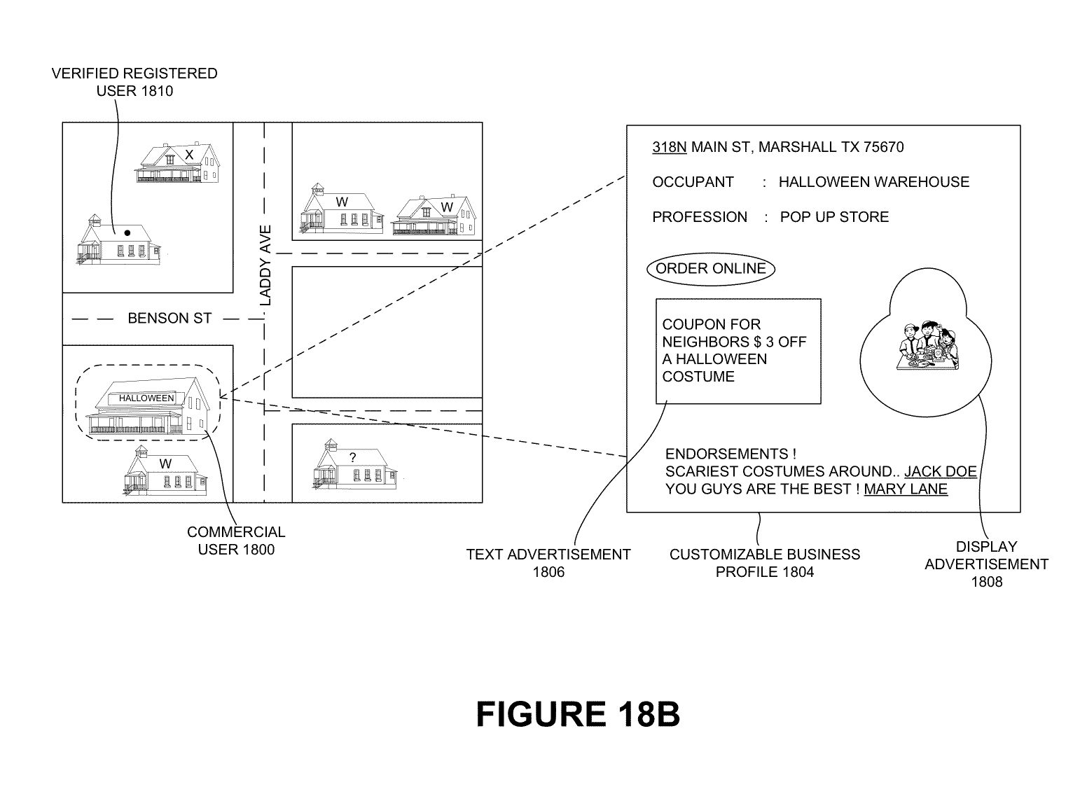

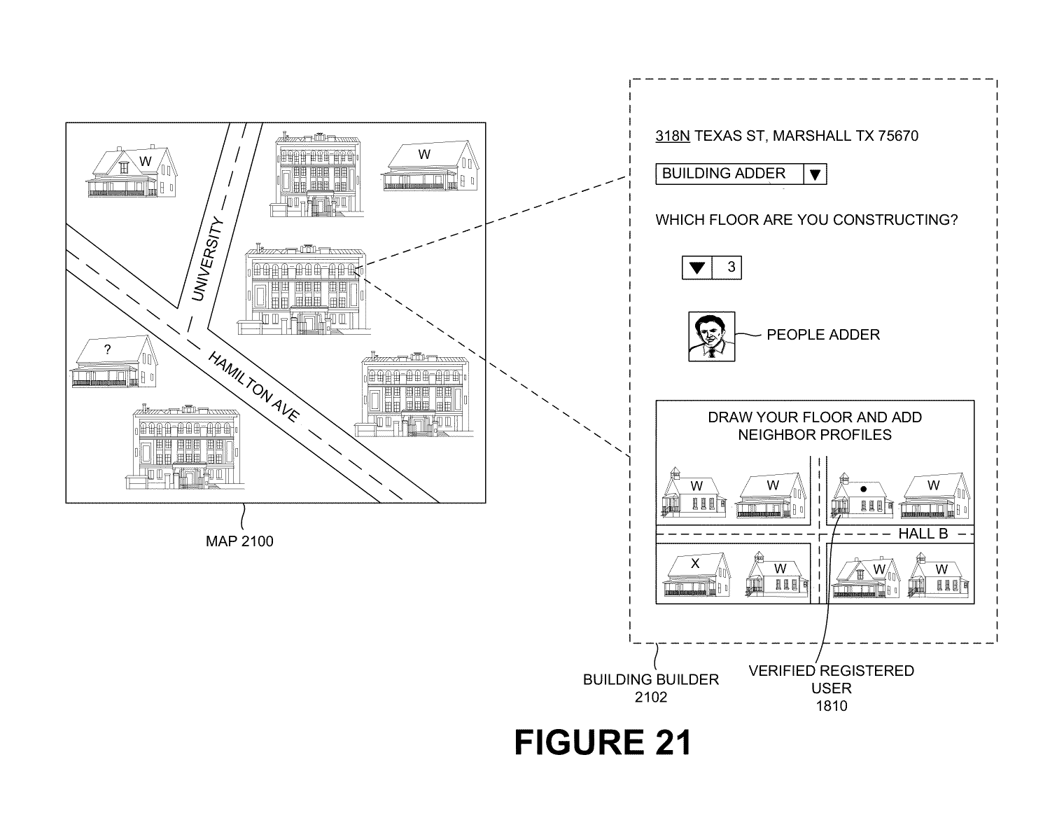

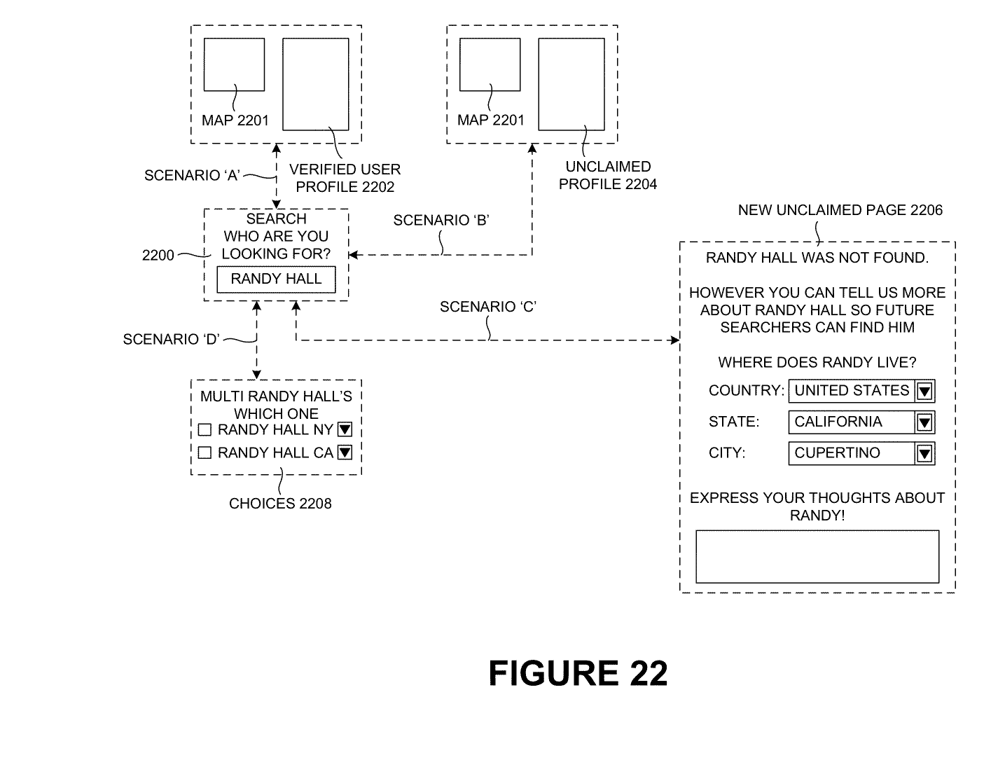

In addition, the social community view 1350 may provide a building creator (e.g., the building builder 2102 of FIG. 21), in which the registered users of the global neighborhood environment 2300 (e.g., the geospatially constrained social network 142 of FIG. 1) may create and/or modify empty unclaimed profiles (i.e., wiki profiles such as the unclaimed profile 1706 of FIG. 17A-17B, a unclaimed profile 1802 of FIG. 18A, a unclaimed profile 2204 of FIG. 22), building layouts, social network pages, etc. The social community view 1350 of the social community module 220 may enable access to the user (e.g., the user 106 of FIG. 1) to model a condo on any floor (e.g., basement, ground floor, first floor, etc.) selected through the drop down box by the registered user of the global neighborhood environment 2300 (e.g., the geo spatially constrained social network 142 of FIG. 1). The social community view 1350 of the social community module 220 (e.g., the social community module 220 of FIG. 2) may enable the registered user of the global neighborhood environment 2300 (e.g., the geospatially constrained social network 142 of FIG. 1) to contribute information about their neighbors (e.g., the other addresses associated with user profiles 402 of FIG. 4).

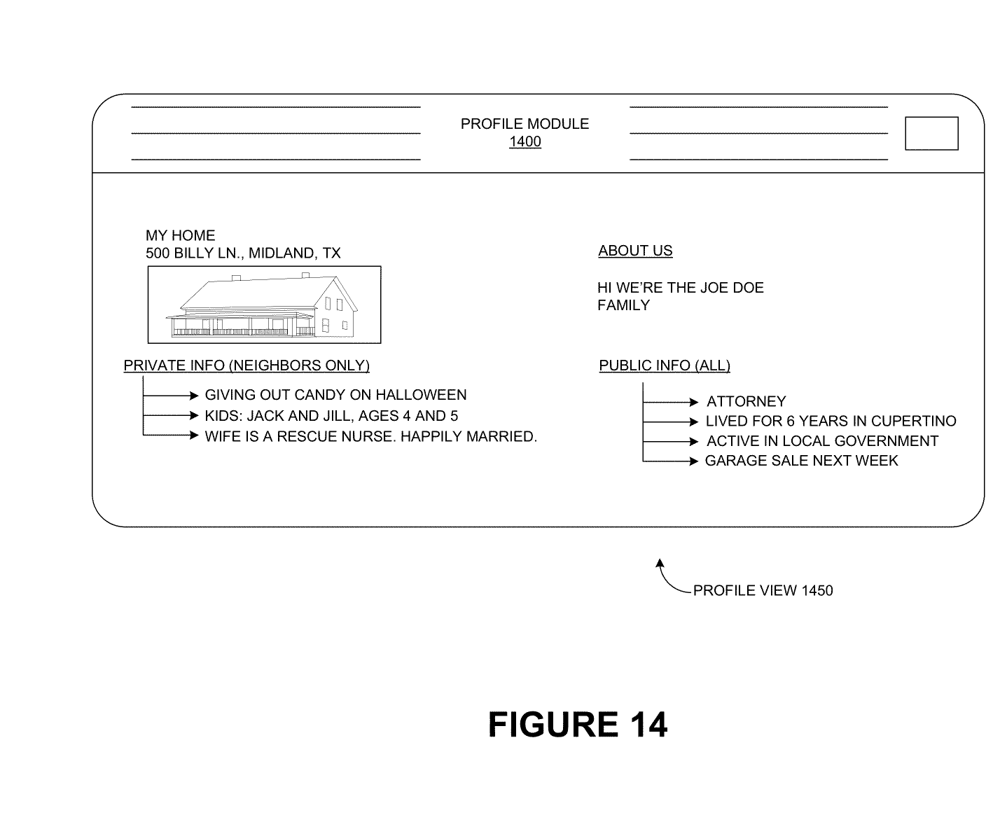

FIG. 14 is a profile view 1450 of a profile module 1400, according to one embodiment. The profile view 1450 of profile module 1400 may offer the registered user to access the profile about the neighbors (e.g., the other addresses associated with user profiles 402 of FIG. 4). The profile view 1450 of profile module 1400 may indicate the information associated with the profile of the registered user of the global neighborhood environment 2300 (e.g., the geospatially constrained social network 142 of FIG. 1). The profile view 1450 may display the address of the registered user. The profile view 1450 may also display events organized by the neighbors (e.g., the other addresses associated with user profiles 402 of FIG. 4), history of the neighbors (e.g., the other addresses associated with user profiles 402 of FIG. 4), and/or may also offer the information (e.g., public, private, etc) associated with the family of the neighbors (e.g., the other addresses associated with user profiles 402 of FIG. 4) located in the locality of the user (e.g., the user(s) 106 of FIG. 1) of the global neighborhood environment 2300 (e.g., the geospatially constrained social network 142 of FIG. 1).

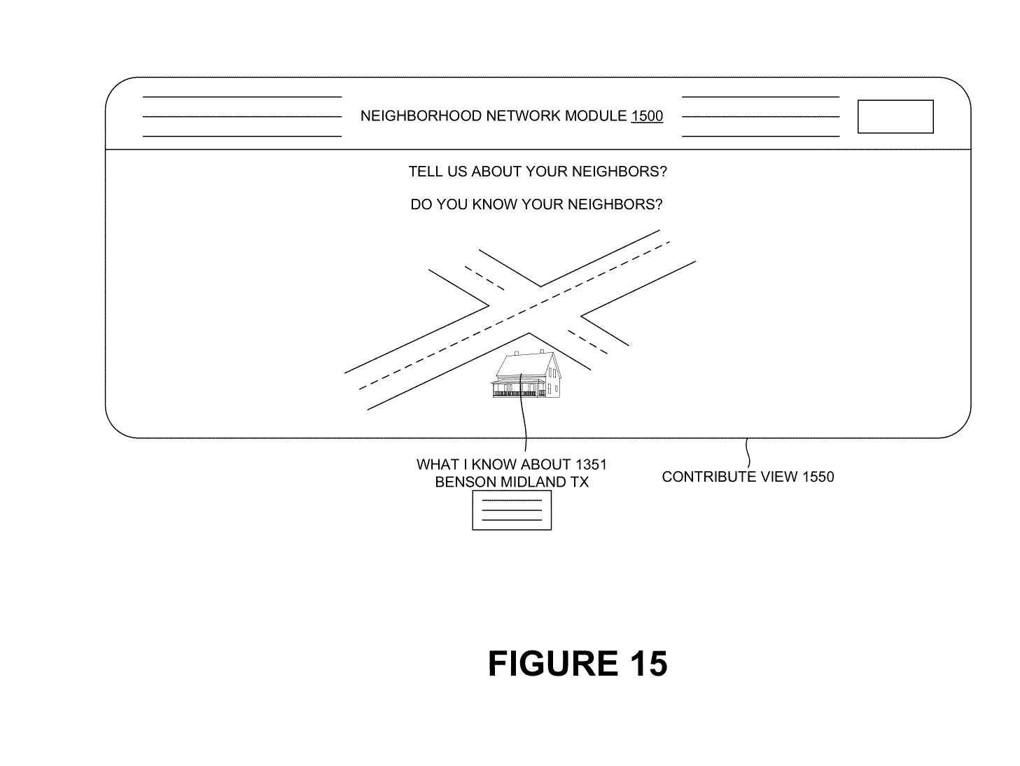

FIG. 15 is a contribute view 1550 of a neighborhood network module 1500, according to one embodiment. The contribute view 1550 of the neighborhood network module 1500 may enable the registered user of the global neighborhood environment 2300 (e.g., the geospatially constrained social network 142 of FIG. 1) to add information about their neighbors in the neighborhood network. The contribute view 1550 of the neighborhood network module 1500 may offer registered user of the global neighborhood environment 2300 (e.g., the geospatially constrained social network 142 of FIG. 1) to add valuable notes associated with the family, holiday participation, events, private information, etc.

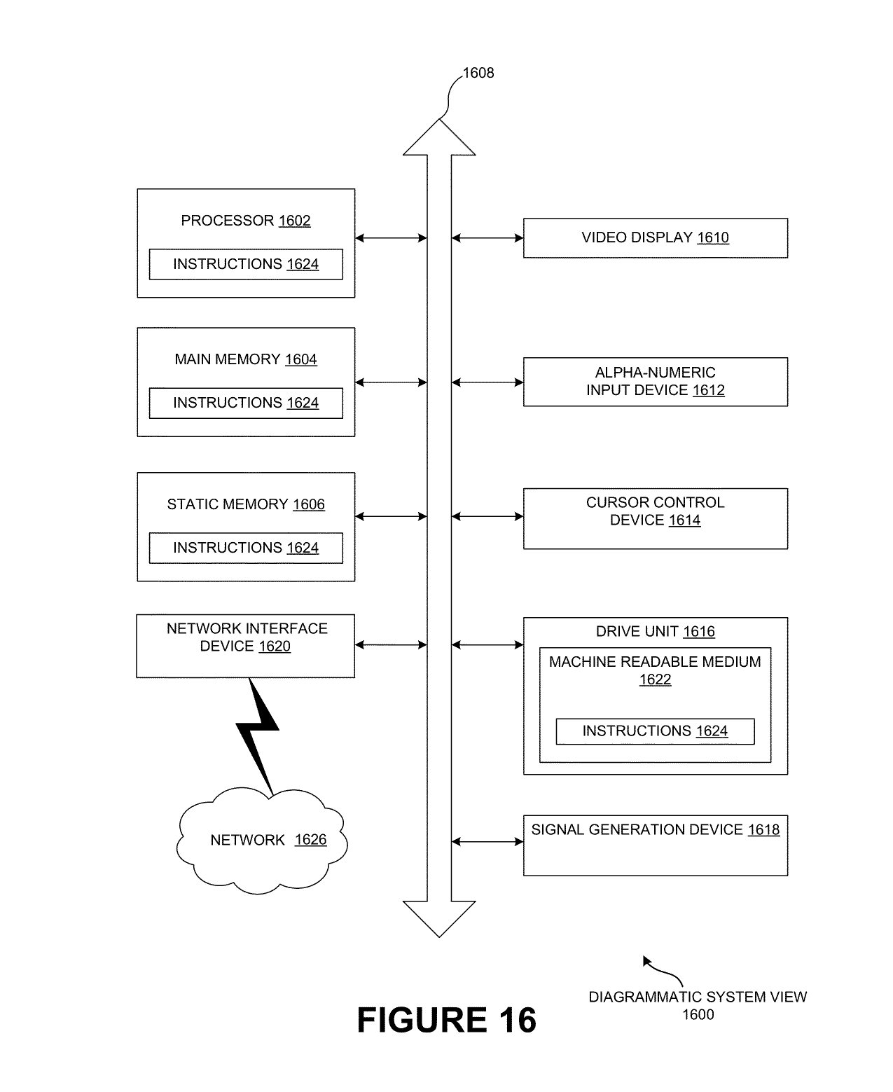

FIG. 16 is a diagrammatic system view, according to one embodiment.

FIG. 16 is a diagrammatic system view 1600 of a data processing system in which any of the embodiments disclosed herein may be performed, according to one embodiment. Particularly, the diagrammatic system view 1600 of FIG. 16 illustrates a processor 1602, a main memory 1604, a static memory 1606, a bus 1608, a video display 1610, an alpha-numeric input device 1612, a cursor control device 1614, a drive unit 1616, a signal generation device 1618, a network interface device 1620, a machine readable medium 1622, instructions 1624, and a network 1626, according to one embodiment.

The diagrammatic system view 1600 may indicate a personal computer and/or a data processing system (e.g., the device 104) in which one or more operations disclosed herein are performed. The processor 1602 may be microprocessor, a state machine, an application specific integrated circuit, a field programmable gate array, etc. (e.g., Intel® Pentium® processor). The main memory 1604 may be a dynamic random access memory and/or a primary memory of a computer system. The network interface device 1620 may be communicatively coupled with the network 1626.

The static memory 1606 may be a hard drive, a flash drive, and/or other memory information associated with the data processing system. The bus 1608 may be an interconnection between various circuits and/or structures of the data processing system. The video display 1610 may provide graphical representation of information on the data processing system (e.g., the device 104). The alpha-numeric input device 1612 may be a keypad, keyboard and/or any other input device of text (e.g., a special device to aid the physically handicapped). The cursor control device 1614 may be a pointing device such as a mouse.

The drive unit 1616 may be a hard drive, a storage system, and/or other longer term storage subsystem. The signal generation device 1618 may be a bios and/or a functional operating system of the data processing system. The machine readable medium 1622 may provide instructions on which any of the methods disclosed herein may be performed. The instructions 1624 may provide source code and/or data code to the processor 1602 to enable any one/or more operations disclosed herein.

FIG. 17A is a user interface view of mapping a user profile 1700 of the geographic location 1704, according to one embodiment. In the example embodiment illustrated in FIG. 17A, the user profile 1700 may contain the information associated with the geographic location 1704. The user profile 1700 may contain the information associated with the registered user. The user profile 1700 may contain information such as address user of the specific geographic location, name of the occupant, profession of the occupant, details, phone number, educational qualification, etc.

The map 1702 may indicate the global neighborhood environment 2300 (e.g., the geospatially constrained social network 142 of FIG. 1) of the geographical location 1704, a unclaimed profile 1706 (e.g., the unclaimed profile 1802 of FIG. 18A, the unclaimed profile 2204 of FIG. 22), and a delisted profile 1708. The geographical location 1704 may be associated with the user profile 1700. The unclaimed profile 1706 may be the unclaimed profile 1706 associated with the neighboring property surrounding the geographic location 1704. The delisted profile 1708 illustrated in example embodiment of FIG. 17A, may be the unclaimed profile 1706 that may be delisted when the registered user claims the physical property. The block 1710 illustrated in the example embodiment of FIG. 17A may be associated with hobbies, personal likes, etc. The block 1716 may be associated with events, requirements, etc. that may be displayed by the members of the global neighborhood environment 2300 (e.g., the geospatially constrained social network 142 of FIG. 1).

For example, a verified registered user (e.g., a verified registered user 1810 of FIG. 18A-B, a verified registered user 1810 of FIG. 21) may be associated with a user profile 1700. The user profile 1700 may be associated with a specific geographic location. A map concurrently displaying the user profile 1700 and the specific geographic location 1704 may be generated. Also, the unclaimed profiles 1706 associated with different geographic locations surrounding the specific geographic location associated with the user profile 1700 may be simultaneously generated in the map. In addition, a query of the user profile 1700 and/or the specific geographic location may be processed.

Similarly, a tag data (e.g., the tags 1710 of FIG. 17A) associated with the specific geographic locations, a particular geographic location, and the delisted geographic location may be processed. A frequent one of the tag data (e.g., the tags 1710 of FIG. 17A) may be displayed when the specific geographic location and/or the particular geographic location is made active, but not when a geographic location is delisted.

FIG. 17B is a user interface view of mapping of the unclaimed profile 1706, according to one embodiment. In the example embodiment illustrated in FIG. 17B, the map 1702 may indicate the geographic locations in the global neighborhood environment 2300 (e.g., the geospatially constrained social network 142 of FIG. 1) and/or may also indicate the geographic location of the unclaimed profile 1706. The unclaimed profile 1706 may display the information associated with the registered user of the global neighborhood environment 2300 (e.g., the geospatially constrained social network 142 of FIG. 1). The link claim this profile 1712 may enable the registered user to claim the unclaimed profile 1706 and/or may also allow the verified registered user (e.g., the verified registered user 1810 of FIG. 18A-B) to edit any information in the unclaimed profiles 1706. The block 1714 may display the information posted by any of the verified registered users (e.g., the verified registered user 1810 of FIG. 18A-B, the verified registered user 1810 of FIG. 21) of the global neighborhood environment 2300 (e.g., the geospatially constrained social network 142 of FIG. 1).

For example, a particular unclaimed profile (e.g., the particular unclaimed profile may be associated with a neighboring property to the specific property in the neighborhood) of the unclaimed profiles (e.g., the unclaimed profile 1802 of FIG. 18A, the unclaimed profile 2204 of FIG. 22) may be converted to another user profile (e.g., the user profile may be tied to a specific property in a neighborhood) when a different registered user (e.g., the user 106 of FIG. 1) claims a particular geographic location to the specific geographic location associated with the particular unclaimed profile.

In addition, a certain unclaimed profile of the unclaimed profiles may be de-listed when a private registered user claims a certain geographic location (e.g., the geographical location 1704 of FIG. 17A) adjacent to the specific geographic location and/or the particular geographic location. Also, the certain unclaimed profile in the map 1702 may be masked when the certain unclaimed profile is de-listed through the request of the private registered user.

Furthermore, a tag data (e.g., the tags 1710 of FIG. 17A) associated with the specific geographic location, the particular geographic location, and the de-listed geographic location may be processed. A frequent one of the tag data may be displayed when the specific geographic location and/or the particular geographic location are made active, but not when a geographic location is de-listed.

Moreover, the verified registered user (e.g., the verified registered user 1810 of FIG. 18A-B, the verified registered user 1810 of FIG. 21) may be permitted to edit any information in the unclaimed profiles 1706 including the particular unclaimed profile 1706 and/or the certain unclaimed profile until the certain unclaimed profile may be claimed by the different registered user and/or the private registered user. In addition, a claimant of any unclaimed profile 1706 may be enabled to control what information is displayed on their user profile. Also, the claimant may be allowed to segregate certain information on their user profile 1700 such that only other registered users directly connected to the claimant are able to view data on their user profile 1700.

FIG. 18A is a user interface view of mapping of a unclaimed profile 1802 of the commercial user 1800, according to one embodiment. In the example embodiment illustrated in FIG. 18A, the commercial user 1800 may be associated with the customizable business profile 1804 located in the commercial geographical location. The unclaimed profile 1802 may contain the information associated with the commercial user 1800. The unclaimed profile 1802 may contain the information such as address, name, profession, tag, details (e.g., ratings), and educational qualification etc. of the commercial user 1800. The verified registered user 1810 may be user associated with the global neighborhood environment 2300 (e.g., the geospatially constrained social network 142 of FIG. 1) and may communicate a message to the neighborhood commercial user 1800. For example, a payment of the commercial user 1800 and the verified registered user 1810 may be processed.

FIG. 18B is a user interface view of mapping of customizable business profile 1804 of the commercial user 1800, according to one embodiment. In the example embodiment illustrated in FIG. 18B, the commercial user 1800 may be associated with the customizable business profile 1804. The customizable business profile 1804 may be profile of any business firm (e.g., restaurant, hotels, supermarket, etc.) that may contain information such as address, occupant name, profession of the customizable business. The customizable business profile 1804 may also enable the verified registered user 1810 to place online order for the products.

For example, the commercial user 1800 may be permitted to purchase a customizable business profile 1804 associated with a commercial geographic location. Also, the verified registered user 1810 may be enabled to communicate a message to the global neighborhood environment 2300 (e.g., the geospatially constrained social network 142 of FIG. 1) based on a selectable distance range away from the specific geographic location. In addition, a payment of the commercial user 1800 and/or the verified registered user 1810 may be processed.

A text advertisement 1806 may display the information associated with the offers and/or events of the customizable business. The display advertisement 1808 may display ads of the products of the customizable business that may be displayed to urge the verified registered user 1810 to buy the products of the customizable business. The verified registered user 1810 may be user associated with the global neighborhood environment 2300 (e.g., the geospatially constrained social network 142 of FIG. 1) that may communicate a message to the commercial user 1800 and/or may be interested in buying the products of the customizable business.

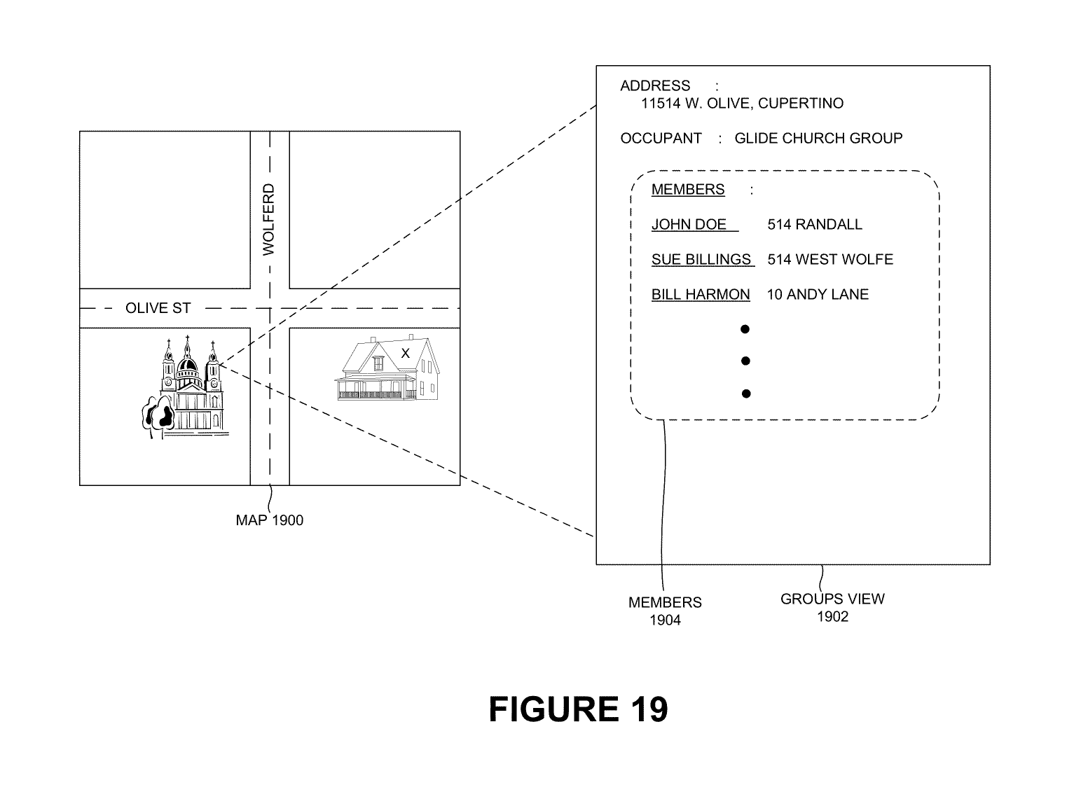

FIG. 19 is a user interface view of a groups view 1902 associated with particular geographical location, according to one embodiment. Particularly FIG. 19 illustrates, a map 1900, a groups view 1902, according to one embodiment. In the example embodiment illustrated in FIG. 19, the map view 1900 may display map view of the geographical location of the specific group of the global neighborhood environment 2300 (e.g., the geospatially constrained social network 142 of FIG. 1). The groups view 1902 may contain the information (e.g., address, occupant, etc.) associated with the particular group of the specific geographical location (e.g., the geographical location displayed in the map 1900) of the global neighborhood environment 2300 (e.g., the geospatially constrained social network 142 of FIG. 1). The members 1904 may contain the information about the members associated with the group (e.g., the group associated with geographical location displayed in the map) of the global neighborhood environment 2300 (e.g., the geospatially constrained social network 142 of FIG. 1).

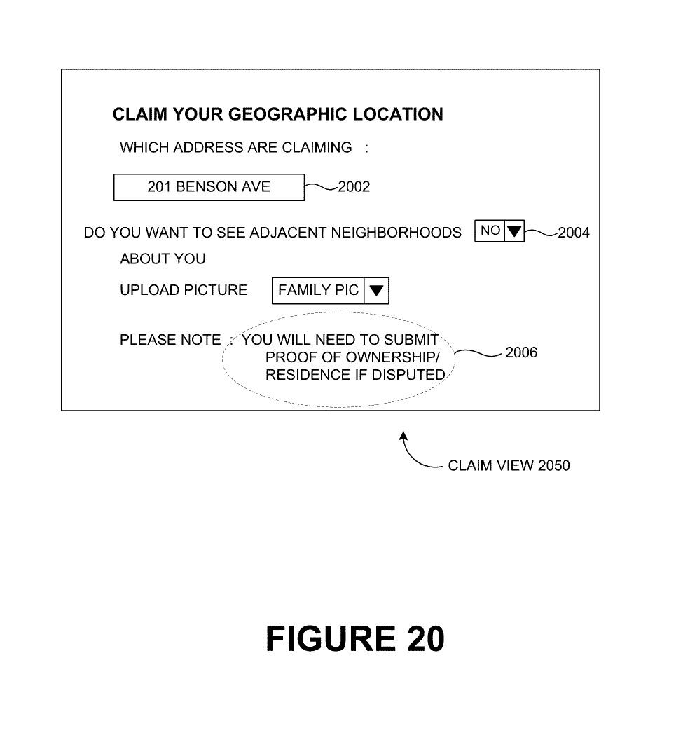

FIG. 20 is a user interface view of claim view 2050, according to one embodiment. The claim view 2050 may enable the user to claim the geographical location of the registered user. Also, the claim view 2050 may facilitate the user of the global neighborhood environment 2300 (e.g., the geospatially constrained social network 142 of FIG. 1) to claim the geographical location of property under dispute.

In the example embodiment illustrated in FIG. 20, the operation 2002 may allow the registered user of the global neighborhood environment 2300 (e.g., the geospatially constrained social network 142 of FIG. 1) to claim the address of the geographic location claimed by the registered user. The operation 2004 illustrated in example embodiment of FIG. 20, may enable the user to access adjacent neighborhoods. The operation 2006 may offer information associated with the document to be submitted by the registered users of the global neighborhood environment 2300 (e.g., the geospatially constrained social network 142 of FIG. 1) to claim the geographical location.

FIG. 21 is a user interface view of a building builder 2102, according to one embodiment. Particularly the FIG. 21 illustrates, a map 2100, a building builder 2102, according to one embodiment. The map 2100 may display the geographical location in which the verified registered user (e.g., the verified registered user 1810 of FIG. 18A-B) may create and/or modify empty unclaimed profiles (e.g., the unclaimed profile 1706 of FIG. 17A-17B, the unclaimed profile 1802 of FIG. 18A, the unclaimed profile 2204 of FIG. 22), building layouts, social network pages, and floor levels structures housing residents and businesses in the neighborhood (e.g., the claimed neighborhood 400 of FIG. 4, the unclaimed neighborhood 404 of FIG. 4). The building builder 2102 may enable the verified registered users (e.g., the verified registered user 1810 of FIG. 18A-B) of the global neighborhood environment 2300 (e.g., the geospatially constrained social network 142 of FIG. 1) to draw floor level structures, add neighbor's profiles and/or may also enable to select the floor number, type, etc. as illustrated in example embodiment of FIG. 21.

The verified registered user 1810 may be verified registered user of the global neighborhood environment 2300 (e.g., the geospatially constrained social network 142 of FIG. 1) interested in creating and/or modifying unclaimed profiles (e.g., the unclaimed profile 1706 of FIG. 17A-17B, the unclaimed profile 1802 of FIG. 18A, the unclaimed profile 2204 of FIG. 22), building layouts, social network pages, and floor level structure housing residents and businesses in the neighborhood (e.g., the claimed neighborhood 400 of FIG. 4, the unclaimed neighborhood 404 of FIG. 4) in the building builder 2102.

For example, a social community module 220 (e.g., a social community module 220 of FIG. 2) of the global neighborhood environment 2300 (e.g., the geospatially constrained social network 142 of FIG. 1) may generate a building creator (e.g., the building builder 2102 of FIG. 21) in which the registered users may create and/or modify empty unclaimed profiles (e.g., the unclaimed profile 1706 of FIG. 17A-17B, the unclaimed profile 1802 of FIG. 18A, the unclaimed profile 2204 of FIG. 22), building layouts, social network pages, and floor levels structures housing residents and/or businesses in the neighborhood (e.g., the claimed neighborhood 400 of FIG. 4, the unclaimed neighborhood 404 of FIG. 4).

FIG. 22 is a systematic view of communication of data, according to one embodiment. Particularly FIG. 22 illustrates a map 2201, verified user profile 2202, choices 2208 and a new unclaimed page 2206, according to one embodiment. The map 2201 may locate the details of the address of the registered user of the global neighborhood environment 2300 (e.g., the geospatially constrained social network 142 of FIG. 1). The verified user profile 2202 may store the profiles of the verified user of the global neighborhood environment 2300 (e.g., the geospatially constrained social network 142 of FIG. 1. The unclaimed profile 2204 may be the profiles of the registered user who may claim them in the global neighborhood environment 2300 (e.g., the geospatially constrained social network 142 of FIG. 1).

In operation 2200 the search for the user profile (e.g., the user profile 1700 of FIG. 17A) may be carried out by the registered user. The new unclaimed page 2206 (i.e., a new wiki page) may solicit for the details of a user whom the registered user is searching for in the global neighborhood environment 2300 (e.g., the geospatially constrained social network 142 of FIG. 1). The choices 2208 may ask whether the requested search is any among the displayed names. The new unclaimed page 2206 may request for the details of location such as country, state and/or city. The operation 2200 may communicate with the choices 2208, and the new unclaimed page 2206.

For example, a no-match module (e.g., a no-match module) of the search module (e.g., the search module) to request additional information from the verified registered user about a person, place, and business having no listing in the global neighborhood environment 2300 (e.g., the geospatially constrained social network 142 of FIG. 1) when no matches are found in a search query of the verified registered user (e.g., the verified registered user 1810 of FIG. 18A-B), and to create a new unclaimed page 2206 based on a response of the verified registered user 2202 about the at least one person, place, and business not previously indexed in the global neighborhood environment 2300 (e.g., the geospatially constrained social network 142 of FIG. 1).

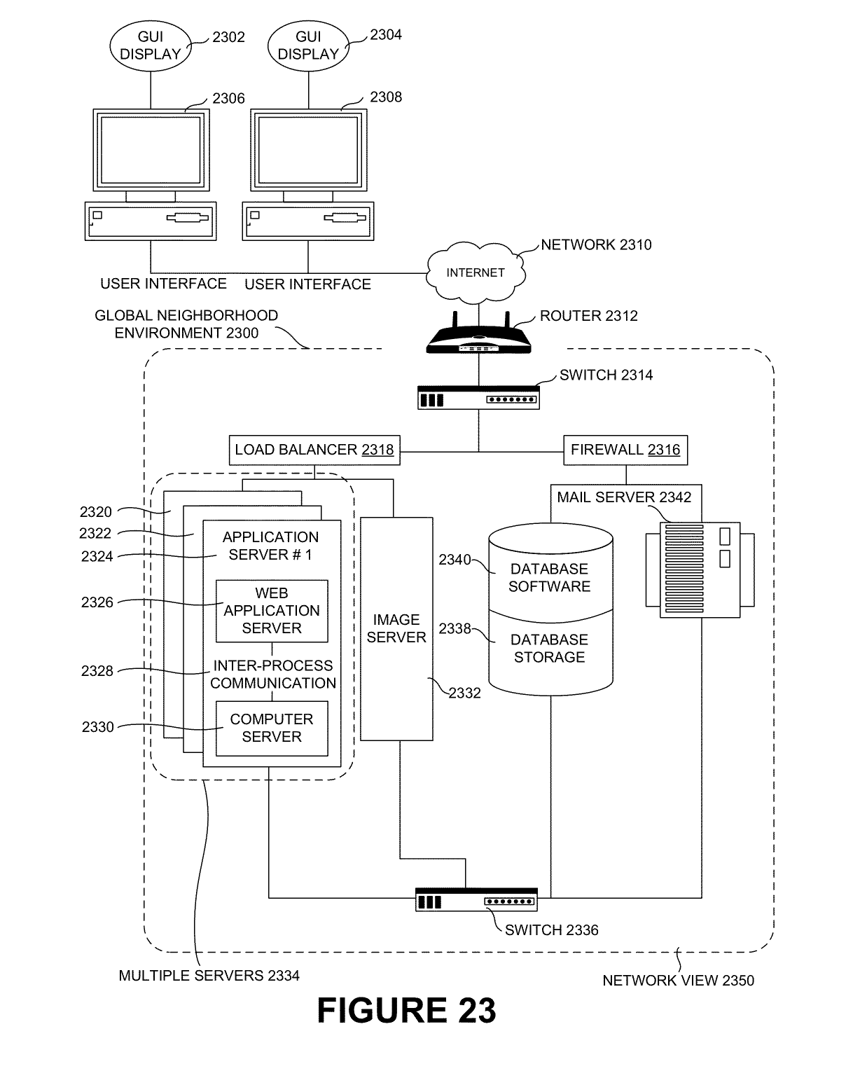

FIG. 23 is a systematic view of a network view 2350, according to one embodiment. Particularly it may include a GUI display 2302, a GUI display 2304, user interface 2306, a user interface 2308, a network 2310, a router 2312, a switch 2314, a firewall 2316, a load balancer 2318, an application server#1 2324, a web application server 2326, an inter-process communication 2328, a computer server 2330, an image server 2332, a multiple servers 2334, a switch 2336, a database storage 2338, database software 2340 and a mail server 2342, according to one embodiment.

The GUI display 2302 and GUI display 2304 may display particular case of user interface for interacting with a device capable of representing data (e.g., computer, cellular telephones, television sets etc) which employs graphical images and widgets in addition to text to represent the information and actions available to the user (e.g., the user 106 of FIG. 1). The user interface 2306 and user interface 2308 may be any device capable of presenting data (e.g., computer, cellular telephones, television sets etc). The network 2310 may be any collection of networks (e.g., internet, private networks, university social system, private network of a company etc) that may transfer any data to the user (e.g., the user 106 of FIG. 1) and the global neighborhood environment 2300 (e.g., the geospatially constrained social network 142 of FIG. 1).

The router 2312 may forward packets between networks and/or information packets between the global neighborhood environment 2300 (e.g., the geospatially constrained social network 142 of FIG. 1) and registered user over the network (e.g., internet). The switch 2314 may act as a gatekeeper to and from the network (e.g., internet) and the device. The firewall 2316 may provides protection (e.g., permit, deny or proxydata connections) from unauthorized access to the global neighborhood environment 2300 (e.g., the geospatially constrained social network 142 of FIG. 1. The load balancer 2318 may balance the traffic load across multiple mirrored servers in the global neighborhood environment 2300 (e.g., the geospatially constrained social network 142 of FIG. 1) and may be used to increase the capacity of a server farm beyond that of a single server and/or may allow the service to continue even in the face of server down time due to server failure and/or server maintenance.

The application server 2322 may be server computer on a computer network dedicated to running certain software applications of the global neighborhood environment 2300 (e.g., the geospatially constrained social network 142 of FIG. 1). The web application server 2326 may be server holding all the web pages associated with the global neighborhood environment 2300 (e.g., the geospatially constrained social network 142 of FIG. 1). The inter-process communication 2328 may be set of rules for organizing and un-organizing factors and results regarding the global neighborhood environment 2300 (e.g., the geospatially constrained social network 142 of FIG. 1). The computer server 2330 may serve as the application layer in the multiple servers of the global neighborhood environment 2300 (e.g., the geospatially constrained social network 142 of FIG. 1) and/or may include a central processing unit (CPU), a random access memory (RAM) temporary storage of information, and/or a read only memory (ROM) for permanent storage of information regarding the global neighborhood environment 2300 (e.g., the geospatially constrained social network 142 of FIG. 1).

The image server 2332 may store and provide digital images of the registered user of the global neighborhood environment 2300 (e.g., the geo spatially constrained social network 142 of FIG. 1). The multiple servers 2334 may be multiple computers or devices on a network that may manage network resources connecting the registered user and the global neighborhood environment 2300 (e.g., the geospatially constrained social network 142 of FIG. 1). The database storage 2338 may store software, descriptive data, digital images, system data and any other data item that may be related to the user (e.g., the user 106 of FIG. 1) of the global neighborhood environment 2300 (e.g., the geospatially constrained social network 142 of FIG. 1). The database software 2340 may be provided a database management system that may support the global neighborhood environment 2300 (e.g., the geospatially constrained social network 142 of FIG. 1). The mail server 2342 may be provided for sending, receiving and storing mails. The user interface 2306 and 2308 may communicate with the GUI display(s) 2302 and 2304, the router 2312 through the network 2310 and the global neighborhood environment 2300 (e.g., the geospatially constrained social network 142 of FIG. 1).

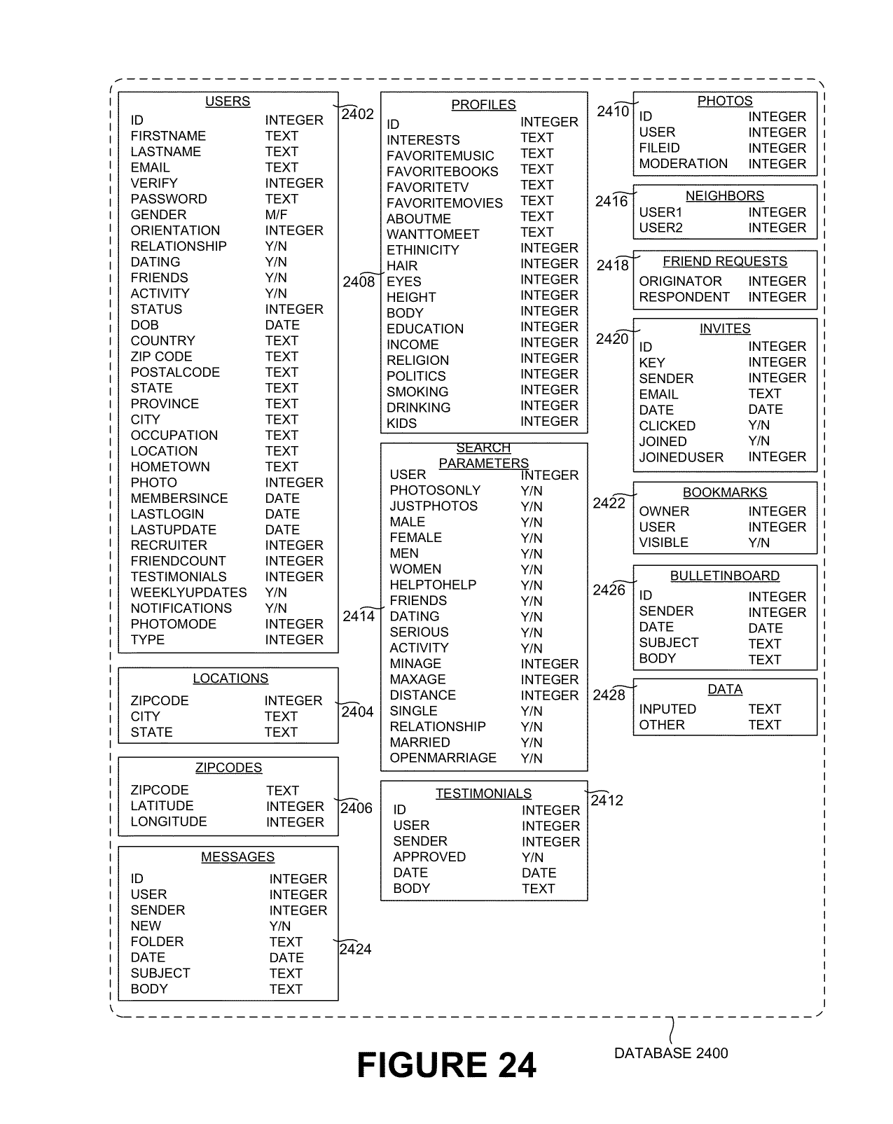

FIG. 24 is a block diagram of a database, according to one embodiment. Particularly the block diagram of the database 2400 of FIG. 24 illustrates a user data 2402, a location data, a zip codes data 2406, a profiles data 2408, a photos data 2410, a testimonials data 2412, a search parameters data 2414, a neighbor's data 2416, a friends requests data 2418, a invites data 2420, a bookmarks data 2422, a message data 2424 and a bulletin board data 2426, and a data 2428, according to one embodiment.

The database 2400 be may include descriptive data, preference data, relationship data, and/or other data items regarding the registered user of the global neighborhood environment 2300 (e.g., the geospatially constrained social network 142 of FIG. 1.

The user data 2402 may be a descriptive data referring to information that may describe a user (e.g., the user 106 of FIG. 1). It may include elements in a certain format for example Id may be formatted as integer, Firstname may be in text, Lastname may be in text, Email may be in text, Verify may be in integer, Password may be in text, Gender may be in m/f, Orientation may be in integer, Relationship may be in y/n, Dating may be in y/n, Friends may be in y/n, Activity may be in y/n, Status may be in integer, Dob may be in date, Country may be in text, Zipcode may be in text, Postalcode may be in text, State may be in text, Province may be in text, City may be in text, Occupation may be in text, Location may be in text, Hometown may be in text, Photo may be in integer, Membersince may be in date, Lastlogin may be in date, Lastupdate may be in date, Recruiter may be in integer, Friendcount may be in integer, Testimonials may be in integer, Weeklypdates may be in y/n, Notifications may be in y/n, Photomode may be in integer and/or Type may be in integer.

The locations data 2404 may clarify the location details in formatted approach. For example Zip code may be formatted as integer, City may be in text and/or State may be in text. The zip codes data 2406 may provide information of a user location in formatted manner. For example Zip code may be formatted as text, Latitude may be in integer and/or Longitude may be in integer. The profile data 2408 may clutch personnel descriptive data that may be formatted.

For examples ID may be formatted as integer, Interests may be in text, Favoritemusic may be in text, Favaoritebooks may be in text, Favoritetv may be in text, Favoritemovies may be in text, Aboutme may be in text, Wanttomeet may be in text, Ethnicity may be in integer, Hair may be in integer, Eyes may be in integer, Height may be in integer, Body may be in integer, Education may be in integer, Income may be in integer, Religion may be in integer, Politics may be in integer Smoking may be in integer, Drinking may be in integer and/or Kids may be in integer.

The photos data 2410 may represent a digital image and/or a photograph of the user formatted in certain approach. For example Id may be formatted as integer, User may be in integer, Fileid may be in integer and/or Moderation may be in integer. The testimonials data 2412 may allow users to write “testimonials” 2412, or comments, about each other and in these testimonials, users may describe their relationship to an individual and their comments about that individual. For example the user might write a testimonial that states “Rohan has been a friend of mine since graduation days. He is smart, intelligent, and a talented person.” The elements of testimonials data 2412 may be formatted as Id may be in integer, User may be in integer, Sender may be integer, Approved may be in y/n, Date may be in date and/or Body may be formatted in text.

The search parameters data 2414 may be preference data referring to the data that may describe preferences one user has with respect to another (For example, the user may indicate that he is looking for a female who is seeking a male for a serious relationship). The elements of the search parameters data 2414 may be formatted as User 2402 may be in integer, Photosonly may be in y/n, Justphotos may be in y/n, Male may be in y/n, Female may be in y/n, Men may be in y/n, Women may be in y/n, Helptohelp may be in y/n, Friends may be in y/n, Dating may be in y/n, Serious may be in y/n, Activity may be in y/n, Minage may be in integer, Maxage may be in integer, Distance may be in integer, Single may be in y/n, Relationship may be in y/n, Married may be in y/n and/or Openmarriage may be in y/n.

The neighbor's data 2416 may generally refer to relationships among registered users of the global neighborhood environment 2300 (e.g., the geospatially constrained social network 142 of FIG. 1) that have been verified and the user has requested another individual to join the system as neighbor's data 2416, and the request may be accepted. The elements of the neighbors data 2416 may be formatted as user1 may be in integer and/or user2 may be in integer. The friend requests data 2418 may tracks requests by users within the neighborhood (e.g., the claimed neighborhood 400 of FIG. 4, the unclaimed neighborhood 404 of FIG. 4) to other individuals, which requests have not yet been accepted and may contain elements originator and/or respondent formatted in integer. The invites data 2420 may describe the status of a request by the user to invite an individual outside the neighborhood (e.g., the claimed neighborhood 400 of FIG. 4, the unclaimed neighborhood 404 of FIG. 4) to join the neighborhood (e.g., the claimed neighborhood 400 of FIG. 4, the unclaimed neighborhood 404 of FIG. 4) and clarify either the request has been accepted, ignored and/or pending.

The elements of the invites data 2420 may be formatted as Id may be in integer, Key may be in integer, Sender may be in integer, Email may be in text, Date may be in date format, Clicked may be in y/n, Joined may be in y/n and/or Joineduser may be in integer. The bookmarks data 2422 may provide the data for a process allowed wherein a registered user of the global neighborhood environment 2300 (e.g., the geospatially constrained social network 142 of FIG. 1) may indicate an interest in the profile of another registered user. The bookmark data 2422 elements may be formatted as Owner may be in integer, User may be in integer and/or Visible may be in y/n. The message data 2424 may allow the users to send one another private messages.

The message data 2424 may be formatted as Id may be in integer, (e.g., User may be in integer, Sender may be in integer, New may be in y/n, Folder may be in text, Date may be in date format, Subject may be in text and/or Body may be in text format) The bulletin board data 2426 may support the function of a bulletin board that users may use to conduct online discussions, conversation and/or debate. The data 2428 may share the user profiles (e.g., the user profile 1700 of FIG. 17A) in the neighborhood (e.g., the claimed neighborhood 400 of FIG. 4, the unclaimed neighborhood 404 of FIG. 4) and its elements may be formatted as wikis inputted and/or others may be in text format.

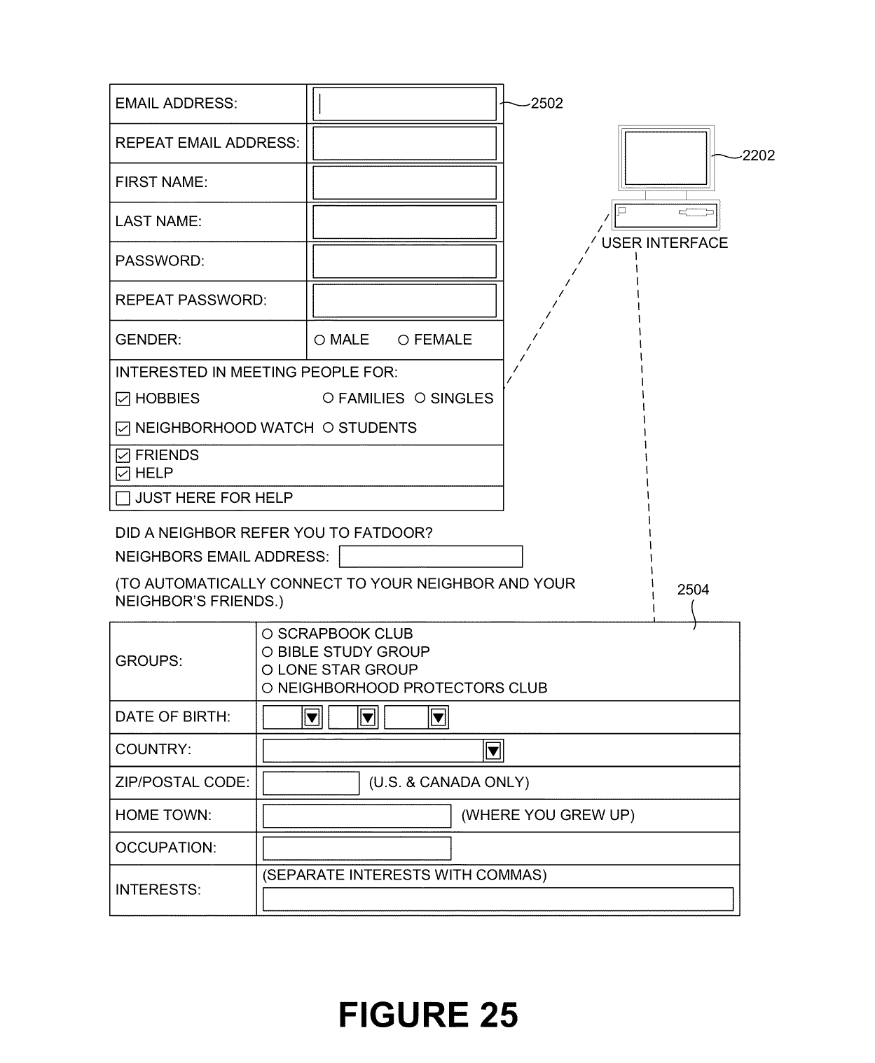

FIG. 25 is an exemplary graphical user interface view for data collection, according to one embodiment. Particularly FIG. 25 illustrates exemplary screens 2502, 2504 that may be provided to the user (e.g., the user 106 of FIG. 1) through an interface may be through the network (e.g., Internet), to obtain user descriptive data. The screen 2502 may collect data allowing the user (e.g., the user 106 of FIG. 1) to login securely and be identified by the neighborhood (e.g., the neighborhood 602A-N of FIG. 1). This screen 2502 may allow the user to identify the reason he/she is joining the neighborhood. For example, a user may be joining the neighborhood for “neighborhood watch”. The screen 2504 may show example of how further groups may be joined. For example, the user (e.g., the user 106 of FIG. 1) may be willing to join a group “Raj for city council”. It may also enclose the data concerning Dob, country, zip/postal code, hometown, occupation and/or interest.

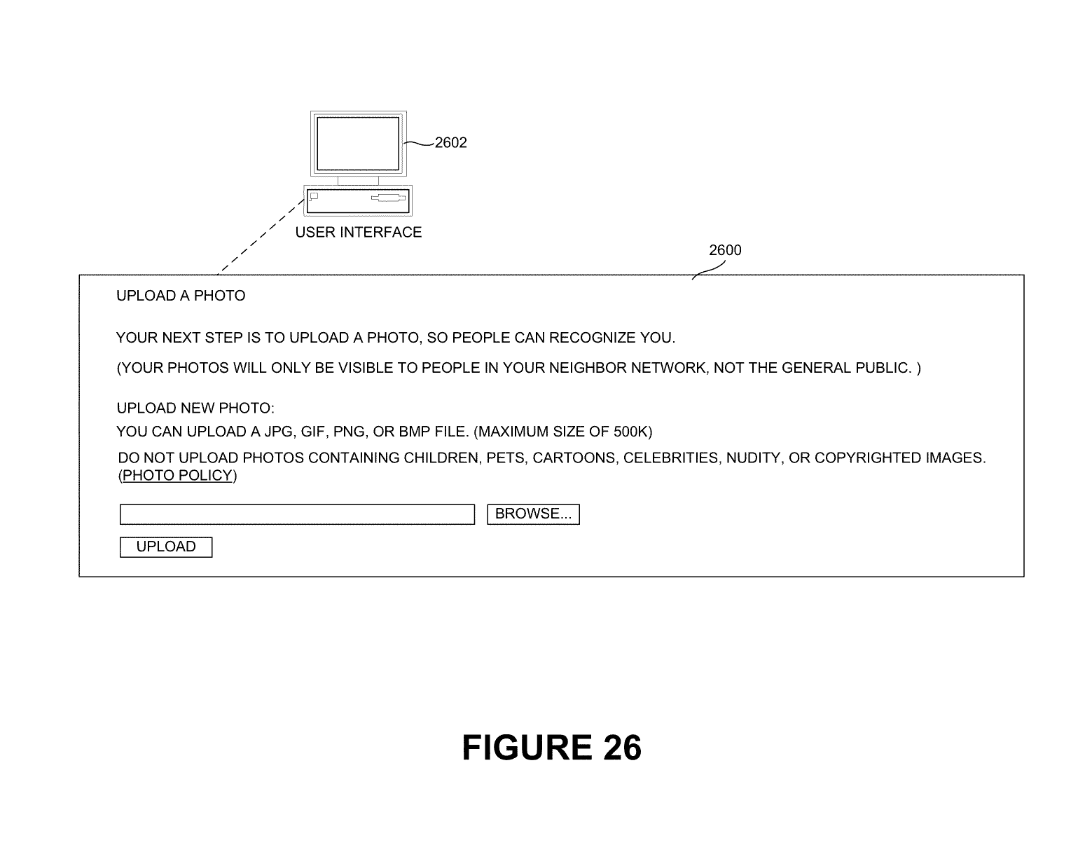

FIG. 26 is an exemplary graphical user interface view of image collection, according to one embodiment. A screen 2600 may be interface provided to the user (e.g., the user 106 of FIG. 1) over the network (e.g., internet) may be to obtain digital images from system user. The user interface 2602 may allow the user (e.g., the user 106 of FIG. 1) to browse files on his/her computer, select them, and then upload them to the neighborhood (e.g., the claimed neighborhood 400 of FIG. 4, the unclaimed neighborhood 404 of FIG. 4). The user (e.g., the user 106 of FIG. 1) may upload the digital images and/or photo that may be visible to people in the neighbor (e.g., the other addresses associated with user profiles 402 of FIG. 4) network and not the general public. The user may be able to upload a JPG, GIF, PNG and/or BMP file in the screen 2600.

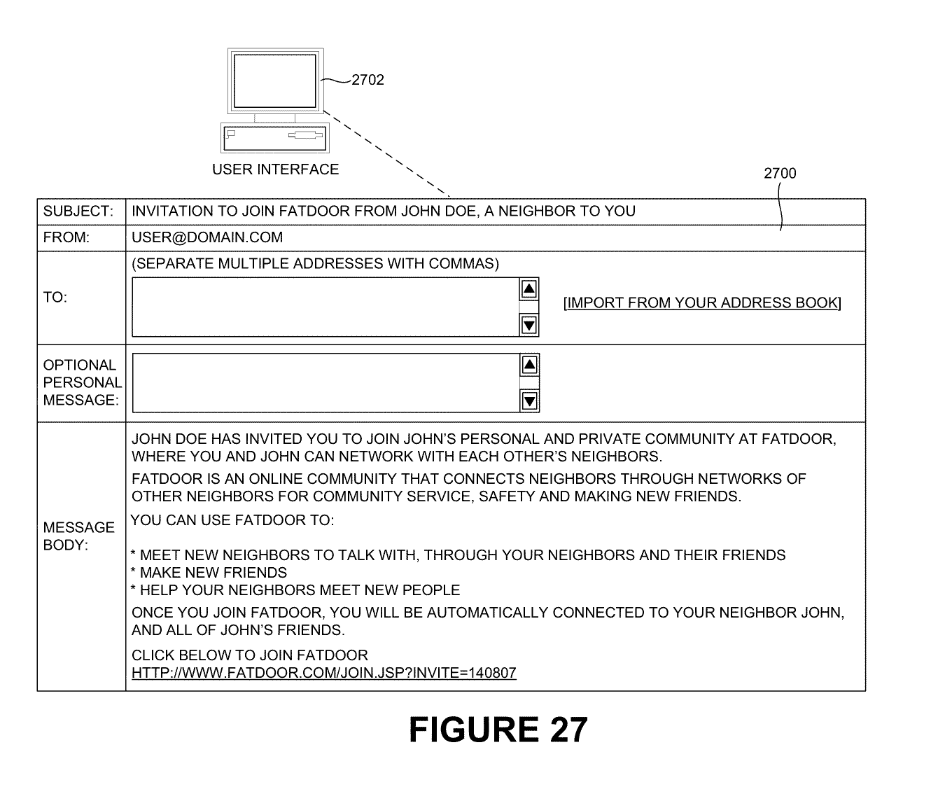

FIG. 27 is an exemplary graphical user interface view of an invitation, according to one embodiment. An exemplary screen 2700 may be provided to a user through a user interface 2702 may be over the network (e.g., internet) to allow users to invite neighbor or acquaintances to join the neighborhood (e.g., the claimed neighborhood 400 of FIG. 4, the unclaimed neighborhood 404 of FIG. 4). The user interface 2702 may allow the user (e.g., the user 106 of FIG. 1) to enter one or a plurality of e-mail addresses for friends they may like to invite to the neighborhood (e.g., the claimed neighborhood 400 of FIG. 4, the unclaimed neighborhood 404 of FIG. 4). The exemplary screen 2700 may include the “subject”, “From”, “To”, “Optional personnel message”, and/or “Message body” sections. In the “Subject” section a standard language text may be included for joining the neighborhood (e.g., Invitation to join Fatdoor from John Doe, a neighborhood.).

The “From” section may include the senders email id (e.g., user@domain.com). The “To” section may be provided to add the email id of the person whom the sender may want to join the neighborhood (e.g., the claimed neighborhood 400 of FIG. 4, the unclaimed neighborhood 404 of FIG. 4). The message that may be sent to the friends and/or acquaintances may include standard language describing the present neighborhood, the benefits of joining and the steps required to join the neighborhood (e.g., the claimed neighborhood 400 of FIG. 4, the unclaimed neighborhood 404 of FIG. 4). The user (e.g., the user 106 of FIG. 1) may choose to include a personal message, along with the standard invitation in the “Optional personal message” section. In the “Message body” section the invited friend or acquaintance may initiate the process to join the system by clicking directly on an HTML link included in the e-mail message (e.g., http://www.fatdoor.com/join.jsp? Invite=140807). In one embodiment, the user (e.g., the user 106 of FIG. 1) may import e-mail addresses from a standard computerized address book. The system may further notify the inviting user when her invitee accepts or declines the invitation to join the neighborhood (e.g., the claimed neighborhood 400 of FIG. 4, the unclaimed neighborhood 404 of FIG. 4).

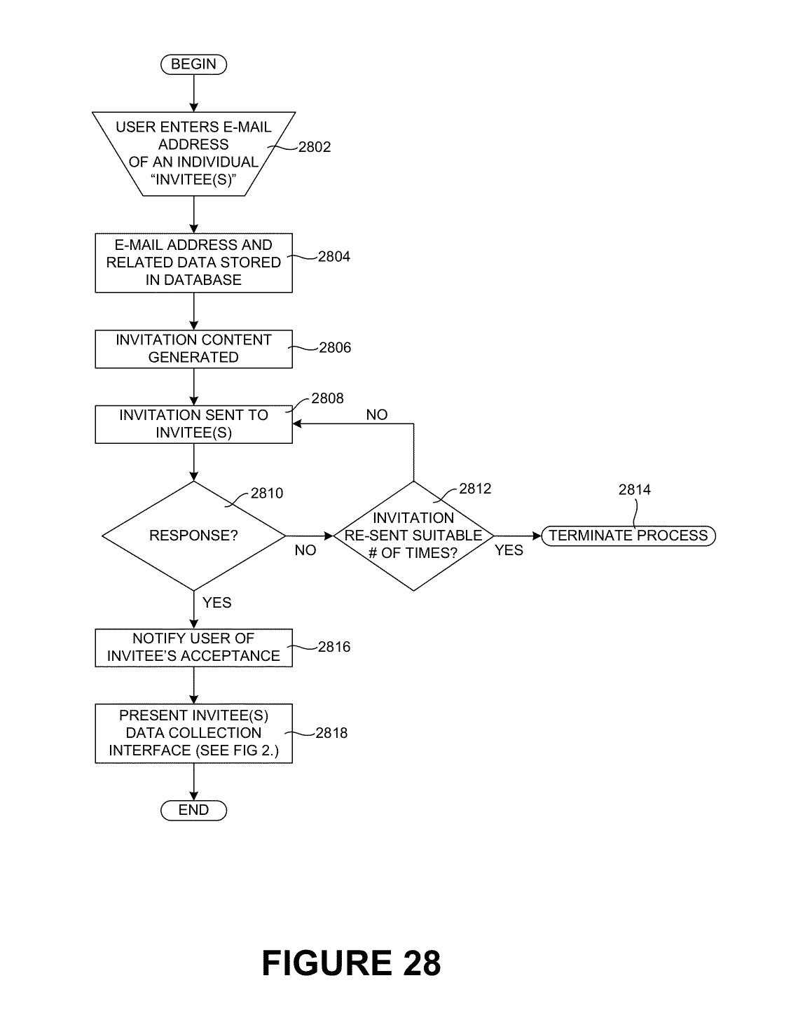

FIG. 28 is a flowchart of inviting the invitee(s) by the registered user, notifying the registered user upon the acceptance of the invitation by the invitee(s) and, processing and storing the input data associated with the user (e.g., the user 106 of FIG. 1) in the database, according to one embodiment. In operation 2802, the verified registered user (e.g., the verified registered user 1810 of FIG. 18A-B, the verified registered user 1810 of FIG. 21) willing to invite the individual enters the email addresses of an individual “invitee”. In operation 2804, the email address and the related data of the invitee may be stored in the database. In operation 2806, the invitation content for inviting the invitee may be generated from the data stored in the database. In operation 2808, the registered user sends invitation to the invitee(s).

In operation 2810, response from the user (e.g., the user 106 of FIG. 1) may be determined. In operation 2812, if the invitee doesn't respond to invitation sent by the registered user then registered user may resend the invitation for a predefined number of times. In operation 2814, if the registered user resends the invitation to the same invitee for predefined number of times and if the invitee still doesn't respond to the invitation the process may be terminated automatically.

In operation 2816, if the invitee accepts the invitation sent by the registered user then system may notify the registered user that the invitee has accepted the invitation. In operation 2818, the input from the present invitee(s) that may contain the descriptive data about the friend (e.g., registered user) may be processed and stored in the database.

For example, each registered user associated e-mail addresses of individuals who are not registered users may be stored and identified by each registered user as neighbors. An invitation to become a new user (e.g., the user 106 of FIG. 1) may be communicated out to neighbor (e.g., other addresses associated with a verified user profile 402) of the particular user. An acceptance of the neighbor (e.g., the other addresses associated with user profiles 402 of FIG. 4) to whom the invitation was sent may be processed.

The neighbor (e.g., the other addresses associated with user profiles 402 of FIG. 4) may be added to a database and/or storing of the neighbor (e.g., the other addresses associated with user profiles 402 of FIG. 4), a user ID and a set of user IDs of registered users who are directly connected to the neighbor (e.g., the other addresses associated with user profiles 402 of FIG. 4), the set of user IDs stored of the neighbor (e.g., the other addresses associated with user profiles 402 of FIG. 4) including at least the user ID of the verified registered user (e.g., the verified registered user 1810 of FIG. 18A-B, the verified registered user 1810 of FIG. 21). Furthermore, the verified registered user may be notified that the invitation to the neighbor (e.g., the other addresses associated with user profiles 402 of FIG. 4) has been accepted when an acceptance is processed. Also, inputs from the neighbor (e.g., the other addresses associated with user profiles 402 of FIG. 4) having descriptive data about the friend may be processed and the inputs in the database may be stored.

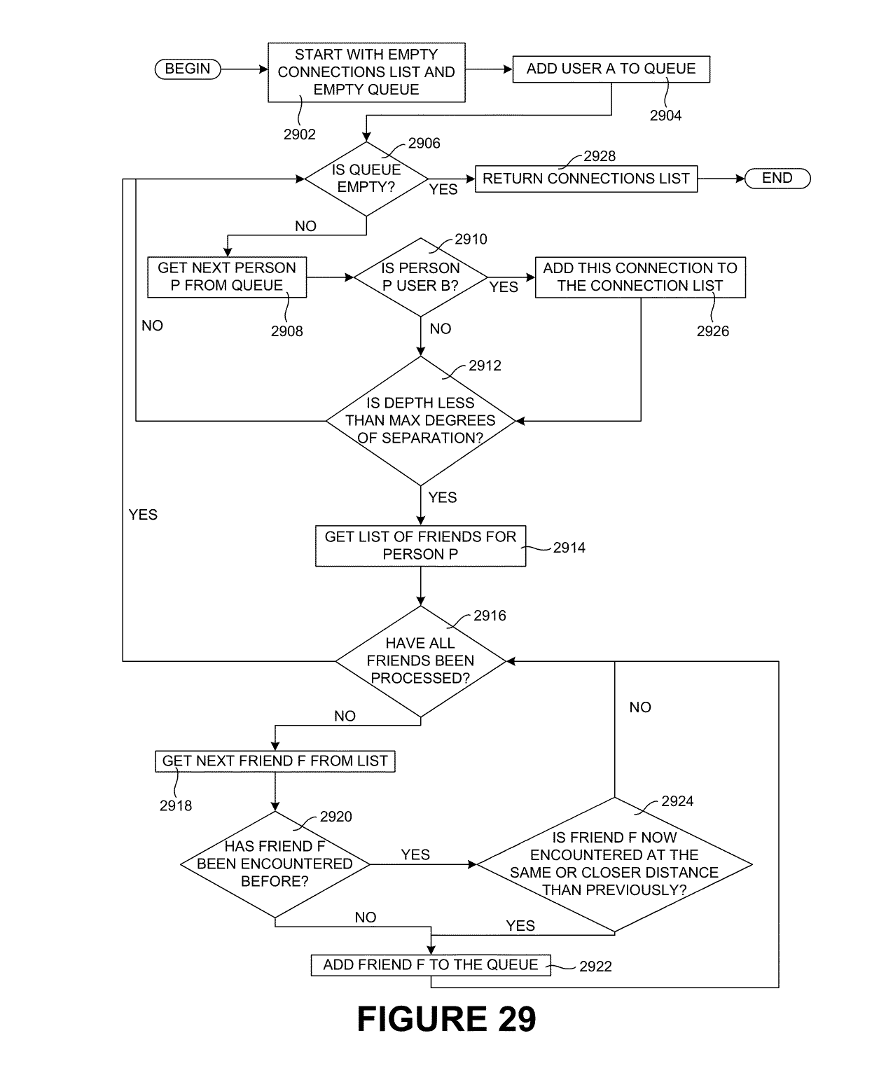

FIG. 29 is a flowchart of adding the neighbor (e.g., the other addresses associated with user profiles 402 of FIG. 4) to the queue, according to one embodiment. In operation 2902, the system may start with the empty connection list and empty queue. In operation 2904, the user may be added to the queue. In operation 2906, it is determined whether the queue is empty. In operation 2908, if it is determined that the queue is not empty then the next person P may be taken from the queue. In operation 2910, it may be determined whether the person P from the queue is user B or not. In operation 2912, if the person P is not user B then it may be determined whether the depth of the geographical location is less than maximum degrees of separation.

If it is determined that depth is more than maximum allowable degrees of separation then it may repeat the operation 2908. In operation 2914, it may be determined that the depth of the geographical location (e.g., the geographical location 1704) is less than maximum degrees of separation then the neighbors (e.g., the other addresses associated with user profiles 402 of FIG. 4) list for person P may be processed. In operation 2916, it may be determined whether all the neighbors (e.g., the other addresses associated with user profiles 402 of FIG. 4) in the neighborhood (e.g., the claimed neighborhood 400 of FIG. 4, the unclaimed neighborhood 404 of FIG. 4) have been processed or not. If all the friends are processed it may be determined the queue is empty.

In operation 2918, if all the neighbors (e.g., the other addresses associated with user profiles 402 of FIG. 4) for person P are not processed then next neighbor N may be taken from the list. In operation 2920, it may be determined whether the neighbor (e.g., the other addresses associated with user profiles 402 of FIG. 4) N has encountered before or not. In operation 2922, if the neighbor (e.g., the other addresses associated with user profiles 402 of FIG. 4) has not been encountered before then the neighbor may be added to the queue. In operation 2924, if the neighbor N has been encountered before it may be further determined whether the geographical location (e.g., the geographical location 1704 of FIG. 17A) from where the neighbor (e.g., the other addresses associated with user profiles 402 of FIG. 4) has encountered previously is the same place or closer to that place.

If it is determined that the neighbor (e.g., the other addresses associated with user profiles 402 of FIG. 4) has encountered at the same or closer place then the friend may be added to the queue. If it may be determined that friend is not encountered at the same place or closer to that place then it may be again checked that all the friends have processed. In operation 2926, if it is determined that the person P is user B than the connection may be added to the connection list and after adding the connection to connection list it follows the operation 2912. In operation 2928, if it may be determined that queue is empty then the operation may return the connections list.

For example, a first user ID with the verified registered user (e.g., the verified registered user 1810 of FIG. 18A-B, the verified registered user 1810 of FIG. 21) and a second user ID may be applied to the different registered user. The verified registered user (e.g., the verified registered user 1810 of FIG. 18A-B, the verified registered user 1810 of FIG. 21) with the different registered user may be connected with each other through at least one of a geo-positioning data associated with the first user ID and the second user ID. In addition, a maximum degree of separation (Nmax) of at least two that is allowed for connecting any two registered users, (e.g., the two registered users who may be directly connected may be deemed to be separated by one degree of separation and two registered users who may be connected through no less than one other registered user may be deemed to be separated by two degrees of separation and two registered users who may be connected through not less than N other registered users may be deemed to be separated by N+1 degrees of separation).

Furthermore, the user ID of the different registered user may be searched (e.g., the method limits the searching of the different registered user in the sets of user IDs that may be stored as registered users who are less than Nmax degrees of separation away from the verified registered user (e.g., the verified registered user 1810 of FIG. 18A-B, the verified registered user 1810 of FIG. 21), such that the verified registered user (e.g., the verified registered user 1810 of FIG. 18A-B, the verified registered user 1810 of FIG. 21) and the different registered user who may be separated by more than Nmax degrees of separation are not found and connected.) in a set of user IDs that may be stored of registered users who are less than Nmax degrees of separation away from the verified registered user (e.g., the verified registered user 1810 of FIG. 18A-B, the verified registered user 1810 of FIG. 21), and not in the sets of user IDs that may be stored for registered users who are greater than or equal to Nmax degrees of separation away from the verified registered user (e.g., the verified registered user 1810 of FIG. 18A-B, the verified registered user 1810 of FIG. 21), until the user ID of the different registered user may be found in one of the searched sets. Also, the verified registered user (e.g., the verified registered user 1810 of FIG. 18A-B, the verified registered user 1810 of FIG. 21) may be connected to the different registered user if the user ID of the different registered user may be found in one of the searched sets.

Moreover, the sets of user IDs that may be stored of registered users may be searched initially who are directly connected to the verified registered user (e.g., the verified registered user 1810 of FIG. 18A-B, the verified registered user 1810 of FIG. 21). A profile of the different registered user may be communicated to the verified registered user (e.g., the verified registered user 1810 of FIG. 18A-B, the verified registered user 1810 of FIG. 21) to display through a marker associating the verified registered user (e.g., the verified registered user 1810 of FIG. 18A-B, the verified registered user 1810 of FIG. 21) with the different registered user. A connection path between the verified registered user (e.g., the verified registered user 1810 of FIG. 18A-B, the verified registered user 1810 of FIG. 21) and the different registered user, the connection path indicating at least one other registered user may be stored through whom the connection path between the verified registered user (e.g., the verified registered user 1810 of FIG. 18A-B, the verified registered user 1810 of FIG. 21) and the different registered user is made.

In addition, the connection path between the verified registered user (e.g., the verified registered user 1810 of FIG. 18A-B, the verified registered user 1810 of FIG. 21) and the different registered user may be communicated to the verified registered user to display. A hyperlink in the connection path of each of the at least one registered users may be embedded through whom the connection path between the verified registered user (e.g., the verified registered user 1810 of FIG. 18A-B, the verified registered user 1810 of FIG. 21) and the different registered user is made.

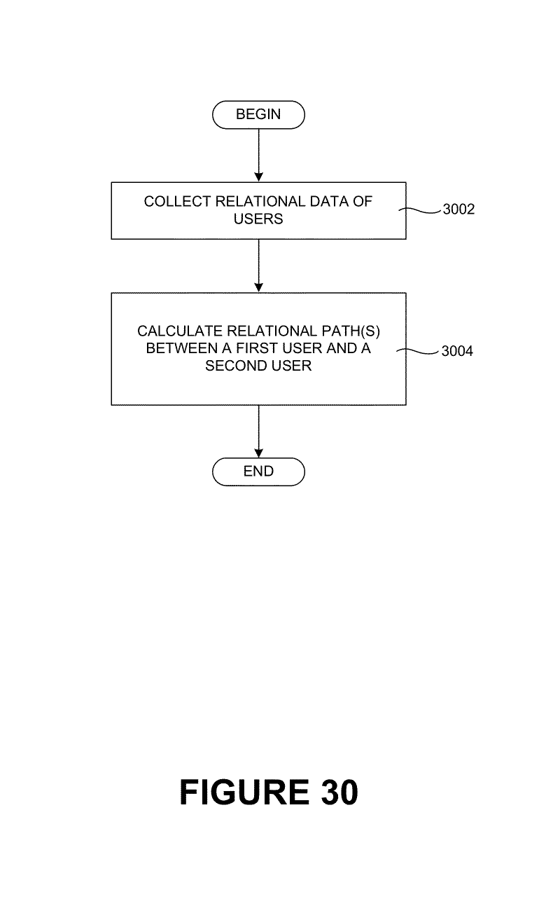

FIG. 30 is a flowchart of communicating brief profiles of the registered users, processing a hyperlink selection from the verified registered user (e.g., the verified registered user 1810 of FIG. 18A-B, the verified registered user 1810 of FIG. 21) and calculating and ensuring the Nmax degree of separation of the registered users away from verified registered users (e.g., the verified registered user 1810 of FIG. 18A-B, the verified registered user 1810 of FIG. 21), according to one embodiment. In operation 3002, the data of the registered users may be collected from the database. In operation 3004, the relational path between the first user and the second user may be calculated (e.g., the Nmax degree of separation between verified registered user (e.g., the verified registered user 1810 of FIG. 18A-B, the verified registered user 1810 of FIG. 21) and the registered user).

For example, the brief profiles of registered users, including a brief profile of the different registered user, to the verified registered user (e.g., the verified registered user 1810 of FIG. 18A-B, the verified registered user 1810 of FIG. 21) for display, each of the brief profiles including a hyperlink to a corresponding full profile may be communicated.

Furthermore, the hyperlink selection from the verified registered user (e.g., the verified registered user 1810 of FIG. 18A-B, the verified registered user 1810 of FIG. 21) may be processed (e.g., upon processing the hyperlink selection of the full profile of the different registered user, the full profile of the different registered user may be communicated to the verified registered user (e.g., the verified registered user 1810 of FIG. 18A-B, the verified registered user 1810 of FIG. 21) for display). In addition, the brief profiles of those registered users may be ensured who are more than Nmax degrees of separation away from the verified registered user (e.g., the verified registered user 1810 of FIG. 18A-B, the verified registered user 1810 of FIG. 21) are not communicated to the verified registered user (e.g., the verified registered user 1810 of FIG. 18A-B, the verified registered user 1810 of FIG. 21) for display.

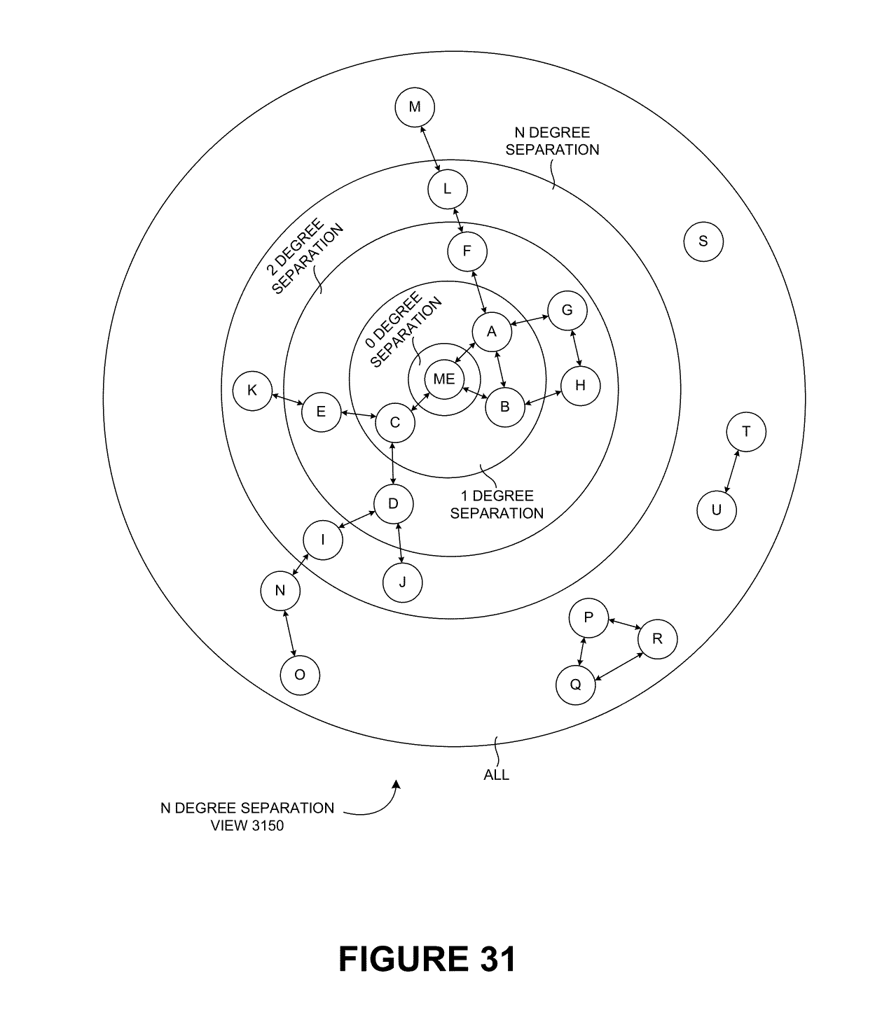

FIG. 31 is an N degree separation view 3150, according to one embodiment. ME may be a verified registered user (e.g., the verified registered user 1810 of FIG. 18A-B, the verified registered user 1810 of FIG. 21) of the global neighborhood environment 2300 (e.g., the geospatially constrained social network 142 of FIG. 1) centered in the neighborhood network. A, B, C, D, E, F, G, H, I, J, K, L, M, N, O, P, Q, R, S, T, and/or U may be the other registered user of the neighborhood network. The member of the neighborhood network may be separated from the centered verified registered user (e.g., the verified registered user 1810 of FIG. 18A-B, the verified registered user 1810 of FIG. 21) ME of the neighborhood network by certain degree of separation. The registered user A, B and C may be directly connected and may be deemed to be separated by one degree of separation from verified registered user (e.g., the verified registered user 1810 of FIG. 18A-B, the verified registered user 1810 of FIG. 21) ME. The registered user D, E, F, G, and H may be connected through no less than one other registered user may be deemed to be separated by two degree of separation from verified registered user (e.g., the verified registered user 1810 of FIG. 18A-B, the verified registered user 1810 of FIG. 21) ME. The registered user I, J, K, and L may be connected through no less than N−1 other registered user and may be deemed to be separated by N degree of separation from verified registered user (e.g., the verified registered user 1810 of FIG. 18A-B, the verified registered user 1810 of FIG. 21) ME. The registered user M, N, O, P, Q, R S, T and U may be all registered user.

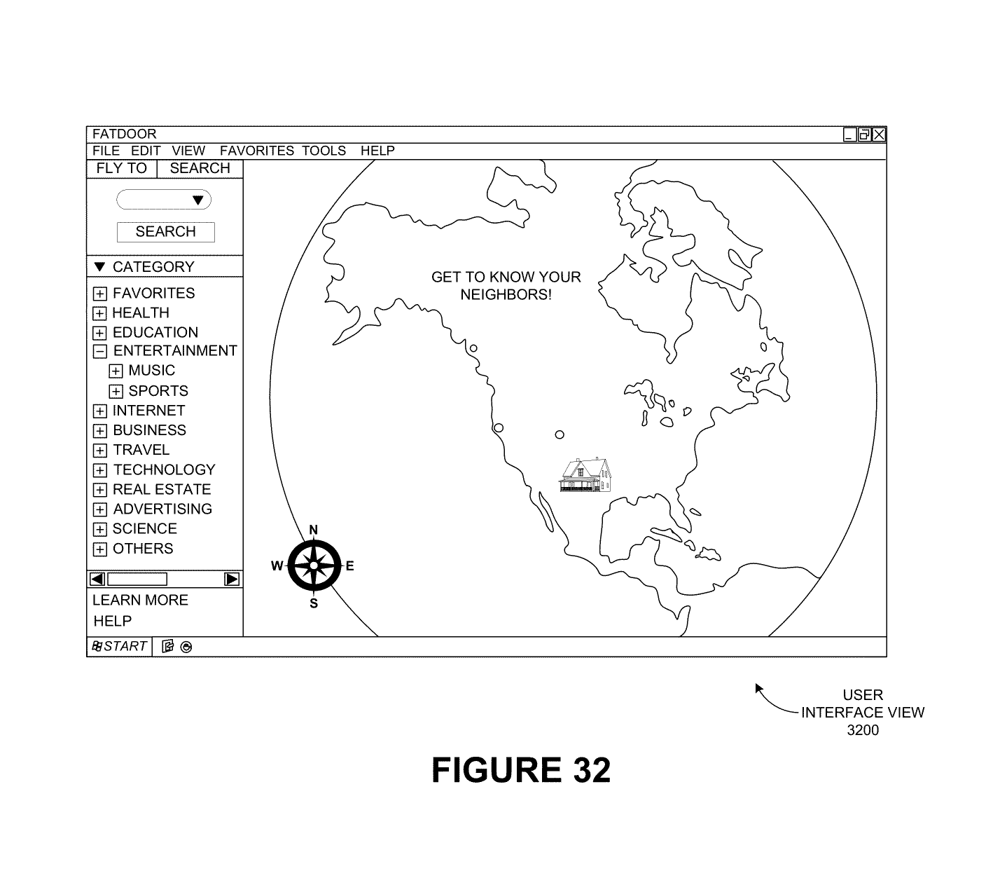

FIG. 32 is a user interface view 3200 showing a map, according to one embodiment. Particularly FIG. 32 illustrates a satellite photo of a physical world. The registered user of the global neighborhood environment 2300 (e.g., the geo spatially constrained social network 142 of FIG. 1) may use this for exploring the geographical location (e.g., the geographical location 1704 of FIG. 17A) of the neighbors (e.g., the other addresses associated with user profiles 402 of FIG. 4). The registered user (e.g., the verified registered user 1810 of FIG. 18A-B, the verified registered user 1810 of FIG. 21) may navigate, zoom, explore and quickly find particular desired geographical locations of the desired neighbors (e.g., the other addresses associated with user profiles 402 of FIG. 4). This may help the registered user to read the map an/or plot the route of the neighbors (e.g., the other addresses associated with user profiles 402 of FIG. 4) on the world map.

FIG. 33 is a user interface view 3350 displaying purchase options associated with Christmas decorations, according to one embodiment. Particularly, FIG. 33 illustrates a selection block 3300, an occasion selection 3301, a set of decoration options 3302, a residence representation 3303, a set of decoration representations 3304 A-N, a residence geo-spatial map 3306, a display customizer 3308, and an order view 3310, according to one embodiment.

The order view 3310 may enable the user 106 of the geospatially constrained social network 142 to purchase Christmas decorations from the decoration options 3302. For example, the Christmas decorations may include candy canes, Christmas trees, elves, Santa, reindeer, snowmen, wreaths, Christmas lights, etc. The selection block 3300 may enable the user 106 to select the number of Christmas decorations that the user 106 wishes to purchase, according to one embodiment.

In the example embodiment illustrated in FIG. 33, the user interface view 3350 displays purchase options associated with Christmas decoration. The user 106 may select desired number of ‘Candy Canes’, ‘Elves’, ‘Reindeer’, and/or ‘lights’ through the selection block 3300 (e.g., using a drop down option, entering a quantity, etc.), according to one embodiment. The user 106 may also be able to drag and drop decorations from the decoration options 3302 onto the residence geospatial map 3306. The user may be able to move, reorient, etc. the decoration representations 3304 A-N using the display customizer 3308. The user 106 may also make a purchase of the selected number of Christmas decorations through the order view 3310.

For example, the decoration options associated with the occasion may also be displayed to the user 106 and a purchase selection of the decoration options may be obtained from the user 106 (e.g., through the order view 3310).

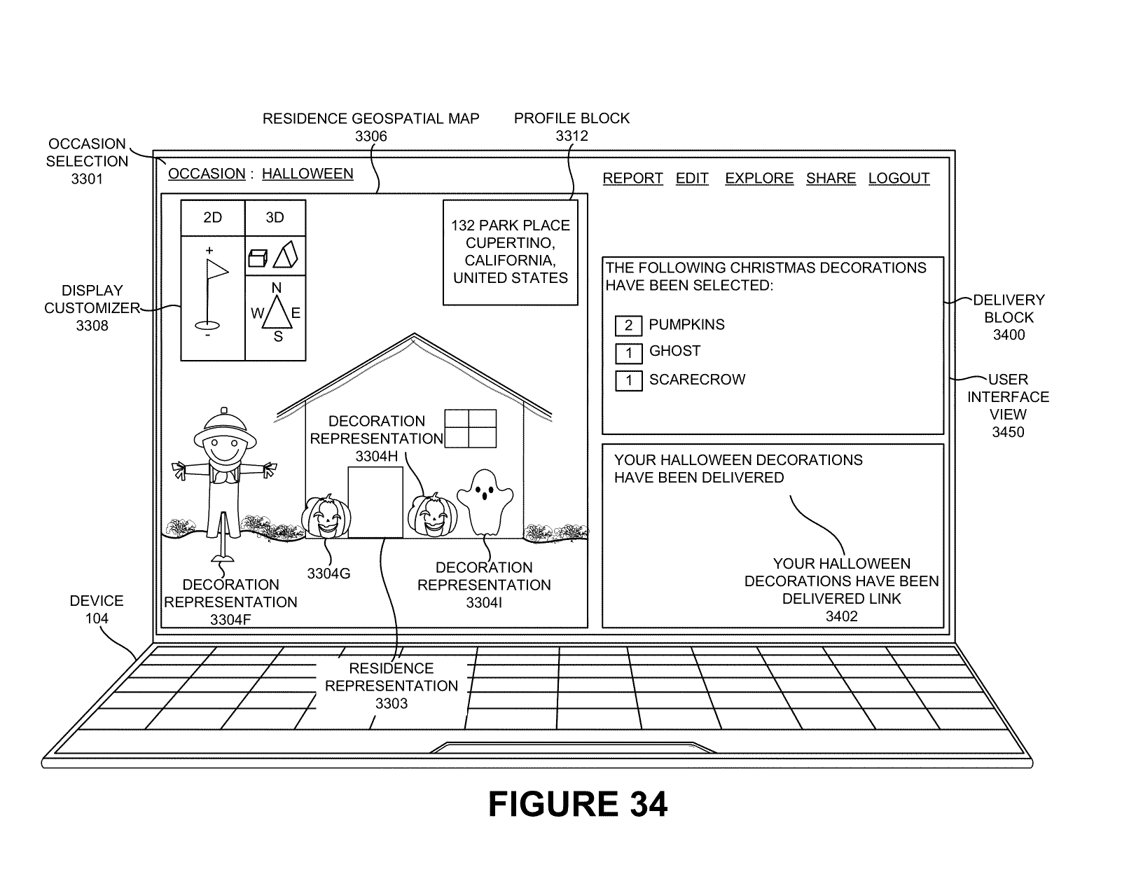

FIG. 34 is a user interface view 3450 displaying decoration representations associated with an occasion (e.g., Halloween) along with the residence representation 3303 on the residence geospatial map 3306, according to one embodiment. Particularly, FIG. 34 illustrates the occasion selection 3301, the residence geospatial map 3306, a delivery block 3400, a your Halloween decorations have been delivered link 3402, the residence representation 3303, the set of decoration representations 3304 A-N and a profile block 3312, according to one embodiment.

The delivery block 3400 may display delivery status of the decorations purchased by a user 106 of the geospatially constrained social network 142. For example, the delivery status may include the number of the decorations delivered to the user 106. The decoration representations 3304 A-N may be representations of the purchased decorations displayed in conjunction with the residence representation 3303 on the residence geospatial map 3306. The your Halloween decorations have been delivered link 3402 may enable the user 106 to view delivery details associated with the purchase of decorations. For example, the delivery details may include a location and/or an address of the user 106, number of decorations, date of delivery, transaction details (e.g., may include financial transactions, physical transactions, etc.) associated with the decorations.

In the example embodiment illustrated in FIG. 34, the user interface view 3450 displays the decoration representations 3304 A-N (e.g., associated with the decorations delivered to the user 106) along with a residence representation 3303. The delivery block 3400 displays delivered decorations as ‘Pumpkins—2 numbers', ‘Ghost—1 number’ and ‘Scarecrow—1number’ associated with Halloween celebration. For example, the decorations may be delivered through a postal service, a delivery service, and/or a courier service, etc. The decoration representations A-N associated with the decoration options may be displayed at a location on the residence geospatial map 3306. In one embodiment, the decorations may be set up as specified by the user (e.g., according to the placement and/or orientation of the decoration representations 3304 A-N on the residence geospatial map 3306) upon delivery. This service may be provided for an additional cost.

In one example embodiment, a decoration associated with the occasion may be purchased. The decoration representations 3304 A-N associated with the decoration may be viewed at a location on the residence geospatial map 3306 and a delivery of the decoration may be received by the user 106. In another example embodiment, a decoration associated with the decoration options may be delivered through a postal service, a courier service and/or a delivery service, etc. to the user 106.

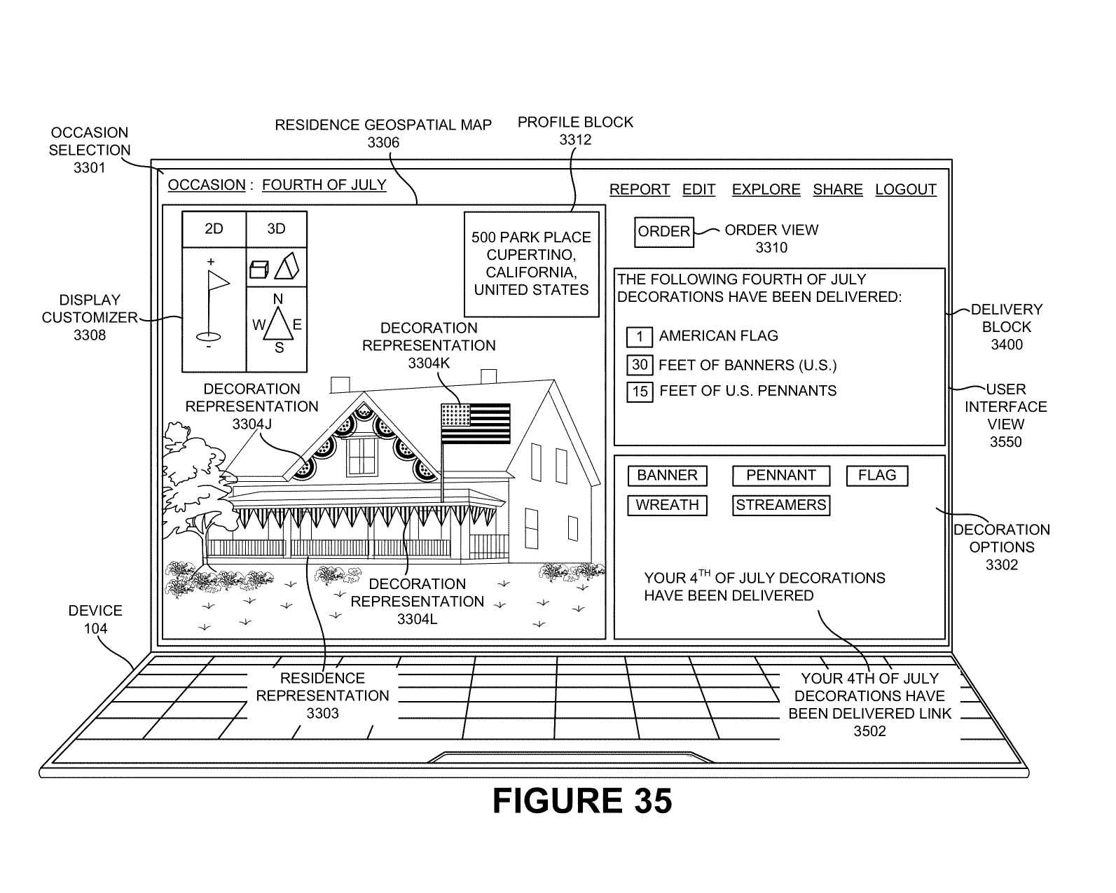

FIG. 35 is a user interface view 3550 displaying decoration representations associated with an occasion (e.g., Fourth of July) along with the residence representation 3303 on the residence geospatial map 3306, according to one embodiment. Particularly, FIG. 35 illustrates the occasion selection 3301, the residence geospatial map 3306, the display customization 3308, a delivery block 3400, a your Fourth of July decorations have been delivered link 3502, the residence representation 3303, the set of decoration representations 3304 A-N and the profile block 3312, according to one embodiment.

The delivery block 3400 may display delivery status of the decorations purchased by a user 106 of the geospatially constrained social network 142. For example, the delivery status may include the number of the decorations delivered to the user 106. The decoration representations 3304 A-N may be representations of the purchased decorations displayed in conjunction with the residence representation 3303 on the residence geospatial map 3306. The your Fourth of July decorations have been delivered link 3502 may enable the user 106 to view delivery details associated with the purchase of decorations. For example, the delivery details may include a location and/or an address of the user 106, number of decorations, date of delivery, transaction details (e.g., may include financial transactions, physical transactions, etc.) associated with the decorations.

In the example embodiment illustrated in FIG. 35, the user interface view 3550 displays the decoration representations 3304 A-N (e.g., associated with the decorations delivered to the user 106) along with a residence representation 3303. In one embodiment, the residence representation 3303 may be an image of the actual residence, a cartoon representation, an image of a similar residence etc. The delivery block 3400 displays delivered decorations as ‘American Flag—1 number’, ‘U.S. Banner—30 feet’ and ‘Pennants—15 feet’ associated with Fourth of July celebration, according to the example embodiment. For example, the decorations may be delivered through a postal service, a delivery service, and/or a courier service, etc. The decoration representations 3304 A-N associated with the decoration options may be displayed at a location on the residence geospatial map 3306. In one embodiment, the decorations may be set up as specified by the user (e.g., according to the placement and/or orientation of the decoration representations 3304 A-N on the residence geospatial map 3306) upon delivery for an additional cost. The user 106 may be able to select and/or purchase additional decorations and/or alter the location, orientation, etc. of decoration representations (e.g., using the display customizer 3308) associated with the occasion upon delivery using the decoration options 3302, according to one embodiment.

In one example embodiment, a decoration associated with the occasion may be purchased. The decoration representations 3304 A-N associated with the decoration may be viewed at a location on the residence geospatial map 3306 and a delivery of the decoration may be received by the user 106. In another example embodiment, a decoration associated with the decoration options may be delivered through a postal service, a courier service and/or a delivery service, etc. to the user 106.

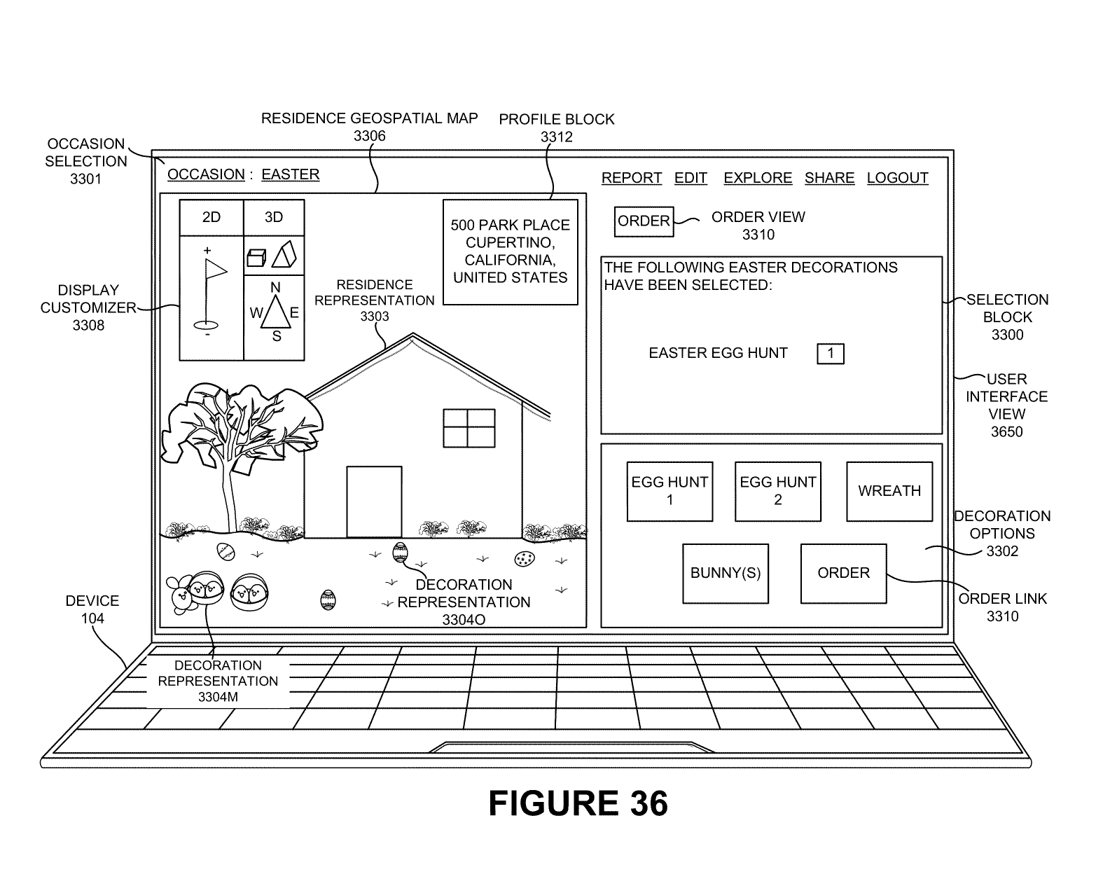

FIG. 36 is a user interface view 3650 displaying purchase options associated with Easter decorations, according to one embodiment. Particularly, FIG. 15 illustrates the selection block 3300, the occasion selection 3301, the set of decoration options 3302, the residence representation 3303, the set of decoration representations 3304 A-N, the residence geospatial map 3306, the display customizer 3308, the profile block 3312, and the order view 3310, according to one embodiment.

The order view 3310 may enable the user 106 of the geospatially constrained social network 142 to purchase Easter decorations from the decoration options 3302. For example, the Easter decorations may include an Egg Hunt Package, wreaths, bunny decorations, etc. The selection block 3300 may enable the user 106 to select the number of Easter decorations that the user 106 wishes to purchase.

In the example embodiment illustrated in FIG. 36, the user interface view 3350 displays purchase options associated with Easter decoration. The user 106 may select desired number of ‘wreaths’, ‘bunny decorations’, and/or type of ‘Egg Hunt’ through the selection block 3300 (e.g., using a drop down option, entering a quantity, etc.), according to one embodiment. The user 106 may be presented with multiple egg hunt packages to select from. These packages may vary in price, number of eggs, contents of plastic eggs, different types of items (e.g., stuffed animals, candy, etc.) to be hidden, number and/or type of baskets, etc. The user may be able to request the items be hidden for the user upon delivery (according to locations specified by the user 106 (e.g., the locations of eggs placed on the residence geo-spatial map 3306)), for an additional charge, according to one embodiment. The user 106 may also be able to drag and drop decorations from the decoration options 3302 onto the residence geospatial map 3306. The user may be able to move, reorient, etc. the decoration representations 1204 3304 A-N using the display customizer 3308. The user 106 may also make a purchase of the selected number of Easter decorations through the order view 3310.

For example, the decoration options associated with the occasion may also be displayed to the user 106 and a purchase selection of the decoration options may be obtained from the user 106 (e.g., through the order view 3310).

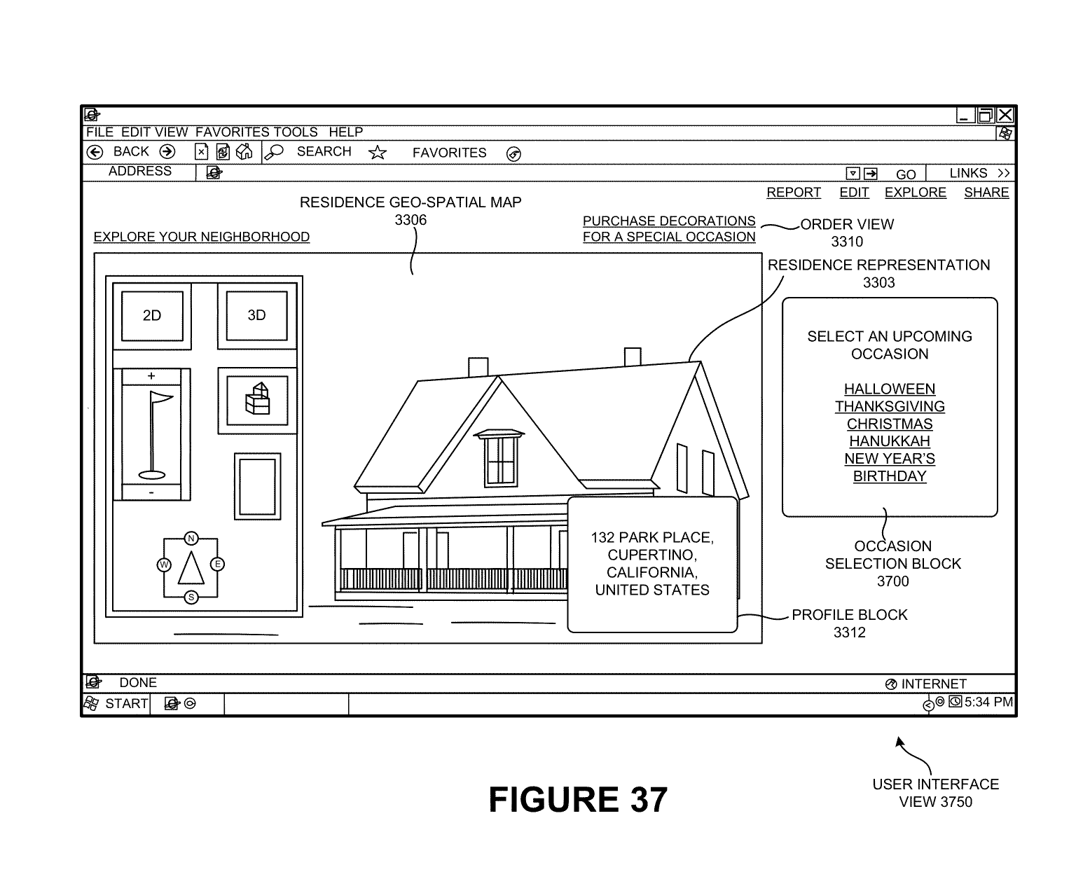

FIG. 37 is a user interface view 3750 of selecting an occasion, according to one embodiment. Particularly, FIG. 16 illustrates an occasion selection block 3700, a residence geo-spatial map 3306, the claimed geospatial locations 700, the residence representation 3303 and the order view 3310, according to one embodiment.

The residence geo-spatial map 3306 may display decoration representations in conjunction with the residence representation 3303 at a location associated with the user 106 (e.g., the verified user 706). For example, the location may be obtained based on the user data associated with the users 106. The profile block 3312 may display profile details associated with the residence representation 3303 on the residence geo-spatial map 3306. For example, the profile details may include name address data, location data (e.g., the claimed geospatial locations 700), etc. of residents associated with the residence representation 3303. The occasion selection block 3700 may enable the user 106 of the geospatially constrained social network 142 to select a desired occasion (e.g., a national holiday, a cultural holiday, a religious holiday, a secular holiday, and/or a celebration, etc). For example, the occasion may be selected to purchase decorations associated with the occasion.

The order view 3310 may enable the user 106 to buy decorations for an upcoming occasion (e.g., displayed in the occasion selection block 3700). The residence representation 3303 may be a representation of a physical structure associated with a user 106 on the residence geo-spatial map 3306. For example, the residence representation 3303 may be an image (e.g., an actual photographic image of the structure, a representation, a cartoon, etc.) of the physical structure displayed in conjunction with the decorations purchased by the user 106 of the geospatially constrained social network 142.

In the example embodiment illustrated in FIG. 37, the user interface view 3750 displays the residence representation 3303. The occasion selection block 3700 displays a list of occasions as ‘Halloween’, ‘Thanksgiving’, ‘Christmas’, ‘Hanukkah’, ‘New Year’, ‘birthday’. Residents (e.g., the verified user 706) associated with the residence representation 3303 may select a desired occasion (e.g., a national holiday, a cultural holiday, a religious holiday, a secular holiday, an event, and/or a celebration, etc.) through the occasion selection block 3700. The residents may make a purchase of decorations associated with the selected occasion using the order view 3310.

For example, a location may be selected. The residence representation 3303 (e.g., an image of a residence) may be selected and viewed at the location on the residence geo-spatial map 3306. A selection of an occasion may be obtained (e.g., using the occasion selection block 3700) from the user 106. Further, a walking map associated with the occasion containing the location may be received (e.g., by the user 106).

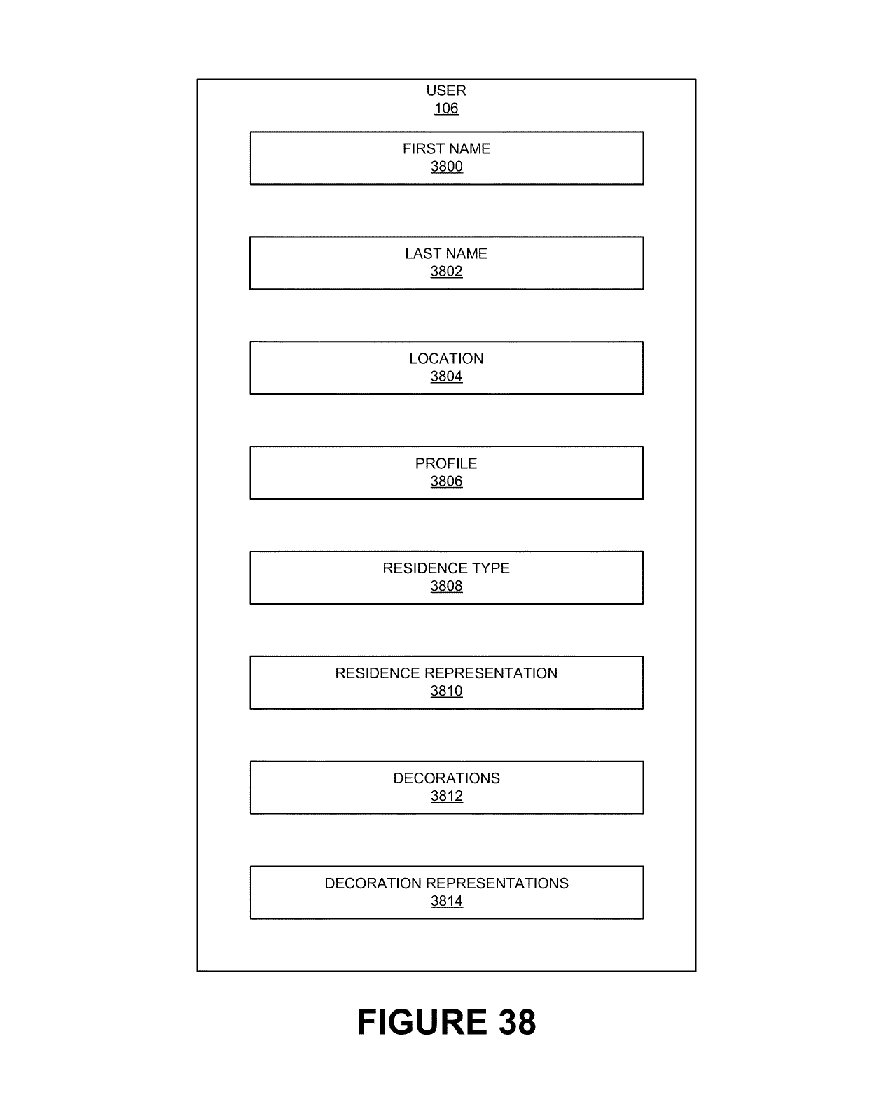

FIG. 38 is a block diagram representation displaying information associated with a user 106, according to one embodiment. In one example embodiment, information is associated with each user 106 of the geospatially constrained social network 142. Particularly, FIG. 38 illustrates the user 106, a first name block 3800, a last name block 3802, a location block 3804, a profile block 3806, a residence type block 3808, a residence representation block 3810, a decorations block 3812 and a decoration representations block 3814, according to one embodiment.

The user 106 may be an individual in the geospatially constrained social network 142. The first name block 3800 may display first name associated with the user 106. The last name block 3802 may display last name associated with the user 106. The location block 3804 may display address data associated with the user 106 (e.g., information regarding the user's 106 claimed geospatial locations 700). The location block 3804 may also be associated with a latitude, a longitude and an altitude. The profile block 3806 may display profile details associated with the user 106. For example, the profile details may include age, gender, profession, hobbies, and/or other personal information.

The residence type block 3808 may display type of residence associated with the user 106 of the geospatially constrained social network 142. For example, the types of residences associated with the user 106 may include a bungalow, a mansion, an apartment, a flat, a colonial house, and/or a cottage, etc. The residence representation block 3810 may display various representations of residences associated with the user 106. For example, the residence representation may be an image, a picture, an illustration, a reflection, etc. of a residence displayed on the residence geo-spatial map 3304.

The decorations block 3810 may display decorations associated with occasions (e.g., the decoration options 3302). For example, decorations associated with Christmas may include Christmas tree, garlands, and/or Christmas star, etc. and decorations associated with Halloween may include pumpkin carvings, turnip carvings, and/or ghosts, etc. The decoration representations block 3814 may display various representations of decorations associated with the occasions. For example, the decoration representations 3302 may include a depiction, an illustration, and/or an icon, etc.

In the example embodiment illustrated in FIG. 38, the block diagram represents various details (e.g., address data, content data, residence representations, decorations, decoration representations, and/or types of residences, etc.) associated with the user 106. Other users 106 may search for the user 106 based on the first name, the last name, the location, the profile, the type of residence, the residence representation, the decoration representations, etc. associated with the user 106.

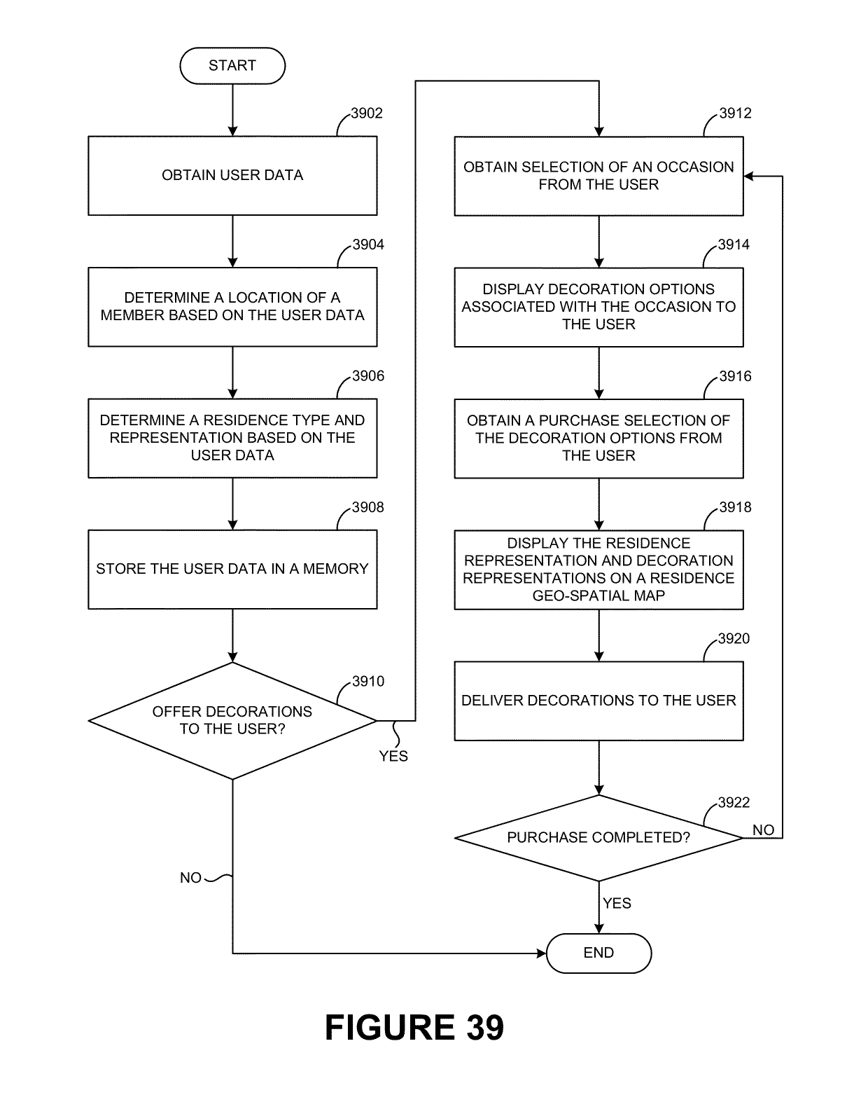

FIG. 39 is a flowchart of delivering decorations associated with an occasion based on a purchase, according to one embodiment. In operation 3902, user data associated with a user 106 is obtained. For example, the user data may include age, gender, profession, and/or address data, etc. In operation 3904, a location of the user 106 is determined based on the user data (e.g., the claimed geospatial locations 700). For example, the location may be identified on a residence geo-spatial map 3306 using the user data (e.g., may include address data).

In operation 3906, a residence type and representation is determined based on the user data. In one example embodiment, the residence type may include a bungalow, a mansion, an apartment, a flat, a colonial house, and/or a cottage, etc. The residence representation may be an image of a residence, business, and/or civic structure etc. In operation 3908, the user data is stored in a database (e.g., the geospatial database 122). For example, the location of the user 106 may be determined based on the user data stored in the database.

In operation 3910, a determination is made whether to offer decorations to the user 106. If the decorations are not to be offered to the user 106, the process of making a purchase may terminate. In operation 3912, a selection of the occasion is obtained from the user 106 (e.g., using the occasion selection block 3700). For example, selection of the occasion obtained from the user 106 may include a national holiday, a secular holiday, a cultural holiday, a religious holiday, an event, and/or a celebration, etc.

In operation 3914, decoration options associated with the occasion are displayed (e.g., as illustrated in decorations options 3302 of FIG. 33) to the user 106. In one example embodiment, the decoration options may include type of decorations (e.g., pumpkins, scarecrows, broomsticks, etc. for Halloween celebrations) associated with a particular occasion (e.g., selected by the user 106). In operation 3916, a purchase selection of the decoration options is obtained from the user 106.

The purchase selection may include specifying a number of decorations to be displayed. In operation 3918, the residence representation (e.g., may include an image of a residence) and decoration representations (e.g., may include image of pumpkins, broomsticks, and/or scarecrows, etc.) are displayed on the residence geo-spatial map 3306. In operation 3920, the decorations are delivered to the user 106. In operation 3922, the user may be asked if the purchase is complete. If so, the process may end. If the user is not finished, the user may be permitted to make additional selections of occasions, according to one embodiment.

The decorations (e.g., purchased by the user 106) may be delivered through a postal service, courier service, and/or delivery service, etc. In operation 3922, a condition is checked whether the purchase associated with the user is completed or not. In one example embodiment, if the purchase is completed, the process may be terminated, else the process of obtaining a selection of an occasion from the user (e.g., as illustrated in operation 3912) may be performed.

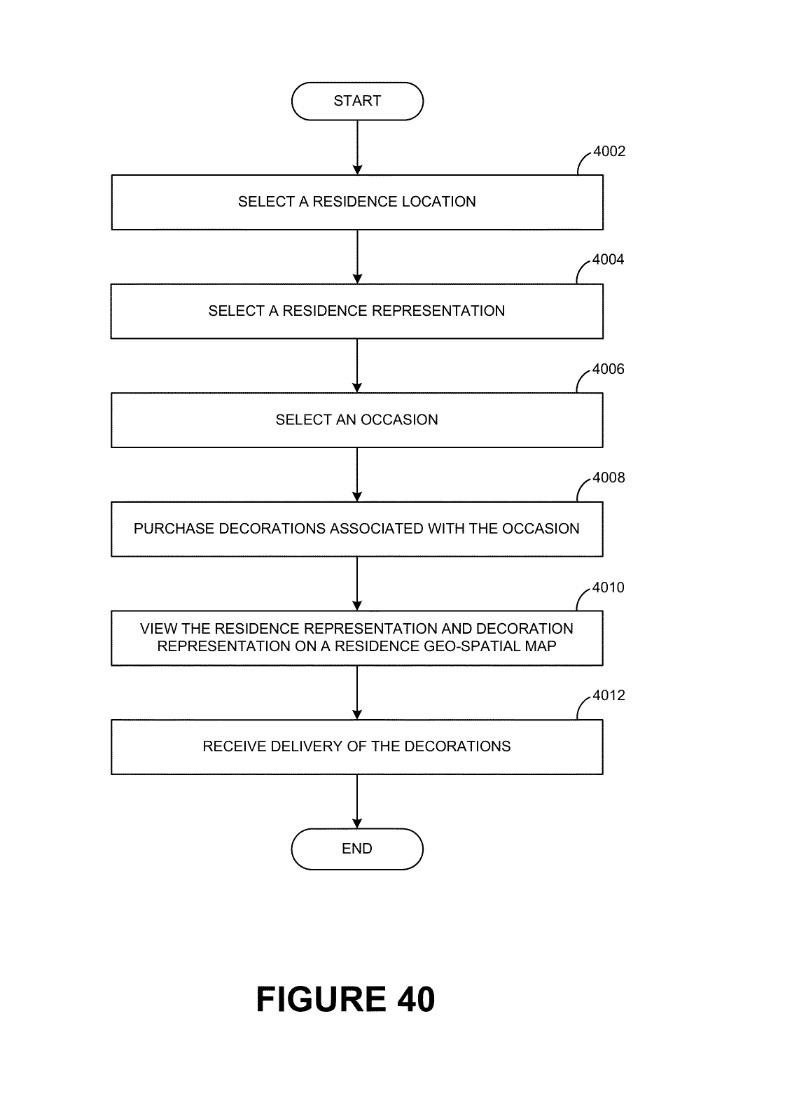

FIG. 40 is a flowchart of receiving delivery of decorations associated with an occasion, according to one embodiment. In operation 4002, a location is selected. For example, the location may be a geographical area (e.g., associated with the user 106) displayed on the residence geo-spatial map 3306. In operation 4004, a residence representation (e.g., the residence representation 3303 of FIG. 33) is selected. For example, the residence representation 3303 may be an image of a residence, business, and/or civic structure, etc.

In operation 4006, the occasion is selected (e.g., using the occasion selection block 3700). For example, the occasion may include Halloween, Thanksgiving, Christmas, Hanukkah, New Year, birthday, Fourth of July, Easter etc. In operation 4008, the decorations associated with the occasion are purchased (e.g., by clicking on the order view 3310 of FIG. 33). For example, decorations associated with Christmas may include Christmas tree, garlands, Christmas star, etc. and decorations associated with Halloween may include pumpkin carvings, turnip carvings, ghosts, etc.

In operation 4010, the residence representation and decoration representations are viewed on the residence geo-spatial map 3306. For example, decoration representations (e.g., of the purchased decorations) may be displayed in conjunction with the residence representation 3303 on the residence geo-spatial map 3306 (e.g., as illustrated in FIG. 33). In operation 4012, delivery of decorations is received. For example, the delivery may be received through a postal service, delivery service, and/or courier service, etc.

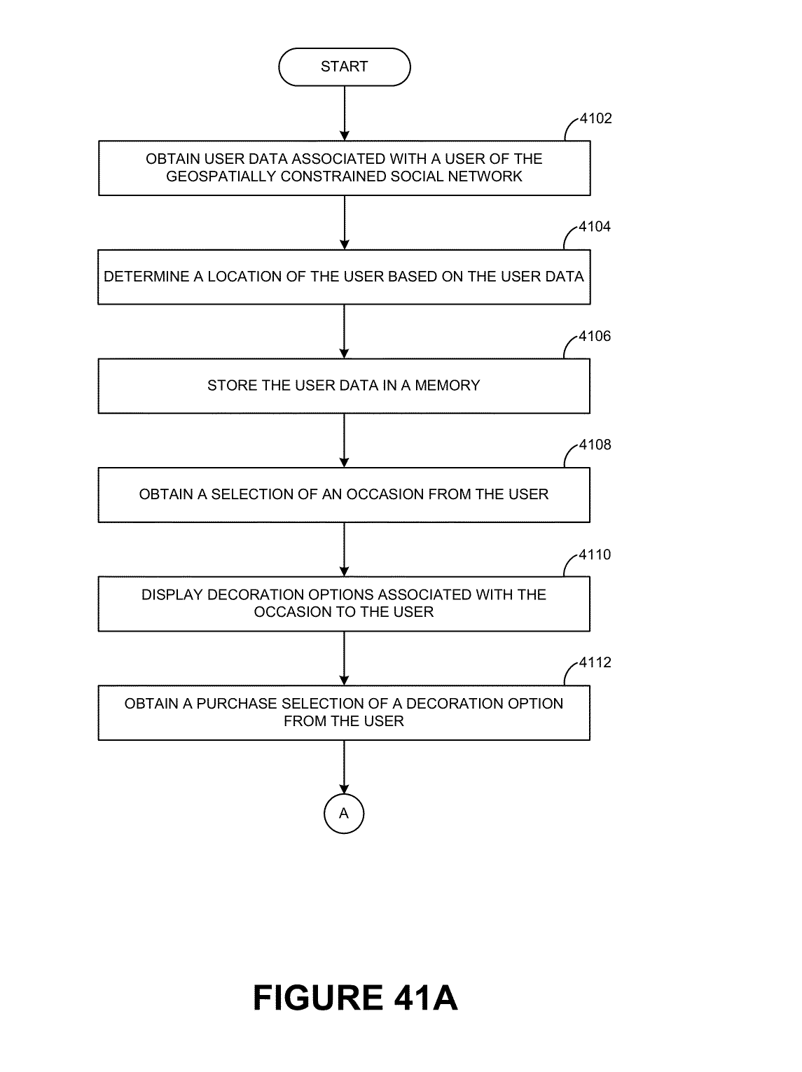

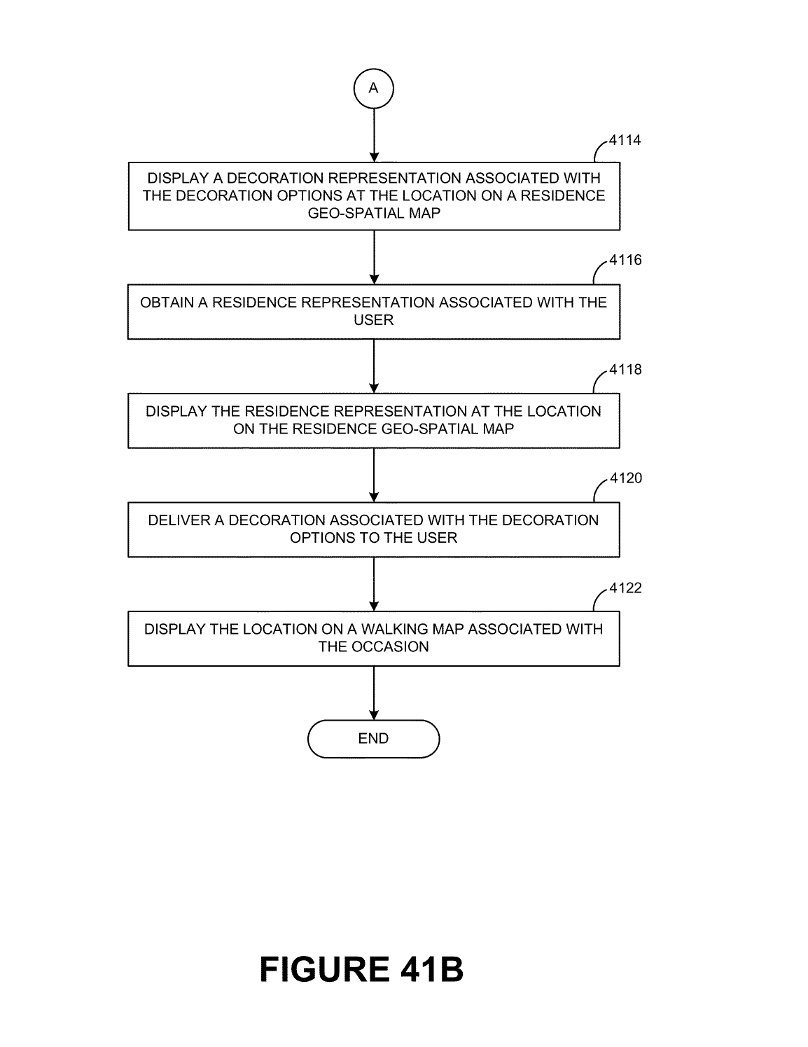

FIG. 41A is a process flow of displaying decoration representations on a residence geo-spatial map (e.g., the residence geo-spatial map 3306 of FIG. 33), according to one embodiment. In operation 4102, user data associated with a user (e.g., the user 106 of FIG. 1) of a community network (e.g., the geospatially constrained social network 142 of FIG. 1) may be obtained. In operation 4104, a location (e.g., may include a latitude, a longitude, and/or an altitude, etc.) of the user 106 may be determined (e.g., based on the user data). In operation 4106, the user data may be stored in a database (e.g., the geospatial database 122).

In operation 4108, a selection of an occasion may be obtained (e.g., through the occasion selection block 3700 of FIG. 37) from the user 106. In operation 4110, decoration options 3302 associated with the occasion may be displayed to the user 106. In operation 4112, a purchase selection of a decoration option may be obtained (e.g., through a click of the order view 3310) from the user 106.

FIG. 41B is a continuation of the process flow of FIG. 41A, showing additional processes, according to one embodiment. In operation 4114, the decoration representation (e.g., the decoration representations 3304 A-N of FIGS. 33-36) associated with the decoration options may be displayed at the location (e.g., selected by the user 106) on the residence geo-spatial map 3306. In operation 4116, a residence representation (e.g., the residence representation 3303 of FIG. 33) associated with the user 106 may be obtained.

In operation 4118, the residence representation 3303 may be displayed at the location (e.g., associated with the user 106) on the residence geo-spatial map 3306. In operation 4120, a decoration associated with the decoration options may be delivered (e.g., through postal service, courier service, and/or delivery service, etc.) to the user 106. In operation 4122, the location (e.g., associated with the occasion) may be displayed on a walking map associated with the occasion. For example, a walking map may be a geo-spatial map with routes that allow user 106 to explore neighborhoods and/or larger areas by navigating. The walking map may also display the decoration representations 3304 A-N simultaneously with the residence representation 3303 associated with the occasion (e.g., Halloween, Christmas, Thanksgiving, and/or New Year, etc.).

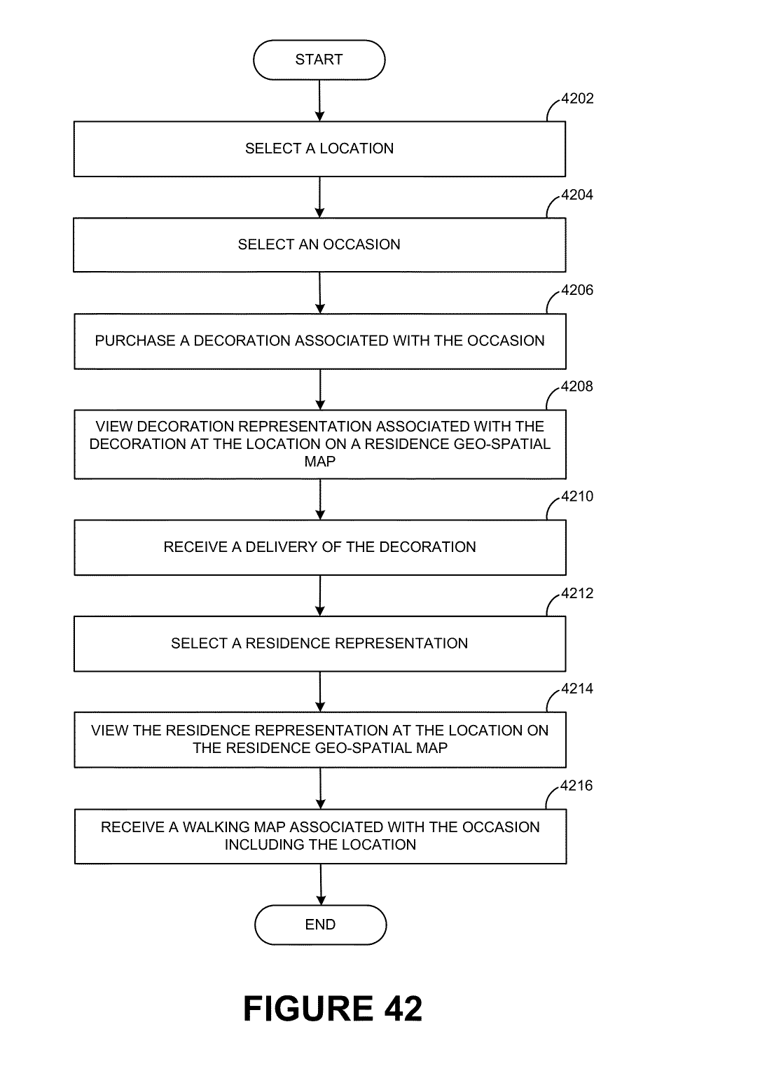

FIG. 42 is a process flow of making a purchase of decorations associated with an occasion, according to one embodiment. In operation 4202, a location may be selected (e.g., using the geo-spatial database 122 of FIG. 1). In operation 4204, the occasion (e.g., Halloween, Thanksgiving, Christmas, Hanukkah, New Year, and/or birthday, etc.) may be selected.

In operation 4206, a decoration associated with the occasion may be purchased. For example, the decoration for Halloween may include pumpkins, ghosts, scarecrows, etc. In operation 4208, a decoration representation (e.g., the decoration representations 3304 A-N of FIGS. 33-36) associated with the decoration may be viewed at the location on a geo-spatial map (e.g., the residence geo-spatial map 3306 of FIG. 33). In operation 4210, a delivery of the decoration may be received (e.g., through postal service, delivery service, courier service, etc.).

In operation 4212, a residence representation (e.g., an image of a residence, business, and/or civic structure, etc.) may be selected. In operation 4214, the residence representation 3303 may be viewed at the location on the residence geo-spatial map 3306 (e.g., along with decoration representations). In operation 4216, a walking map associated with the occasion including the location may be received. For example, the walking map received by the user may also display the decoration representations 3304 A-N simultaneously with the residence representation 3303 associated with the occasion.

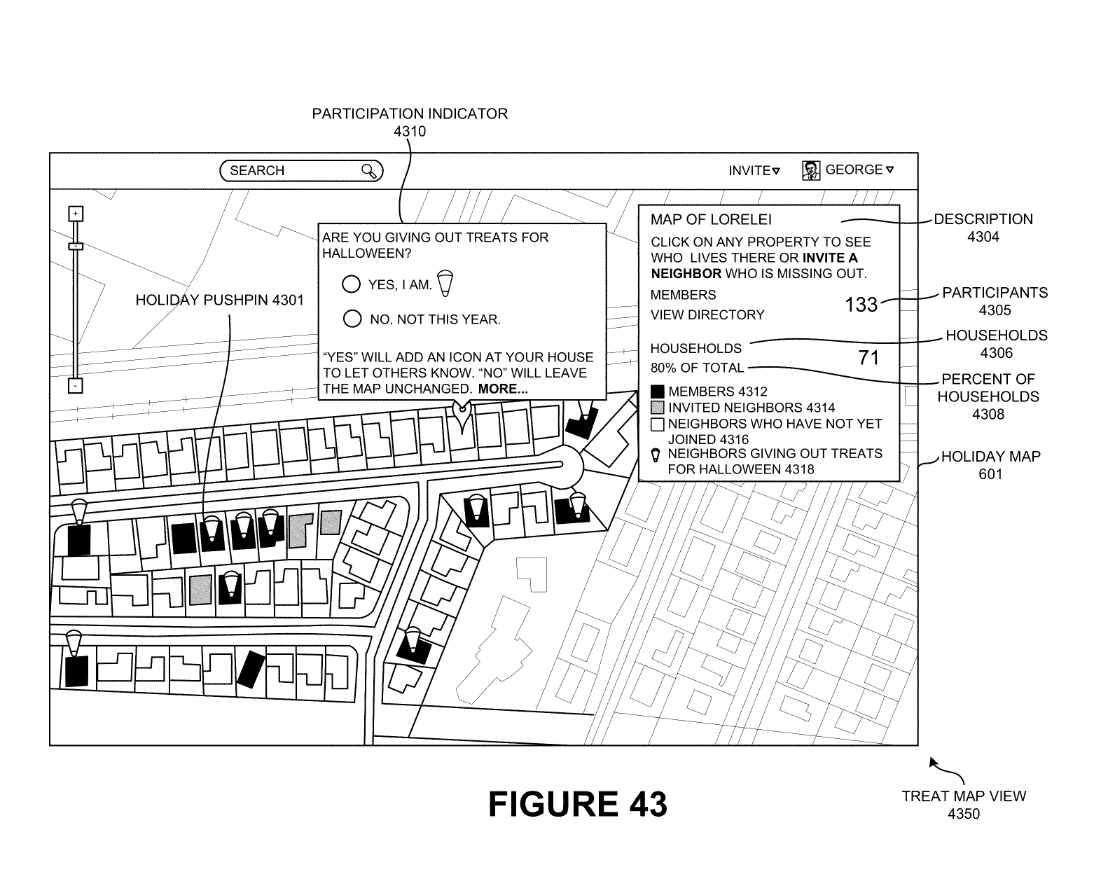

FIG. 43 is a treat map view 4350 of a holiday map, according to one embodiment. FIG. 43 shows a holiday map 601, a description 4304, a set of participants 4305, a set of households 4306, a percent of households 4308, a participation indicator 4310, a members 4312, an invited neighbors 4314, a neighbors who have not yet joined 4316, and a neighbors giving out treats for Halloween 4318. The holiday map 601 may be a geospatial map of the neighborhood in which the verified user has a claimed geospatial location. The description 4304 may be a description of the holiday, activity and/or neighborhood. The participants 4305 may be the number of users in the neighborhood that have claimed their geospatial location in the neighborhood. The households 4306 may be the number of households (e.g., claimed geospatial locations) that have indicated participation via the participation indicator 4310.

In one embodiment, the percent of households 4308 may be the percentage of total houses in the neighborhood that have indicated participation via the participation indicator 4310. The participation indicator 4310 may allow the verified user to declare whether or not they will be participating in the holiday activity (e.g., giving out candy on Halloween). According to one embodiment, the verified user may indicate the time, date, type of candy given out, type of Christmas light display, types of fireworks to be used etc. on the representation of their claimed geospatial location on the holiday map. In one embodiment, members 4312 may be indicated on the map by the aesthetic disposition of the representation of their claimed geospatial location (e.g., by the color, shading etc.). Invited neighbors 4314 may be neighbors that have not claimed their geospatial location in the neighborhood but have been invited to join the geospatially constrained social network 142 by at least on of another neighbor. The invited neighbor 4314 may be indicated on the holiday map 601 by the aesthetic disposition of the representation of their claimed geospatial location (e.g., by the color, shading etc.). The neighbors who have not yet joined 4316 may be neighbors who have not joined the geospatially constrained social network and have not yet been invited by at least on of another neighbor, according to one embodiment. The neighbors who have not yet joined 4316 may be indicated on the holiday map 601 by the aesthetic disposition of the representation of their claimed geospatial location (e.g., by the color, shading etc.). The neighbors giving out treats for Halloween 4318 may indicate that the user associated with the claimed geospatial location has indicated that they will be participating in the Halloween activity of giving out treats via the participation indicator 4310. In one embodiment, the holiday pushpin 4301 (e.g., the Halloween pushpin 802) may mark the claimed geospatial location to show that the user associated with the claimed geospatial location has indicated their participation via the participation indicator 4310. Users may be provided with automated verbal navigation guidance (e.g., through a mobile device associated with the user) describing an optimal walking route to homes participating in the holiday activity (e.g., giving out Halloween candy, Christmas lights displays, Independence Day fireworks). Users may update the holiday map 601 to include at least one of an availability, a rating, a review, and/or another update of various items listed in the holiday map.

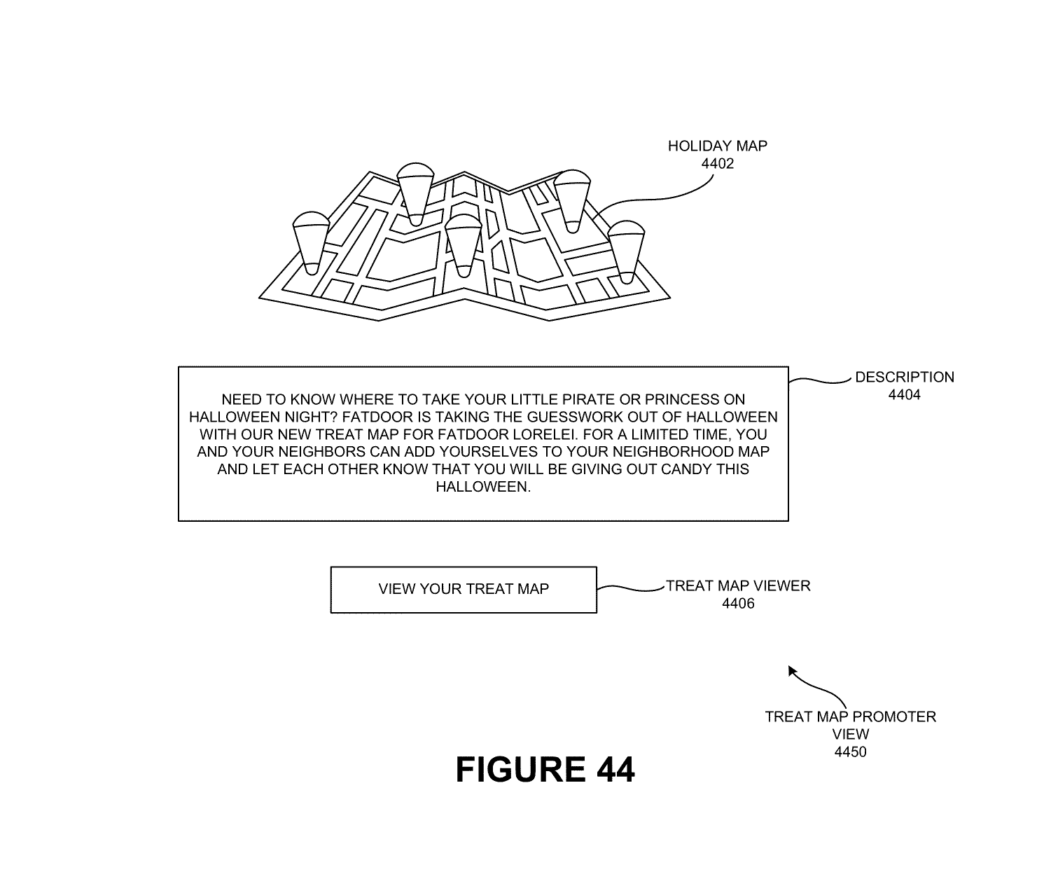

FIG. 44 is a treat map promoter view 4450 of a holiday map, a description, and a treat map viewer, according to one embodiment. Particularly, FIG. 44 shows a holiday map 4402, a description 4404 and a treat map viewer 4406. The holiday map 4402 may be a geospatial map of the neighborhood in which a verified user has a claimed geospatial location (e.g., the holiday map 601). The description 4404 may include information about the holiday map 4402, information regarding how the verified user may add themselves to the holiday map, details about the holiday activates promoted on the geospatially constrained social network 142 (e.g., on the holiday map 4402) and/or the benefits of the using the holiday map 4402, according to one embodiment. The treat map viewer 4406 may allow the verified user to view the holiday map 4402 (e.g., treat map), receive automated verbal navigation guidance to participating geospatial locations in the user's claimed neighborhood and/or add themselves to the holiday map 4403, according to one embodiment.

It should be noted that there are a number of different ‘user’ roles described in the various embodiments described herein. The user roles include a ‘user’, a ‘claimed user’, and a ‘verified user’. The user is someone that has signed up for and/or accessed the holiday expression server 100 through the geospatially constrained social network 142. The user can ‘claim’ an existing profile (e.g., prepopulated and/or created by another user through a wiki like creation process), and/or ‘claim’ an address with a new location, thereby transforming the user to the ‘claimed user’. The claimed user can verify that they actually live at a particular home address and/or work at a particular business address (e.g., thereby showing their affiliation with a non-transitory location) by submitting a response to a verification code on a postcard, submitting a utility bill, and/or being invited by and/or getting vouched for by an existing verified user. This can transform the claimed user to a ‘verified user’, in one embodiment. It will be understood by those with skill in the art that the user 106 may refer to either a user that has not yet claimed, the claimed user, and/or the verified user.

Disclosed are a method, a device and/or a system for holiday expression and mapping in a geospatially constrained social network 142. In one aspect, a method includes verifying a user 106 of a geospatially constrained social network 142 having a primary residence in a particular location associated with a claimed neighborhood 300 based on at least one of an address data and a zip code data verified using at least one of a post card verification, a utility bill verification, a privately published access code and a neighbor vouching method using a processor 120 and a memory 124. The method permits the user 106, verified in the geospatially constrained social network 142 having the primary residence at the particular location, to place a holiday pushpin 4301 on a geospatial representation of a property boundary associated with the user 106. The method also generates a holiday map 601 in which various homes associated with users 106 of the geospatially constrained social network 142 who have placed holiday pushpins 4301 on their property boundaries are published to other verified users 706 in the claimed neighborhood 300. The method restricts the visibility of the holiday map 601 to users 106 who have verified their address in the claimed neighborhood 300. The method also denies access to the holiday map 601 to users 106 who have verified their addresses in neighborhoods different from the claimed neighborhood 300.

The holiday expression server 100 may automatically generate a walking map of the claimed neighborhood 300 based on a request of the users 106 in the claimed neighborhood 300. The holiday map 601 may be a Christmas lighting display map, an Independence Day fireworks map, an Easter egg hunt map and/or a Halloween candy availability map (e.g., a treat map). The holiday pushpin 4301 may be associated with the Halloween candy distribution by the user 106 of the geospatially constrained social network 142 and the holiday map 601 may be a treat map. The method may provide automated verbal navigation guidance describing an optimal walking route to homes offering Halloween candy in the claimed neighborhood 300 through a voice-navigation system 615 of a mobile device 504 associated with the user 106. The method may permit the user 106 to set a time and/or day of candy availability associated with the holiday pushpin 4301 that the user 106 may be able to select when candy will be available at their home and/or what kind of candy will be offered at their home.

The method may include annotating the holiday map 601 based on real-time feedback from users 106 of geospatially constrained social network 142 such that the holiday map 601 may be updated based on an availability, a rating 620, and/or a review 622 of various items listed in the holiday map 601. The claimed neighborhood 300 of the user 106 may be activated based on a minimum number of other verified users 706 in a threshold radial distance 119 verified through a primary residential address associated with each of the other verified users 706 through the post card verification, the utility bill verification, the privately published access code and/or the neighbor vouching method. The method may also permit a holiday broadcast data 102 to be disseminated to adjacent neighborhoods that may have been claimed by different users 106 in a manner that the holiday broadcast data 102 may be optionally disseminated to the surrounding claimed neighborhood 300s based on a preference of the user 106.

The method may include the holiday pushpin 4301 generated through a data processing system (e.g., the device 104) radially distributed through an on-page posting, an electronic communication and/or a push notification delivered to desktops, mobile devices 504 and/or data processing systems associated with users 106 and their user profiles 1700 around an epicenter 144 defined at the set of geospatial coordinates 103 associated with the holiday broadcast data 102 to all subscribed user profiles 1700 in a circular geo-fenced area. The geo-fenced area may be defined by a threshold distance from the set of geospatial coordinates 103 associated with the holiday broadcast data 102 through the radial algorithm 240 of the neighborhood broadcasting system that may measure a distance away of each address associated with each user profile 1700 from a current geospatial location at the epicenter 144.

In another aspect, a method of a holiday expression server 100 comprises generating a treat map in a geospatially constrained social network 142 in which users 106 that have verified addresses (e.g., claimed geospatial locations 700) associated with each listing in the treat map have a holiday pushpin 4301 placed on a visual representation of a property associated with each verified address when the users 106 indicate that they are offering Halloween candy to neighborhood residents having verified addresses in the geospatially constrained social network 142 using a processor 120 and a memory 124. The method includes, permitting the visibility of the treat map to users 106 who have verified their address in the claimed neighborhood 300. The method denies access to the treat map to users 106 who have verified their addresses in neighborhoods different from the claimed neighborhood 300.

The method may include verifying that a user 106 of a geospatially constrained social network 142 has a primary residence at a particular location associated with a claimed neighborhood 300 based on an address data and/or a zip code data verified using a post card verification, a utility bill verification, a privately-published access code, and/or a neighbor vouching method. The user 106 that has been verified in the geospatially constrained social network 142 as having the primary residence at the particular location may be permitted to place a holiday pushpin 4301 on a geo-spatial representation of a property boundary associated with the user 106.

In yet another aspect, a method includes validating that a holiday broadcast data 102 generated through a mobile device 504 is associated with a verified user 706 of the holiday expression server 100 using a processor 120 and a memory 124. The method verifies that a set of geospatial coordinates 103 associated with the holiday broadcast data 102 generated through the mobile device 504 are trusted based on a claimed geospatial location 700 of the verified user 706 of the holiday expression server 100. The method includes determining that a time stamp 510 associated with a creation date 508 and a creation time 507 of the holiday broadcast data 102 generated through the mobile device 504 is trusted based on the claimed geospatial location 700 of the verified user 706 of the holiday expression server 100. The method automatically publishes the holiday broadcast data 102 generated through the mobile device 504 on a set of user profiles 1700 having associated verified addresses in a threshold radial distance 119 from the set of geospatial coordinates 103 associated with the holiday broadcast data 102 generated through the mobile device 504 of the verified user 706 of the holiday expression server 100 using a radial algorithm 240.

The method may include determining that the holiday broadcast data 102 is generated by the verified user 706 of a neighborhood broadcast system when validating that the holiday broadcast data 102 is associated with the mobile device 504. It may be determined that an application on the mobile device 504 is communicating the holiday broadcast data 102 to the geospatially constrained social network 142 when the holiday broadcast data 102 is processed. The verified user 706 may be associated with a verified user 706 profile in the geospatially constrained social network 142 through the application on the mobile device 504. The holiday broadcast data 102 generated through the mobile device 504 as an holiday pushpin 4301 of the holiday broadcast may be presented in a geospatial map surrounding pre-populated residential listings in a surrounding vicinity, such that the holiday pushpin 4301 of the holiday broadcast may be automatically presented on the geospatial map and/or may be presented on the set of user profiles 1700 having associated verified addresses in the threshold radial distance 119 from the set of geospatial coordinates 103 associated with the holiday broadcast data 102 generated through the mobile device 504 of the verified user 706 of the holiday expression server 100.

The holiday broadcast data 102 generated through the mobile device 504 may be radially distributed through an on-page posting, an electronic communication, and/or a push notification delivered to desktop and/or mobile devices 504 associated with users 106 and/or their user profiles 1700 around an epicenter 144 that may be defined at the set of geospatial coordinates 103 associated with the holiday broadcast data 102 may be generated through the mobile device 504 (e.g., the device 104) to all subscribed user profiles 1700 in a circular geo-fenced area defined by the threshold distance from the set of geospatial coordinates 103 associated with the holiday broadcast data 102 generated through the mobile device 504 through the radial algorithm 240 of a geospatially constrained social network 142 that measures a distance away of each address associated with each user profile 1700 from the current geospatial location at the epicenter 144.

The verified user 706 may be permitted to drag and drop the holiday pushpin 4301 (e.g., the Halloween pushpin 802, the Easter pushpin 804, the Christmas pushpin 806 and/or the broadcast pushpin 808 of FIG. 8) on any location on the geospatial map, and/or the method may automatically determine a latitude and/or a longitude associated with a placed location. The method may include geocoding a set of residential addresses in a neighborhood surrounding the mobile device 504. The set of residential addresses in the threshold radial distance 119 from the claimed geospatial location 700 of the verified user 706 of the holiday expression server 100 may be prepopulated in a neighborhood curation system communicatively coupled with the holiday expression server 100. The holiday broadcast data 102 generated through the mobile device 504 may be automatically published to the set of user profiles 1700 having associated verified addresses in the threshold radial distance 119 from the claimed geospatial location 700 of the verified user 706 of the holiday expression server 100 using the radial algorithm 240.

The method may include processing a claim request of the verified user 706 generating the holiday broadcast data 102 generated through the mobile device 504 to be associated with an address of the neighborhood curation system. It may be determined if the claimable neighborhood in the neighborhood curation system is associated with a private neighborhood community in the claimable neighborhood of the neighborhood curation system. The verified user 706 may be associated with the private neighborhood community in the claimable neighborhood of the neighborhood curation system if the private neighborhood community has been activated by at least one of the verified user 706 and a different verified user 706.

The verified user 706 may be permitted to draw a set of boundary lines in a form of a geospatial polygon such that the claimable neighborhood in a geospatial region surrounding the claim request may create the private neighborhood community in the neighborhood curation system if the private neighborhood community is inactive;

The claim request of the verified user 706 generating the holiday broadcast data 102 generated through the mobile device 504 may be verified to be associated with a neighborhood address of the neighborhood curation system when the address is determined to be associated with at least one of a work address and a residential address of the verified user 706. The method may include simultaneously publishing the holiday broadcast data 102 generated through the mobile device 504 on the private neighborhood community associated with the verified user 706 generating the holiday broadcast data 102 generated through the mobile device 504 in the threshold radial distance 119 from the address associated with the claim request of the verified user 706 of the neighborhood curation system when automatically publishing the holiday broadcast data 102 generated through the mobile device 504 on a set of user profiles 1700 (having associated verified addresses in the threshold radial distance 119 from the claimed geospatial location 700 of the verified user 706 of the holiday expression server 100 based on a set of preferences of the verified user 706) using the radial algorithm 240.

A summary data may be provided to the verified user 706 generating the holiday broadcast data 102 generated through the mobile device 504 of how many user profile 1700 pages were updated with an alert of the holiday broadcast data 102 generated through the mobile device 504 when publishing the holiday broadcast data 102 generated through the mobile device 504 in at least one of the private neighborhood community and/or the set of user profiles 1700 having associated verified addresses in the threshold radial distance 119 from the claimed geospatial location 700 of the verified user 706 of the holiday expression server 100 based on the set of preferences of the verified user 706. The method may include live broadcasting the holiday broadcast data 102 generated through the mobile device 504 to the different verified user 706 and/or other verified users 706 in the private neighborhood community and/or currently within the threshold radial distance 119 from the current geospatial location through a multicast algorithm of the holiday expression server 100 such that a live broadcast 616 may multicast to a plurality of data processing systems (e.g., the device 104) associated with each of the different user 106 and the other verified users 706 simultaneously when the mobile device 504 of the verified user 706 generating the live broadcast 616 enables broadcasting of the holiday broadcast data 102 generated through the mobile device 504 to any one of a geospatial vicinity around the mobile device 504 of the verified user 706 generating the broadcast and/or in any private neighborhood community in which the verified user 706 has a non-transitory connection.

The different verified user 706 and other verified users 706 in at least one of the private neighborhood community may be permitted to bi-directionally communicate with the verified user 706 generating the broadcast through the holiday expression server 100, wherein any private neighborhood community in which the verified user 706 has the non-transitory connection may be the residential address of the verified user 706 that has been confirmed by the holiday expression server 100 as being associated with the verified user 706. The threshold distance may be between 0.2 and 0.4 miles from the set of geospatial coordinates 103 associated with the holiday broadcast data 102 generated through the mobile device 504 to optimize a relevancy of the live-broadcast. The holiday expression server 100 may include a crowdsourced moderation algorithm in which multiple neighbors to a geospatial area 117 may determine what content contributed to the holiday expression server 100 persists and which is deleted. The holiday expression server 100 may permit users 106 to mute messages of specific verified users 706 to prevent misuse of the holiday expression server 100. Access to the holiday broadcast data 102 may be restricted to the claimed neighborhood 300 of the verified user 706. Access to the holiday broadcast data 102 may be denied to users 106 having verified addresses outside the claimed neighborhood 300 of the verified user 706.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

Embodiments described herein in FIGS. 1-11 govern a new kind of social network for neighborhoods, according to one embodiment (e.g., may be private and/or wiki-editable search engine based). It should be noted that in some embodiments, the address of a user may be masked from the public search (but still may be used for privacy considerations), according to one embodiment. Some embodiments have no preseeded data, whereas others might. Embodiments described herein may present rich, location specific information on individual residents and businesses.

A user can “Claim” one or more Business Pages and/or a Residential Pages, according to one embodiment. In order to secure their Claim, the user may verify their location associated with the Business Page and/or Residential page within 30 days, or the page becomes released to the community, according to one embodiment. A user can only have a maximum of 3 unverified Claims out at any given time, according to one embodiment. When a user clicks on “Claim this Page” on Business Profile page and/or a Residential Profile page, they can indicate the manner in which they intend to verify their claim, according to one embodiment. Benefits of Claiming a Business Page and/or Residential page may enable the user to mark their page ‘Self-Editable only’ from the default ‘Fully Editable’ status, and see “Private” listings in a claimed neighborhood around the verified location, according to one embodiment. Each edit by a user on a Residential Profile page and/or a Business Profile page may be made visible on the profile page, along with a date stamp, according to one embodiment.

Browse function: Based on the user's current location, the browse function may display a local map populated with pushpins for location-specific information, and a news feed, made up of business page edits, public people page edits, any recent broadcasts, etc., according to one embodiment. The news feed may show up on each Business Page and each Residential Page, based on activity in the surrounding area, according to one embodiment. Secure a Neighborhood function: May allow the user to identify and “secure” a neighborhood, restricting certain types of access to verified residents, according to one embodiment. Add a Pushpin function: May allow any registered or verified user to add any type of Pushpin (as described in FIG. 8), to one embodiment.

In addition to the map, the search results page may display a news feed, made up of business page edits, public people page edits, any recent broadcasts, and autogenerated alerts who has moved into the neighborhood, who has moved out of the neighborhood, any recent reviews in the neighborhood, any pushpins placed in the immediate area, etc., according to one embodiment. The news feed may prioritize entries relating to the search results, and will take into account privacy policies and preferences, according to one embodiment.

Example Newsfeeds may include:

Joe Smith moved into the neighborhood in September 2013. Welcome Joe! Like Share; 43 neighbors (hyperlink) moved in to the Cupertino library neighborhood in July 2013. Like Share; 12 neighbors (hyperlink) verified in to the Cupertino library neighborhood in July 2013. Like Share; Raj Abhyanker invited Paul Smith, a guest to the Cupertino neighborhood. Raj indicates Paul is a friend from college looking to move into the neighborhood. Welcome Paul!; Raj Abhyanker posted a Nissan Leaf for rent $35 a day, in mountain view Rent now. Like Share

This content may feed each Profile Page and helps to increase Search Engine value for content on the site, according to one embodiment. Alerts may be created and curated (prioritized, filtered) automatically and/or through crowdsourcing, to keep each page vibrant and actively updating on a regular basis (ideally once a day or more), according to one embodiment.

A Multi-Family Residence page will display a list of residents in the entire building, according to one embodiment. Clicking on any resident will display a Single Family Residence page corresponding to the individual living unit where that person resides, according to one embodiment.

For example, suppose that John Smith and Jane Smith live in apartment 12 of a large building. Their names are included in the list of residents. When a user clicks on either John Smith or Jane Smith, we will display a “Single Family Residence” page showing both John and Jane, just as if apartment 12 was a separate structure, according to one embodiment.

The broadcast feature (e.g., associated with the holiday broadcast data 102 and generated by the radial algorithm 240 of the radial distribution module 140) may be a “Radio” like function that uses the mobile device's current geospatial location to send out information to neighbors around the present geospatial location of the user, according to one embodiment. Broadcasts may be posted to neighbor pages in the geospatial vicinity (e.g., in the same neighborhood) on public and private pages in the geospatial social network, according to one embodiment. These broadcasts may enable any user, whether they live in a neighborhood or not to communicate their thoughts to those that live or work (or have claimed) a profile in the neighborhood around where the broadcaster is physically at, regardless of where the broadcaster lives, according to one embodiment. Broadcasts can be audio, video, pictures, and or text, according to one embodiment. For accountability, the broadcaster may be a verified user and their identity made public to all users who receive the broadcast in one embodiment.

This means that the broadcast feature may be restricted to be used only by devices (e.g., mobile phones) that have a GPS chip (or other geolocation device) that an identify a present location of where the broadcast is originating from, according to one embodiment. The broadcast may be sent to all users who have claimed a profile in the geo spatial vicinity where the broadcast originates, according to one embodiment. This can either be broadcast live to whoever is “tuned” in to a broadcast of video, audio, picture, and text in their neighborhood, or can be posted on each users profile if they do not hear the broadcast to the neighborhood in a live mode in one embodiment.

When a broadcast is made neighbors, around where the broadcast is made, they may receive a message that says something like:

Raj Abhyanker, a user in Menlo Park just broadcast “Japanese cultural program” video from the Cupertino Union church just now. Watch, Listen, View

This broadcast may be shared with neighbors around Menlo park, and or in Cupertino. This way, Raj's neighbors and those in Cupertino can know what is happening in their neighborhoods, according to one embodiment. In one embodiment, the broadcast only goes to one area (Cupertino or Menlo park in the example above).

Broadcasts could be constrained to devices that have geospatial accuracy of present location and a current only (mobile devices for example). Otherwise, broadcasts won't mean much, according to one embodiment (would otherwise be just like thoughts/video upload without this). Broadcasts shouldn't be confused with ‘upload videos’, according to one embodiment. Different concepts. Why? Broadcasts have an accuracy of time and location that cannot be altered by a user, according to one embodiment, Hence, mobile is the most likely medium for this not desktop computer, according to one embodiment. We should not let the user set their own location for broadcasts (like other pushpin types), according to one embodiment. Also time is fixed, according to one embodiment. Fixing and not making these two variables editable give users confidence that the broadcast was associated with a particular time and place, and creates a very unique feature, according to one embodiment. For example, it would be not useful if the broadcast is untrusted as to location of origination, according to one embodiment. E.g., I broadcast when I am somewhere only about the location I am at, according to one embodiment.

Broadcasts are different that other pushpins because location of where a broadcast, and time of broadcast is

*current location* and *current time*, according to one embodiment. They are initiated wherever a broadcaster is presently at, and added to the news feed in the broadcasters neighborhood and in the area wherever a broadcaster is presently at, according to one embodiment.

Broadcast rules may include:

1. If I post a Broadcast in my secured neighborhood, only my neighbors can see it, according to one embodiment.

2. If I post a Broadcast in different secured neighborhood then my own, my neighbors can see it (e.g., unless I turn this off in my privacy setting) and neighbors in the secured neighborhood can see it (e.g., default not turn-offable, but I can delete my broadcast), according to one embodiment.

3. If I post a Broadcast in different unsecured neighborhood then my own, my neighbors can see it (unless I turn this off in my privacy setting) and the broadcast is publicly visible on user pages of public user profiles in the unsecured neighborhood until profiles are claimed and/or the neighborhood is secured, according to one embodiment.

4. If an outsider in a secure neighborhood posts a broadcast in my secure neighborhood, it's not public, according to one embodiment.

5. If an outsider in a unsecure neighborhood posts a broadcast in my secure neighborhood, the system does not post on profiles in his unsecure neighborhood (to prevent stalking, burglary), but does post in my secure neighborhood, according to one embodiment.

Privacy settings. For each verified residential or business location, the user may set Privacy to Default, Public, Private, or Inactive, according to one embodiment. The Default setting (which is the default) means that the profile will be public, until the neighborhood is secured; in a secured neighborhood, the profile will be Private, according to one embodiment. By changing this setting, the user may force the profile to be Public or Private, regardless of whether the neighborhood is secured, according to one embodiment.

For each verified residential location, the user may set edit access to Group Editable or Self Editable, according to one embodiment.

Residential Privacy example. The residential profiles can be: Public: anyone can search, browse, or view the user profile, according to one embodiment. This is the default setting for unsecured neighborhoods (initially, all the content on the site), according to one embodiment. Private: only people in my neighborhood can search, browse, or view the user's profile, according to one embodiment. This is the default for secured neighborhoods, according to one embodiment. Inactive: nobody can search, browse, or view the profile, even within a secured neighborhood, according to one embodiment. A user may have at least one active (public or private), verified profile in order to have edit capabilities, according to one embodiment; if the user makes all profiles inactive, that user is treated (for edit purposes) as an unverified user, according to one embodiment.

Verified users can edit the privacy setting for their profile and override the default, according to one embodiment. Group Editable: anyone with access to a profile based on the privacy roles above can edit the profile, according to one embodiment. This is the default setting, according to one embodiment Self Editable, only the verified owner of a profile can edit that profile, according to one embodiment.

Exceptions Guest User. A verified user in another neighborhood is given “Guest” access to a neighborhood for a maximum of 60 days by a verified user in the neighborhood in which the guest access is given, according to one embodiment. In effect, the guest becomes a member of the neighborhood for a limited period, according to one embodiment. Friend. When a user has self-elected being friends with someone in a different neighborhood, they can view each other's profiles only (not their neighbors), according to one embodiment. One way for a user to verify a location is to submit a scanned utility bill, according to one embodiment.

When a moderator selects the Verify Utility Bills function, the screen will display a list of items for processing, according to one embodiment. Accept the utility bill as a means of verification, according to one embodiment. This will verify the user's location, and will also generate an e-mail to the user, according to one embodiment. Or Decline the utility bill as a means of verification, according to one embodiment. There will be a drop-down list to allow the moderator to select a reason, according to one embodiment; this reason will be included in an e-mail message to the user. Reasons may include: Name does not match, address does not match, name/address can't be read, not a valid utility bill, according to one embodiment.

Additionally, for example, the broadcast may even occur automatically and simultaneously when a user 106 views and/or orders decorations associated with a particular holiday. Upon viewing and/or selecting decorations through the user interfaces of FIGS. 33-37, recipients within a threshold radial distance 119 (e.g., selected by the user 106) from the claimed geospatial location 700 of the user 106 may be updated and/or may be able to contact the user 106 indicating that they have extra decorations similar to those selected by the user via the user interfaces of FIGS. 33-37. This may allow neighbors to share decorations and avoid purchasing decorations every year and/or for each holiday.

Halloween may be Sarah's favorite holiday. Her parents may not allow her or her brother to eat candy except at Halloween. Every year, Sarah may spend months choosing her costume and dreaming about all the candy she will get. This year, Sarah may be able to quickly get all the candy she desires. Rather than spending all night wandering the streets of her neighborhood with her family only to find a few houses that are giving out candy, she may be able to go directly to each house with candy and even plot the most efficient route for getting candy. Her parents may not be required to spend hours walking about on a work night before she is satisfied with how many treats she has collected. When Sarah comes upon a house with candy, her parents may not need to be apprehensive about their children ringing the bell and/or eating the candy they are given. This may be because her parents are may be able to see who lives at the house. Sarah and her family may be able to have the safest, most fun, and/or sweetest Halloween they have ever had by using the geospatially constrained social network 142.

It will be understood with those skill in the art that in some embodiments, the radial distribution module 140 may restrict dissemination of broadcast data by verified users to claimed neighborhoods in a private neighborhood social network (e.g. the geospatially constrained social network 142 may be a private social network, the neighborhood curation system described herein may also be part of the private neighborhood social network) in which the broadcaster resides (e.g., has a home) using the radial algorithm 140. The geo-spatially constrained social network 142 may include online communities designed to easily create private websites to facilitate communication among neighbors and build stronger neighborhoods (e.g., to help neighbors build stronger and safer neighborhoods).

Further, it follows that the threshold radial distance 119 may take on a variety of shapes other than purely circular and is defined to encompass a variety of shapes based on associated geographic, historical, political and/or cultural connotations of associated boundaries of neighborhoods and/or as defined by a city, municipality, government, and/or data provider (e.g., Maponics®, Urban Mapping®), in one embodiment. For example, the threshold radial distance 119 may be based on a particular context, such as a school boundary, a neighborhood boundary, a college campus boundary, a subdivision boundary, a parcel boundary, and/or a zip code boundary.

In an alternative embodiment, the threshold radial distance 119 generated by the geospatially constrained social network 142 may be restricted to a shared apartment building (e.g., and/or an office building). In addition, it will be understood with those skilled in the art that the holiday expression server 100 may be operate as a function of the geo-spatially constrained social network 142 (e.g., a neighborhood social network).

In addition, it will be understood that the holiday broadcast data 102 may appear in a ‘feed’ provided to users of the geo-spatially constrained social network 142 (e.g., a private social network for neighbors) on their profile pages based on access control privileges set by the radial broadcast module 140 using the radial algorithm 240. For example, access to the holiday broadcast data 102 may be limited to just a claimed neighborhood (e.g., as defined by neighborhood boundaries) and/or optionally adjacent neighborhoods.

In one embodiment, the geo-spatially constrained social network 142 may provide holiday services with a separate login in which they can invite neighbors themselves. For example, communications defined from one broadcasting user to an adjacent neighborhood may involve sharing information about a haunted house, trick or treat activities and/or participation, community Easter egg hunts, Fourth of July fireworks shows, to rally support from neighbors from multiple neighborhoods to address civic issues, to spread the word about events like local theater production or neighborhood garage sales, and/or to ask for advice or recommendations from the widest range of people in a community). In one embodiment, the geospatially constrained social network 142 may prevent self-promotional messages that are inappropriate (e.g., a user sending such messages may be suspended from the geospatially constrained social network using the crowd sourced moderation algorithm module 204). In one embodiment, the user 106 may personalize nearby neighborhoods so that the user can choose exactly which nearby neighborhoods (if any) they wish to communicate with. The user 106 may be able to flag a neighborhood feeds from adjacent neighborhoods. In addition, leaders from a particular neighborhood may be able to communicate privately with leaders of an adjoining neighborhood to plan and organize on behalf of an entire constituency. Similarly, users 106 may be able to filter feeds to only display messages from the neighborhood that they reside in. The user 106 may be able to restrict posts (e.g., pushpin placements) only in the neighborhood they are presently in. In one embodiment, nearby neighbors may (or may not) be able to access profiles of adjacent neighborhoods.

It will also be understood that in some embodiments, that users may be ‘verified through alternate means, for example through a utility bill verification (e.g., to verify that a user's address on a utility bill matches the residential address they seek to claim), a credit card verification (e.g., or debit card verification), a phone number verification (e.g., reverse phone number lookup), a privately-published access code (e.g., distributed to a neighborhood association president, and/or distributed at a neighborhood gathering), and a neighbor vouching method (e.g., in which an existing verified neighbor ‘vouches’ for a new neighbor as being someone that they personally know to be living in a neighborhood.

In one embodiment, the geospatially constrained social network 142 ensures a secure and trusted environment for a neighborhood website by requiring all members to verify their address. In this embodiment, verification may provide assurance the assurance that new members are indeed residing at the address they provided when registering for an account in the geo-spatially constrained social network 142. Once a neighborhood has launched out of pilot status, only members who have verified their address may be able access to their neighborhood website content.

It will be understood that among the various ways of verifying an address, a user of the geo-spatially constrained social network 142 may uses the following methods to verify the address of every member:

A. Postcard.

The geo-spatially constrained social network 142 can send a postcard to the address listed on an account of the user 106 with a unique code printed on it (e.g., using the Fatmail postcard campaign). The code may allow the user 106 to log in and verify their account.

B. Credit or Debit Card.

The geo-spatially constrained social network 142 may be able to verify a home address through a credit or debit card billing address. In one embodiment, billing address may be confirmed without storing personally identifiable information and/or charging a credit card.

C. Home Phone.

If a user 106 has a landline phone, the user may receive an automated phone call from the geo-spatially constrained social network 142 that may provide with a unique code to verify an account of the user 106.

D. Neighborhood Leader.

A neighborhood leader of the geo-spatially constrained social network can use a verify neighbors feature of the geo-spatially constrained social network 142 to vouch for and verify neighbors.

E. Mobile Phone.

A user 106 may receive a call to a mobile phone associated with the user 106 to verify their account.

F. Neighbor Invitations.

A neighbor who is a verified member of the geo-spatially constrained social network 142 can vouch for, and may invite another neighbor to join the geo-spatially constrained social network 142. Accepting such an invitation may allow the user 106 to join the geo-spatially constrained social network 142 as a verified member, according to one embodiment.

H. Social Security Number (SSN).

The geo-spatially constrained social network 142 can verify a home address when the user 106 provides the last 4 digits of a SSN (e.g., not stored by the geospatially constrained social network 142 for privacy reasons).

It will be also understood that in a preferred embodiment neighborhood boundaries defined by the radial distribution module 140 using the radial algorithm 140 may be constrained to work in neighborhoods having a threshold number of homes (e.g., 100 homes in a neighborhood) and more (e.g., up to thousands of homes) as this may be needed to reach the critical mass of active posters that is needed to help the geo-spatially constrained social network 142 succeed. In one embodiment, ‘groups’ may be creatable in smaller neighborhoods having fewer than the threshold number of homes for communications in micro-communities within a claimed neighborhood.

It will also be appreciated that in some embodiments, a mobile device 104 may be a desktop computer, a laptop computer, and/or a non-transitory broadcasting module. In addition, it will be understood that the prepopulated data (e.g., preseeded data) described herein may not be created through data licensed from others, but rather may be user generated content of organically created profiles in the geo-spatial social network created by different users who have each verified their profiles.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system. Accordingly, the specification and drawings are to be regarded in an illustrative rather than a restrictive sense.

What is claimed is:

1. A method of a holiday expression server comprising:
verifying that a user of a geospatially constrained social network has a primary residence at a particular location associated with a claimed neighborhood based on at least one of an address data and a zip code data verified using at least one of a post card verification, a utility bill verification, a privately-published access code, and a neighbor vouching method using a processor and a memory;
permitting the user that has been verified in the geospatially constrained social network as having the primary residence at the particular location to place a holiday pushpin on a geo-spatial representation of a property boundary associated with the user;
generating a holiday map in which various homes associated with users of the geospatially constrained social network that have placed holiday pushpins on their property boundaries are published to other verified users in the claimed neighborhood;
restricting visibility of the holiday map to users who have verified their address in the claimed neighborhood; and
denying access to the holiday map to users who have verified their addresses in neighborhoods different than the claimed neighborhood.

2. The method of claim 1 further comprising automatically generating a walking map of the claimed neighborhood based on a request of the users in the claimed neighborhood,
wherein the holiday map is at least one of a Christmas lighting display map, an Independence day fireworks map, and a Halloween candy availability map.

3. The method of claim 2 wherein the holiday pushpin is associated with a Halloween candy distribution by the user of the geospatially constrained social network, and wherein the holiday map is a treat map.

4. The method of claim 3 further comprising providing automated verbal navigation guidance describing an optimal walking route to homes offering Halloween candy in the claimed neighborhood through a voice-navigation system of a mobile device associated with the user.

5. The method of claim 4 further comprising: permitting the user to set a time and day of candy availability associated with the holiday pushpin, such that the user can select when candy will be available at their home, and what kind of candy will be offered at their home.

6. The method of claim 5 further comprising annotating the holiday map based on real-time feedback from users of the geospatially constrained social network such that the holiday map is updated based on at least one of an availability, a rating, and a review of various items listed in the holiday map.

7. The method of claim 1 wherein the claimed neighborhood of the user is activated based on a minimum number of other verified users in a threshold radial distance that have been verified through a primary residential address associated with each of the other verified users through at least one of the post card verification, the utility bill verification, the privately-published access code, and the neighbor vouching method.

8. The method of claim 1 permitting a holiday broadcast data to be disseminated to adjacent neighborhoods that have been claimed by different users in a manner such that the holiday broadcast data is optionally disseminated to the surrounding claimed neighborhoods based on a preference of the user.

9. The method of claim 8 wherein the holiday pushpin generated through a data processing system is radially distributed through at least one of an on-page posting, an electronic communication, and a push notification delivered to desktops, mobile devices and/or data processing systems associated with users and their user profiles around an epicenter defined at the set of geospatial coordinates associated with the holiday broadcast data to all subscribed user profiles in a circular geo-fenced area defined by a threshold distance from a set of geospatial coordinates associated with the holiday broadcast data through a radial algorithm of a neighborhood broadcasting system that measures a distance away of each address associated with each user profile from a current geospatial location at the epicenter.

10. A method of a holiday expression server comprising:
generating a treat map in a geospatially constrained social network in which users that have verified addresses associated with each listing in the treat map have a holiday pushpin placed on a visual representation of a property associated with each verified address when the users indicate that they are offering Halloween candy to neighborhood residents having verified addresses in the geospatially constrained social network using a processor and a memory;
permitting visibility of the treat map to users who have verified their address in the claimed neighborhood; and
denying access to the treat map to users who have verified their addresses in neighborhoods different than the claimed neighborhood.

11. The method of claim 10 further comprising
verifying that a user of the geospatially constrained social network has a primary residence at a particular location associated with a claimed neighborhood based on at least one of an address data and a zip code data verified using at least one of a post card verification, a utility bill verification, a privately-published access code, and a neighbor vouching method;
permitting the user that has been verified in the geospatially constrained social network as having the primary residence at the particular location to place the holiday pushpin on a geo-spatial representation of a property boundary associated with the user;
generating a holiday map in which various homes associated with users of the geospatially constrained social network that have placed holiday pushpins on their property boundaries are published to other verified users in the claimed neighborhood;
and
automatically generating a walking map of the claimed neighborhood based on a request of the users in the claimed neighborhood,
wherein the holiday map is at least one of a Christmas lighting display map, an Independence day fireworks map, and a Halloween candy availability map.

12. The method of claim 11 wherein the holiday pushpin is associated with a Halloween candy distribution by the user of the geospatially constrained social network, and wherein the holiday map is the treat map.

13. The method of claim 12 further comprising providing automated verbal navigation guidance describing an optimal walking route to homes offering Halloween candy in the claimed neighborhood through a voice-navigation system of a mobile device associated with the user.

14. The method of claim 13 further comprising: permitting the user to set a time and day of candy availability associated with the holiday pushpin, such that the user can select when candy will be available at their home, and what kind of candy will be offered at their home.

15. The method of claim 14 further comprising annotating the holiday map based on real-time feedback from users of the geospatially constrained social network such that the holiday map is updated based on at least one of an availability, a rating, and a review of various items listed in the holiday map.

16. The method of claim 15 wherein the claimed neighborhood of the user is activated based on a minimum number of other verified users in a threshold radial distance that have been verified through a primary residential address associated with each of the other verified users through at least one of the post card verification, the utility bill verification, the privately-published access code, and the neighbor vouching method.

17. The method of claim 16 permitting a holiday broadcast data to be disseminated to adjacent neighborhoods that have been claimed by different users in a manner such that the holiday broadcast data is optionally disseminated to the surrounding claimed neighborhoods based on a preference of the user.

18. The method of claim 17 wherein the holiday pushpin generated through a data processing system is radially distributed through at least one of an on-page posting, an electronic communication, and a push notification delivered to desktops, mobile devices and/or data processing system s associated with users and their user profiles around an epicenter defined at a set of geospatial coordinates associated with the holiday broadcast data to all subscribed user profiles in a circular geo-fenced area defined by a threshold distance from the set of geospatial coordinates associated with the holiday broadcast data through a radial algorithm of a neighborhood broadcasting system that measures a distance away of each address associated with each user profile from a current geospatial location at the epicenter.

19. A method of a holiday expression server comprising:
validating that a holiday broadcast data generated through a mobile device is associated with a verified user of the holiday expression server using a processor and a memory;
verifying that a set of geospatial coordinates associated with the holiday broadcast data generated through the mobile device are trusted based on a claimed geospatial location of the verified user of the holiday expression server;
determining that a time stamp associated with a creation date and a creation time of the holiday broadcast data generated through the mobile device is trusted based on the claimed geospatial location of the verified user of the holiday expression server; and
automatically publishing the holiday broadcast data generated through the mobile device on a set of user profiles having associated verified addresses in a threshold radial distance from the set of geospatial coordinates associated with the holiday broadcast data generated through the mobile device of the verified user of the holiday expression server using a radial algorithm.

20. The method of claim 19 further comprising:
determining that the holiday broadcast data is generated by the verified user of a neighborhood broadcast system when validating that the holiday broadcast data is associated with the mobile device;
determining that an application on the mobile device is communicating the holiday broadcast data to a geospatially constrained social network when the holiday broadcast data is processed;
associating the verified user with a verified user profile in the geospatially constrained social network through the application on the mobile device; and
presenting the holiday broadcast data generated through the mobile device as an holiday pushpin of a holiday broadcast in a geospatial map surrounding pre-populated residential listings in a surrounding vicinity, such that the holiday pushpin of the holiday broadcast is automatically presented on a geospatial map in addition to being presented on the set of user profiles having associated verified addresses in the threshold radial distance from the set of geospatial coordinates associated with the holiday broadcast data generated through the mobile device of the verified user of the holiday expression server,
wherein the holiday broadcast data generated through the mobile device is radially distributed through at least one of an on-page posting, an electronic communication, and a push notification delivered to desktop and mobile devices associated with users and their user profiles around an epicenter defined at the set of geospatial coordinates associated with the holiday broadcast data generated through the mobile device to all subscribed user profiles in a circular geo-fenced area defined by a threshold distance from the set of geospatial coordinates associated with the holiday broadcast data generated through the mobile device through the radial algorithm of the geospatially constrained social network that measures a distance away of each address associated with each user profile from a current geospatial location at the epicenter.
geocoding a set of residential addresses each associated with a resident name in a neighborhood surrounding the mobile device; and
prepopulating the set of residential addresses in the threshold radial distance from the claimed geospatial location of the verified user of the holiday expression server in a neighborhood curation system communicatively coupled with the holiday expression server.
automatically publishing the holiday broadcast data generated through the mobile device to the set of user profiles having associated verified addresses in the threshold radial distance from the claimed geospatial location of the verified user of the holiday expression server using the radial algorithm.
processing a claim request of the verified user generating the holiday broadcast data generated through the mobile device to be associated with an address of the neighborhood curation system;
determining if the claimable neighborhood in the neighborhood curation system is associated with a private neighborhood community in the claimable neighborhood of the neighborhood curation system;
associating the verified user with the private neighborhood community in the claimable neighborhood of the neighborhood curation system if the private neighborhood community has been activated by at least one of the verified user and a different verified user;
permitting the verified user to draw a set of boundary lines in a form of a geospatial polygon such that the claimable neighborhood in a geospatial region surrounding the claim request creates the private neighborhood community in the neighborhood curation system if the private neighborhood community is inactive;
verifying the claim request of the verified user generating the holiday broadcast data generated through the mobile device to be associated with a neighborhood address of the neighborhood curation system when the address is determined to be associated with at least one of a residential address of the verified user; and
simultaneously publishing the holiday broadcast data generated through the mobile device on the private neighborhood community associated with the verified user generating the holiday broadcast data generated through the mobile device in the threshold radial distance from the address associated with the claim request of the verified user of the neighborhood curation system when automatically publishing the holiday broadcast data generated through the mobile device on the set of user profiles having associated verified addresses in the threshold radial distance from the claimed geospatial location of the verified user of the holiday expression server based on a set of preferences of the verified user using the radial algorithm.
providing a summary data to the verified user generating the holiday broadcast data generated through the mobile device of how many user profile pages were updated with an alert of the holiday broadcast data generated through the mobile device when publishing the holiday broadcast data generated through the mobile device in at least one of the private neighborhood community and the set of user profiles having associated verified addresses in the threshold radial distance from the claimed geospatial location of the verified user of the holiday expression server based on the set of preferences of the verified user.
live broadcasting the holiday broadcast data generated through the mobile device to the different verified user and other verified users in at least one of the private neighborhood community and currently within the threshold radial distance from the current geospatial location through a multicast algorithm of the holiday expression server such that a live broadcast multicasts to a plurality of data processing systems associated with each of a different user and the other verified users simultaneously when the mobile device of the verified user generating a live-broadcast enables broadcasting of the holiday broadcast data generated through the mobile device to any one of a geospatial vicinity around the mobile device of the verified user generating a broadcast and in any private neighborhood community in which the verified user has a non-transitory connection; and
permitting the different verified user and the other verified users in at least one of the private neighborhood community to bi-directionally communicate with the verified user generating the broadcast through the holiday expression server,
wherein any private neighborhood community in which the verified user has the non-transitory connection is at least one of the residential address of the verified user that has been confirmed by the holiday expression server as being associated with the verified user,
wherein the threshold distance is between 0.2 and 0.4 miles from the set of geospatial coordinates associated with the holiday broadcast data generated through the mobile device to optimize a relevancy of the live-broadcast,
wherein the holiday expression server includes a crowdsourced moderation algorithm in which multiple neighbors to a geospatial area determine what content contributed to the holiday expression server persists and which is deleted,
wherein the holiday expression server permits users to mute messages of specific verified users to prevent misuse of the holiday expression server,
wherein the holiday expression server permits the holiday broadcast data to be disseminated to adjacent neighborhoods that have been claimed by different users in a manner such that the holiday broadcast data is optionally disseminated to the surrounding claimed neighborhoods based on a preference of the verified user,
wherein access to the holiday broadcast data is restricted to the claimed neighborhood of the verified user, and
wherein access to the holiday broadcast data is denied to users having verified addresses outside the claimed neighborhood of the verified user.
